(19) United States
(12) Patent Application Publication
(10) Pub. No.: US 2020/0172387 A1
(43) Pub. Date: Jun. 4, 2020

(54) DRAFT BEER SUPPLY CHAIN SYSTEMS AND METHODS

(71) Applicant: RBE INVESTMENTS, LLC, Indianapolis, IN (US)

(72) Inventors: Steve Hershberger, Carmel, IN (US); Steve Kremer, Carmel, IN (US); Matt Mayer, Westfiled, IN (US); Mark Kosiarek, Fishers, IN (US)

(21) Appl. No.: 16/557,344

(22) Filed: Aug. 30, 2019

Related U.S. Application Data
(63) Continuation of application No. 15/033,885, filed on May 2, 2016, now abandoned.
(60) Provisional application No. 61/899,286, filed on Nov. 3, 2013.
(60) Provisional application No. 61/909,270, filed on Nov. 26, 2013.

(51) Int. Cl. B67D 1/08; B67D 1/12; B67D 1/00; G01G 19/52

(52) U.S. Cl. CPC B67D 1/0888; B67D 1/0855; B67D 1/0801; B67D 1/1247; G06Q 10/087; B67D 1/0857; B67D 1/0871; B67D 1/0884; G01G 19/52; B67D 1/0004

(57) ABSTRACT

Supply chain systems and methods are disclosed for monitoring fluid levels in liquid containers, such as kegs. Embodiments include sensors that fit within a keg's false bottom, measure the weight of the keg, and transmit the weight information to a computer database via a wireless network. Other embodiments include an RFID device with information about a characteristic of the liquid within a keg (such as brand and/or type of beer) that may be attached to the keg and paired with the sensor so the sensor can transmit information about the characteristic of the liquid in the keg. In alternate embodiments, the sensor's transmitter is short range and an uplink/gateway is used to receive information from the sensor and relay that sensor's information to a broader wireless network. Multiple containers in close proximity may each be fitted with an RFID device and sensor and communicate their individual information to the database.

### CROSS REFERENCE TO RELATED APPLICATION

This application is a continuation of U.S. patent application Ser. No. 15/033,885, filed May 2, 2016, which is a national stage filing of PCT/US2014/063645, filed Nov. 3, 2014, which claims the benefit of priority to U.S. Provisional Patent Application Ser. No. 61/899,286, filed Nov. 3, 2013; and U.S. Provisional Patent Application Ser. No. 61/909,270, filed Nov. 26, 2013, all of which are incorporated herein by reference.

### FIELD

Embodiments of the present disclosure relate to managing information related to inventory and distribution, such as the inventory and distribution of draft (draught) beer. Further embodiments of the present inventions relate to monitoring of draft beer and other bulk beverage inventories, and to related data analysis, including automated ordering, prompting for ordering, and mobile marketing.

### BACKGROUND

Establishments such as restaurants and bars frequently receive products consumed by customers, such as beverages, from distributors. When an establishment runs low on certain products, the establishment typically contacts the distributor to resupply the establishment's stock of products. However, this process can be time consuming, especially when it is difficult for the establishment to ascertain the quantity of certain products, such as when those products are supplied in bulk, such as in kegs. It was realized by the inventors of the current disclosure that improvements in the supply chain for certain products, such as beer in kegs, are needed. Certain features of the present disclosure address these and other needs and provide other important advantages.

### SUMMARY

Embodiments of the present disclosure provide improved draft beer supply chain systems and methods.

In accordance with one aspect of embodiments of the present disclosure, a method is disclosed, the method including attaching a wireless electronic communication device to a container with liquid, the wireless electronic communication device being encoded with information relating to a characteristic of the liquid within the container; attaching a sensor/transmitter to the container; transferring information relating to a characteristic of the liquid within the container from the wireless electronic communication device to the sensor/transmitter; determining the quantity of the fluid (or other material) within the container with the sensor/transmitter; and transmitting information related to the weight of the container and the type of liquid within the container from the sensor/transmitter to a computer database via a wireless network.

In accordance with another aspect of embodiments of the present disclosure, an apparatus is disclosed, the apparatus including a sensor/transmitter adapted to attach to the container, a sensor/transmitter including a liquid quantity sensor configured and adapted to detect the amount of liquid within the container, a receiver that receives information related to the liquid in the container from a wireless electronic communication device, and a transmitter that receives information from the receiver and from the liquid quantity sensor, wherein the transmitter transmits information received from the receiver and the liquid quantity sensor to a wireless network.

In accordance with still another aspect of embodiments of the present disclosure, a system is disclosed, the system including a plurality of wireless electronic communication devices, each encodable with information identifying a characteristic of liquid within a container, each wireless electronic communication device being attachable to a container; a plurality of sensors each attachable to a container, each sensor configured and adapted to measure the quantity of liquid within the container to which the sensor is attached, receive information from one of the plurality of wireless electronic communication devices attached to the same container as each sensor, the information relating to at least one characteristic of the liquid within the container to which the one wireless electronic communication device and the sensor is attached, and transmit information to a wireless network, the transmitted information including information from the wireless electronic communication device including the characteristic of the liquid within the container to which the sensor is attached, and information about the weight of the container to which the sensor is attached; and a computer database that receives and stores information from the plurality of sensors via the wireless network.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein is not necessarily intended to address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions or may have been created from scaled drawings. However, such dimensions, or the relative scaling within a figure, are by way of example, and not to be construed as limiting.

FIG. 1 is a perspective view of a pressure sensor installed on the bottom of a keg according to one embodiment of the present disclosure.

FIGS. 2-3 illustrate installation of one form of a pressure sensor on the bottom of the keg according to one embodiment of the present disclosure.

FIG. 4A is a perspective view of the bottom of a pressure sensor according to another embodiment of the present disclosure.

FIG. 4B is a perspective view of the top of the pressure sensor depicted in FIG. 4A.

FIG. 4C is a side elevational view of the pressure sensor depicted in FIG. 4A.

FIG. 5A is an exploded view of the pressure sensor depicted in FIG. 4A.

FIG. 5B is a perspective view of the pressure sensor depicted in FIG. 4A with at least the upper housing not depicted.

FIG. 5C is a perspective view of the upper housing lower surface of the pressure sensor depicted in FIG. 4A.

FIG. 5D is a partial perspective view of the pressure sensor depicted in FIG. 4A with at least the upper housing not depicted.

FIG. 5E is a perspective view of the pressure sensor depicted in FIG. 4A with detailed views of various features.

FIGS. 6A and 6B are side elevational views of the pressure sensor depicted in FIG. 4A being installed on the bottom of a keg according to one embodiment of the present disclosure.

FIG. 7 is a top/side/rear view of a sensor installation apparatus for use in various embodiments.

FIG. 8 is a perspective view of a sound wave-based keg volume sensor for use in various embodiments.

FIG. 9 is a perspective view of an uplink/gateway according to one embodiment.

FIG. 10A is a schematic diagram of a bulk beverage information collection, management, processing, and action system according to one embodiment.

FIG. 10B is a schematic diagram of a bulk beverage information collection, management, processing, and action system according to another embodiment.

FIG. 11 is a schematic diagram of distribution, reporting, ordering, and processing of bulk beverage information according to one embodiment of the present disclosure.

FIG. 12 illustrates a keg location monitoring system in yet another embodiment.

FIG. 13 illustrates the pairing and installation of a sensor/transmitter to a keg with an electronic identification device according to one embodiment of the present disclosure.

FIG. 14 is a schematic diagram of a bulk beverage information collection, management, processing and action system according another embodiment of the present disclosure.

FIG. 15 is a schematic diagram of a computer used in various embodiments.

FIG. 16A is a perspective view of the top of the pressure sensor depicted in FIG. 4A with a footer according to one embodiment of the present disclosure.

FIG. 16B is a perspective view of the bottom of pressure sensor and footer depicted in FIG. 16A.

FIG. 16C is a side elevation view of the pressure sensor and footer depicted in FIG. 16A.

FIG. 16D is a top perspective view of the pressure sensor and footer depicted in FIG. 16A.

FIG. 17 is a schematic diagram illustrating a bottom keg, a top keg, and an embodiment of a sensor adapted to nest between the kegs.

FIG. 18A is a side, partial cutaway view of a radial restraint on a sensor.

FIG. 18B is another side, partial cutaway view of a radial restraint on a sensor.

FIG. 18C is yet another side, partial cutaway view of a radial restraint on a sensor.

FIG. 19 is a schematic diagram of a system for ordering, distributing, reporting, and/or payment processing for bulk beverages according to one embodiment of the present disclosure.

FIG. 20A is a bottom plan view of an embodiment of a stacker adapter according to one embodiment of the present disclosure.

FIG. 20B is a top plan view of the stacker adapter depicted in FIG. 20A.

FIG. 20C is a side cross-sectional view of the stacker adapter depicted in FIG. 20A positioned between a two kegs of different sizes.

FIG. 21 is a schematic diagram of a process for establishing ownership of a keg according to one embodiment of the present disclosure.

FIG. 22 is a bottom plan view of an embodiment of an adjustable sensor attached to a keg according to one embodiment of the present disclosure.

FIG. 23 is a bottom plan view of an adjustable sensor according to another embodiment of the present disclosure.

FIG. 24A is a top plan view of an adapter according to one embodiment of the present disclosure.

FIG. 24B is a bottom plan view of the spacer adapter depicted in FIG. 24A.

FIG. 24C is a side cross-sectional view of the spacer adapter depicted in FIG. 24A mounted on a sensor and a spacer.

FIG. 25 is a tag according to one embodiment of the present disclosure.

FIG. 26 is a chart displaying the profit margin of two beverages over time.

FIG. 27A is a diagram depicting suggested order calculation according to one embodiment of the present disclosure.

FIG. 27B is a diagram of an example suggested order calculation according to one embodiment of the present disclosure.

FIG. 28 is a user interface for ordering beverages according to one embodiment of the present disclosure.

FIG. 29 depicts side elevational views of a keg with a sensor on bottom; two kegs with sensors on bottom and a keg stacker between them; and two kegs with sensors on bottom and a keg spacer between them according to one embodiment of the present disclosure.

FIG. 30 is a flow chart of a draft beer supply chain system and method according to at least one embodiment of the present disclosure.

FIG. 31 is a flow chart of a draft beer supply chain system and method according to at least one other embodiment of the present disclosure in which a unique serial number may be associated with an RFID tag.

FIG. 32 is an enlarged view of a portion of the flow chart of FIG. 31 associated with a brewery.

FIG. 33 is an enlarged view of a portion of the flow chart of FIG. 31 associated with a distributor warehouse.

FIG. 34 is an enlarged view of a portion of the flow chart of FIG. 31 associated with a retailer bar or restaurant.

FIG. 35 is an enlarged view of a portion of the flow chart of FIG. 31 associated with the return of empty kegs to a brewery.

FIG. 36 is a top perspective view of one embodiment of a no-clip weight sensor of the present disclosure.

FIG. 37 is a top perspective, partially exploded view of the weight sensor of FIG. 36.

FIG. 38 is a bottom perspective view of the no-clip weight sensor of FIG. 36.

FIG. 39 is a cross-sectional view along line 39-39 in FIG. 37.

### DETAILED DESCRIPTION OF THE ILLUSTRATED EMBODIMENTS

For the purposes of promoting an understanding of the principles of the disclosure, reference will now be made to one or more embodiments illustrated in the drawings and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to “advantages” provided by some embodiments, other embodiments may not include those same advantages, or may include different advantages. Any advantages described herein are not to be construed as limiting to any of the claims.

Specific quantities (spatial dimensions, temperatures, pressures, times, force, resistance, current, voltage, concentrations, wavelengths, frequencies, heat transfer coefficients, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

At least one embodiment of the present disclosure includes a system/method for measuring the amount of liquid in a portable liquid container and wirelessly communicating that information to a database in order to automatically establish/maintain an inventory of the amount of fluid in each container. Particular embodiments include detecting the level of beer in a keg and relaying that information to a central database that can be used, for example, by a distributor to know when certain kegs need to be replenished.

At least one embodiment includes: a sensor for detecting the fluid level; an identification device that identifies the brand/type of fluid (beer); a transmitter/link that wirelessly connects the sensor and ID device to a database; and a database for maintaining the information (likely connected to a wireless network).

Detecting the level of fluid (beer) in each individual container (keg) may be accomplished in at least two ways. One is a weight sensor attached to the bottom of the portable keg. Another is a sensor that determines the fluid level by generating and evaluating a signal directed to the container. One example is a transmitter that transmits energy into the container. Another example is a transmitter that reflects energy (e.g., sound waves) off the surface of the liquid.

Identifying the brand/type of fluid (beer) in each individual container (keg) may be accomplished in at least two ways. One is to encode information related to the brand/type of liquid (beer) in each container (keg) to the fluid level sensor attached to each keg. Another is to use a device separate from the fluid level sensor and encoded this separate device with the brand/type of beer in the keg. This separate identification device can be attached to each container (such as to the hand grip holes in a keg) using, e.g., a bracket, zip tie, clip, bayonet fitting, etc.

The transmitter can receive information from both the fluid level sensor and the identification device and can wirelessly relay this information (e.g., using established wireless networks) to a database. In one embodiment, the transmitter is included with the fluid level sensor; however, other variations include a transmitter included with the identification device or a transmitter that is separate from both the fluid level sensor and the identification device.

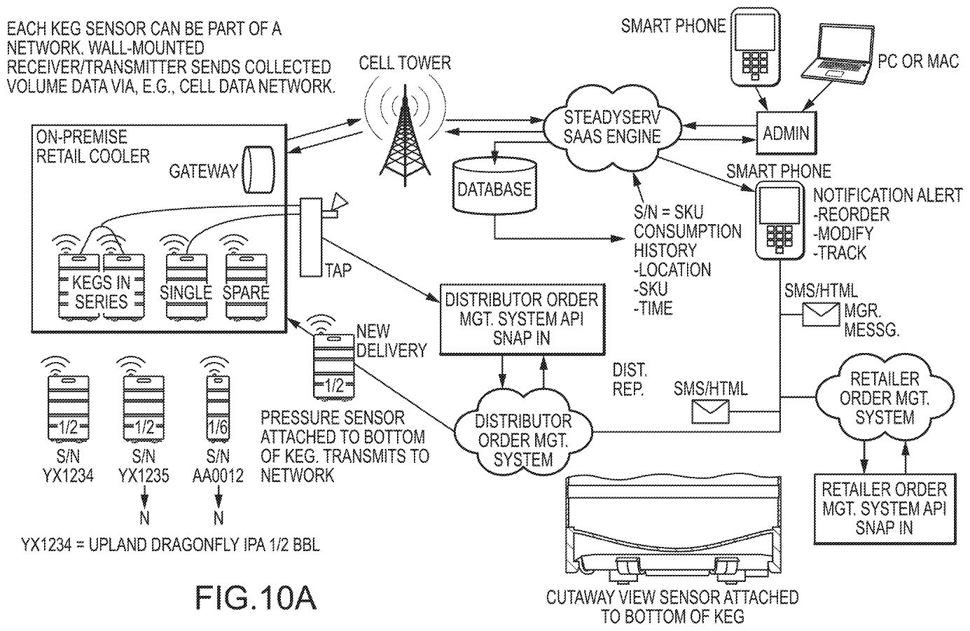

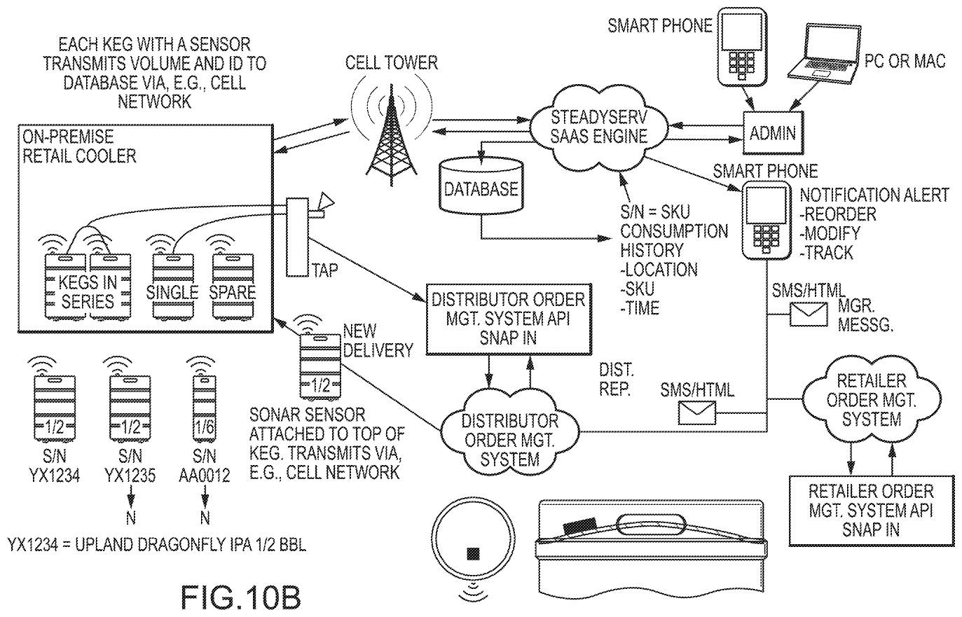

At least one embodiment utilizes a combined fluid level sensor and transmitter with a separate identification device. The identification device may be a wireless communication device (such as an RFID device, which may take the form of an RFID tag and/or a bar code display), or may require physical connection (such as a thumb drive or the like). In use, a delivery person can arrive at a bar/restaurant with a keg that has an RFID device attached identifying the brand/type of beer (or other characteristic of the liquid in the container to which the RFID device is associated) in the keg. A combined fluid level sensor and transmitter (which can be generic and used with any keg) is attached to the container (keg), which may be accomplished prior to delivery to the customer, and the combined sensor/transmitter is paired with the RFID device. Once paired, the sensor/transmitter can transmit information related to the amount of beer and the brand/type of beer (or other characteristic(s) of the liquid) in the keg to the database. Multiple kegs and sensor/transmitters can be monitored and information about the kegs can be maintained, interpreted, and disseminated in a variety of ways that may be useful to brewers, distributors, sales establishments, and/or customers. See, e.g., FIGS. 10-12 and 14.

A user of the database can be able to use real-time information about the kegs in a variety of ways, such as enabling the distributor to automatically deliver fresh kegs when needed or to provide real-time information to consumers so the consumer can determine which bars/restaurants have their preferred beverage in stock. Various embodiments include database interfaces for the restaurant owner, customers, distributors and beer manufacturers that may be used in a variety of combinations to facilitate the efficient delivery of liquid in bulk containers for consumption.

At least one embodiment of the present disclosure uses on-keg monitoring devices to keep track of substantially real-time levels of draft beer in inventories of on-premises beer retailers. Data collector(s) at each site periodically transmit the data to a centralized data storage and processing facility. Alerts are sent to key personnel when it is time to place another order, and supply chain mechanisms leverage the data for efficient resource planning and movement at all stages. Consumers are able to find favorite beers by accessing the inventory data through a mobile app, and other uses are made of the collected data.

The draft beer industry employs re-usable aluminum kegs to distribute draft beer. The kegs are simple aluminum vessels that can be filled with beer, pressurized, and then the beer flows out of a top-mounted valve/spout. The keg typically embodies no technology beyond a simple pressure valve/spout on the top.

Kegs are often designed with a spherical round bottom that is surrounded or collared with a round aluminum sheath that allows the keg to sit upright and level. This collar on the bottom of the keg, combined with the spherical round bottom, creates a constructed void or space under the keg. All kegs have this empty space under the main container portion.

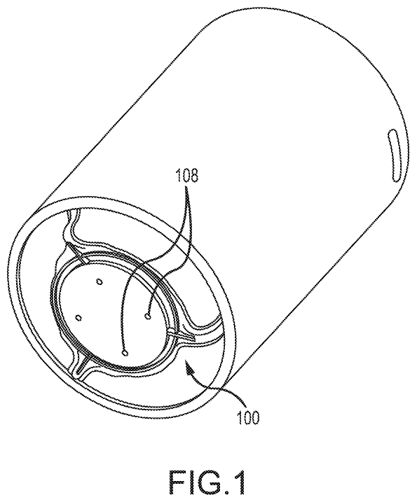

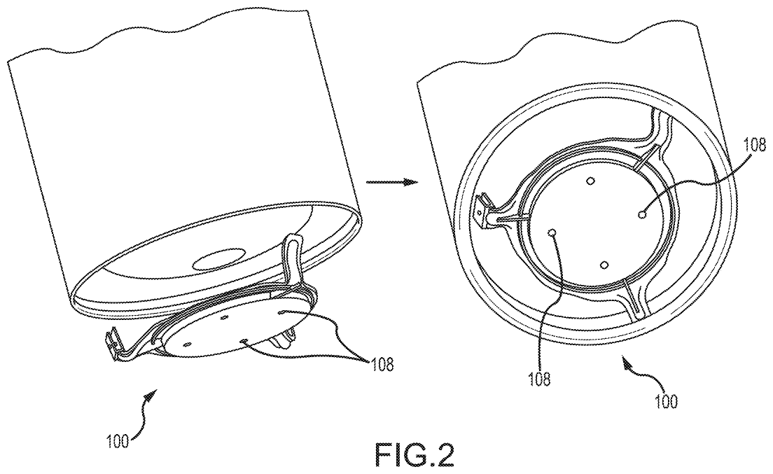

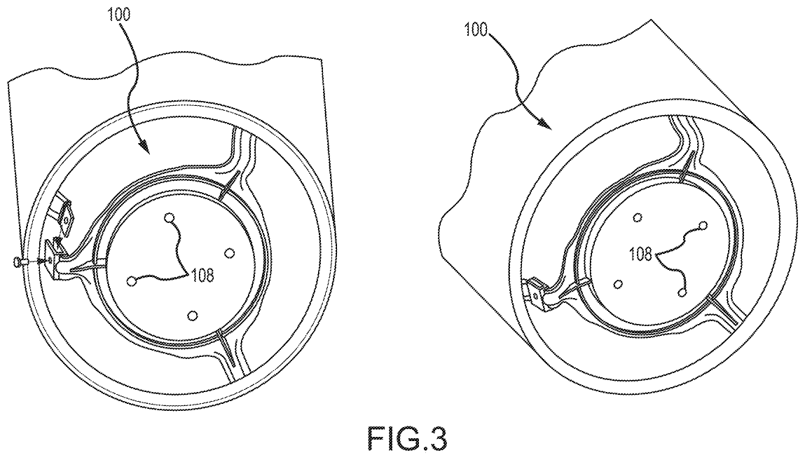

At least one embodiment of the present disclosure includes a sensor and transmitter (which may be referred to as a sensor/transmitter) that attaches to the bottom of the keg, such as fitting in this space under the bottom of the keg. In one embodiment, illustrated in FIGS. 1-3, the sensor 100 is generally a pressure sensor, which in at least one embodiment is an analog electronic device that converts weight into an analog value calibrated to the weight of a full keg. When the sensor 100 is mounted to the bottom of the keg, the sensor weight element 108 rests on the floor. In some use scenarios, kegs are stacked on top of each other. In such situations, the system vendor can supply a rigid, hard plastic mat (not shown) that can fit on the top of a keg to provide a hard, level surface for the keg sensor/transmitter on the next layer up to sit on. In this stacking scenario, the sensors on the bottom kegs can be adjusted to account for there being more than one keg resting on top of the sensor weight element 108, such as by transferring weight information to/from the kegs above. In the illustrated embodiment, sensor 100 has a circular center portion with connection brackets extending outward in a generally star-shaped configuration, although other shapes are contemplated.

The sensor 100 registers pressure from the weight of the keg. In the case of a full keg that has a maximum volume and weight, the sensor registers a maximum analog value, which is converted in the present embodiment into a digital value by an analog-to-digital converter (ADC) onboard the microcontroller chip in the sensor/transmitter unit. In some embodiments, the conversion uses an 8-bit value, while in others, another range of digital outputs (such as 0-20, or, in other embodiments, 0-10, 0-50, 0-100, or 0-240) is used. Using this latter form as an example, as the keg is depleted, the value changes from 20 to 19, 18, 17, etc. all the way down to 0 (zero), which is the value corresponding to the weight of an empty keg. The keg sensor/transmitter electronics communicate the weight value of 0-20 to the keg transmitter. The keg transmitter may be housed in the bottom of the keg and may be connected by wire (or wireless) to the keg sensor. In the present embodiment, the keg transmitter communicates with the local uplink/gateway (such as using ZigBee protocols, Bluetooth protocols, other IEEE 802.15 protocols or IEEE 802.11 protocols, or similar wireless protocols), which communicates with a larger network (such as a cellular telephone network or a mesh network). Alternate embodiments utilize alternate wireless data transmission technologies as will occur to those skilled in the art in view of the present disclosure.

In some embodiments, the keg sensor can remain asleep and wake up periodically to receive a signal related to the current weight of the keg, communicate with the network (e.g., the cellular network, which may be via the local uplink/gateway) and transfer data to and/or from a database (which may take approximately 10-20 seconds in some embodiments), then go back to sleep. In one embodiment, the keg sensor wakes up and communicates with the network once every hour. In other embodiments, the sensor will wake up more or less frequently depending on the time of day or the day of the week/year. In still other embodiments, the sensor wakes up based on a schedule received from a database, which may be adjusted by the database. For example, if an algorithm evaluating data form a database determines that beer A is selling quickly and beer B is not selling quickly, a command can be sent through the network to one or more sensors associated with beer A (e.g., through a cellular network, which may be sent to the sensor via a local uplink/gateway) instructing the one or more sensors associated with beer A to wake up and communicate with the database every 20 minutes and/or a command can be sent through the network to one or more sensors associated with beer B instructing the one or more sensors associated with beer B to wake up and communicate with the database every 2 hours. In addition to sending instructions modifying the wake up schedule of a sensor, other software updates may also be delivered wirelessly from the network to the sensor/transmitter and/or the uplink.

In at least one embodiment, the keg transmitter may also have a flash memory that has been preprogrammed with several software parameters. One of these parameters can be a Serial Number corresponding to the individual keg sensor/transmitter. That is, each and every keg sensor Transmitter can have its own unique Serial Number that is programmed into the software when the unit is manufactured. In addition to the Serial Number, the software version number may be pre-programmed. The keg transmitter software may also be programmed with certain functions and intelligence. In this embodiment, the software may be programmed at the factory to perform various functions, including waking itself up at predetermined times, at specific intervals of time, or upon the occurrence of specific events or actions and transmitting a signal via a wireless network (e.g., ZigBee, Bluetooth, or other) to check whether it is in range of an uplink/gateway. When the transmitter is shipped to an equipped warehouse, the keg transmitter can first wake up and connect with an uplink/gateway. At that point, the keg transmitter can begin to check for an uplink/gateway every hour.

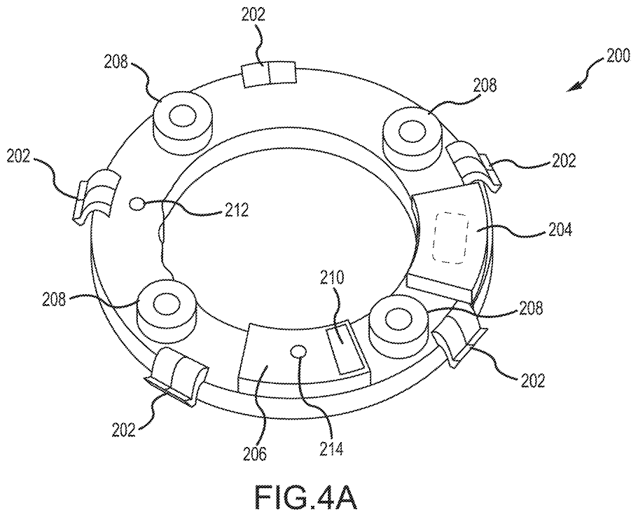

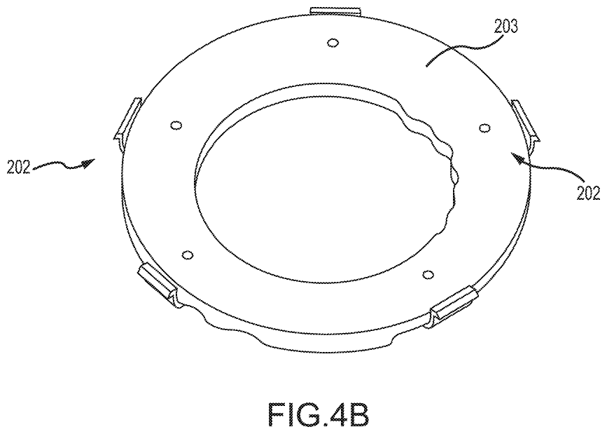

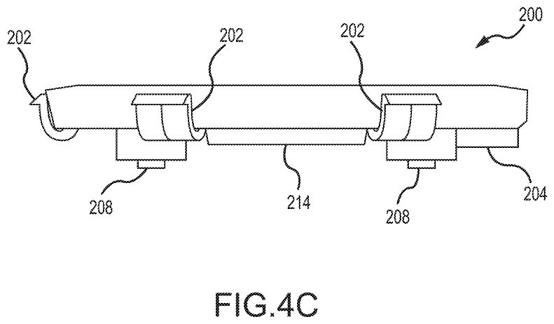

Depicted in FIGS. 4-6 is a weight or volume sensor 200 according to another embodiment of the present disclosure. Sensor 200 is configured and adapted to attach to the bottom of a large beverage container (such as a beer keg) and sense the weight of the container. Sensor 200 includes an upper housing 201a, a lower housing 201b, and one or more fasteners 202 that prevent sensor 200 from falling off the keg when the keg is lifted off the support surface or tilted. Sensor 200 also includes one or more abutment surfaces 203 that abut the bottom surface of the keg and permit sensor 200 to support the keg keeping it slightly elevated above the support surface. Abutment surfaces 203 may be downwardly sloping in radially inward directions as shown. In the illustrated embodiment, sensor 200 is doughnut-shaped (toroidal) (also referred to as annular or ring-shaped) being generally circular with a circular aperture in the center, although other shapes are contemplated.

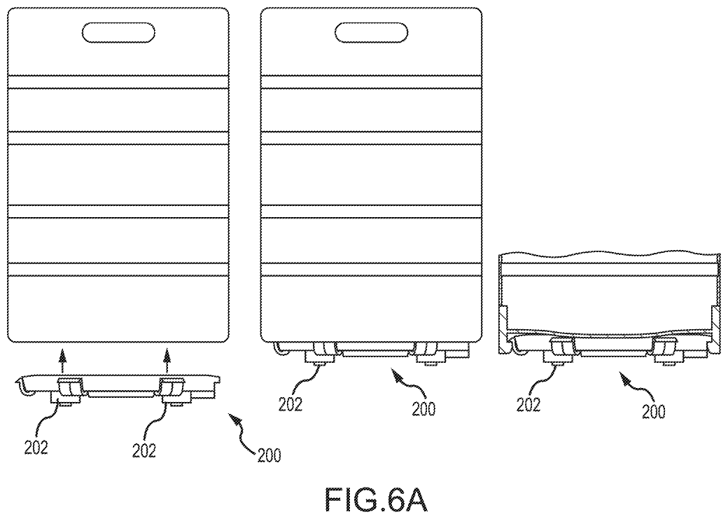

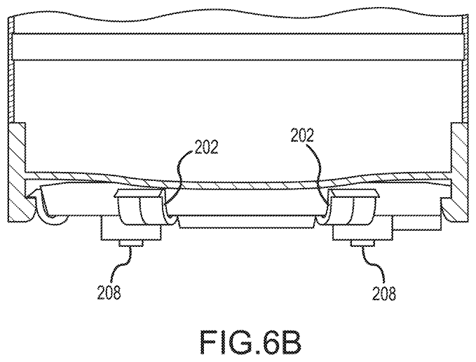

When installed, sensor 200 attaches inside the cavity (false bottom) on the underside of the keg (see, e.g., FIGS. 6A and 6B). Sensor 200 optionally does not extend to the outside surface of the keg, and may optionally attach to the keg at a location where sensor 200 does not contact the support surface and is not damaged when the keg is tipped onto its bottom edge/lip and rolled/rotated as is commonly done when moving kegs (see, e.g., FIG. 6B). In the illustrated embodiment, sensor 200 includes five fasteners 202 that clip to the inside of the lip that forms the bottom of the keg. See e.g., FIGS. 6A and 6B. In at least one embodiment, fasteners 202 are configured and adapted to allow a user to attach sensor 200 to a keg and detach sensor 200 from a keg using only the user's hands. In FIG. 6B the sensor is depicted as flexing and snapping firmly into place on the rolled lip, although other embodiments affix to the keg in different, yet secure, fashions.

In at least one embodiment, a user may place sensor 200 on the support surface, place a keg on top of sensor 200, and exert a downward force on the keg to attach sensor 200 to the bottom of the keg. The downward force may be supplied in whole or in part by the weight of the keg (and possibly its contents). In still other embodiments, a user can attach sensor 200 to the bottom of a keg by placing sensor 200 on a support surface, tipping the keg at an angle and rolling the keg on its lip into close proximity with sensor 200, then lowering (un-tipping) the keg onto sensor 200, and using a downward force of the keg on sensor 200 (which may be supplied in whole or in part by the weight of the keg itself) to connect sensor 200 to the keg. In some embodiments, the connection between sensor 200 and the keg is sufficiently strong so that sensor 200 will not disconnect from the keg when the keg is raised above the support surface (or tipped with respect to the support surface) until the user disengages one or more of the fasteners 202.

Sensor 200 further includes a receiver 204 that receives data from an electronic device (typically attached to a keg, such as an RFID device) containing information about a characteristic of the fluid within the keg. (As used herein, a characteristic of the fluid within a keg includes, but is not limited to, the brand-name, type, manufacture date, or other characteristic about the fluid a distributor, retail seller, or consumer would be concerned with). Receiver 204 may be contained within a compartment (e.g., receiver cavity 204d) that is covered by receiver cover 204a, and may optionally include a waterproof strip 204b. Receiver 204 may also include an antenna 205, which may be contained within the same compartment as receiver 204. Receiver 204 and/or antenna 205 may be a printed circuit board (PCB).

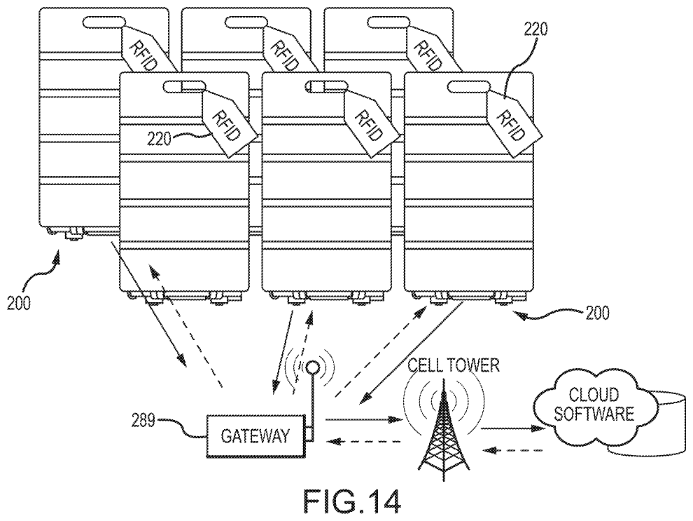

Sensor 200 further includes a transmitter 206 that communicates with a wireless network and can transmit information concerning a characteristic of the fluid in the keg to which sensor 200 is attached (which may be received from an RFID device 220 associated with the keg via receiver 204) and/or information about the weight of the keg to the wireless network. (See, e.g., FIG. 14). Transmitter 206 may be contained in a compartment (e.g., transmitter cavity 206c) covered by transmitter cover 206a, and an optional waterproof strip 206b may be included to inhibit water from entering into the transmitter compartment. In one embodiment, transmitter 206 is relatively planar in appearance as depicted by the example transmitter 206 and may be on a printed circuit board (PCB).

In alternate embodiments receiver 204 is both a receiver and a transmitter capable of two-way communication with the electronic device (e.g., RFID device) associated with the keg containing information about the liquid contained within the keg.

In alternate embodiments transmitter 206 is a receiver and a transmitter capable of two-way communication with the wireless network.

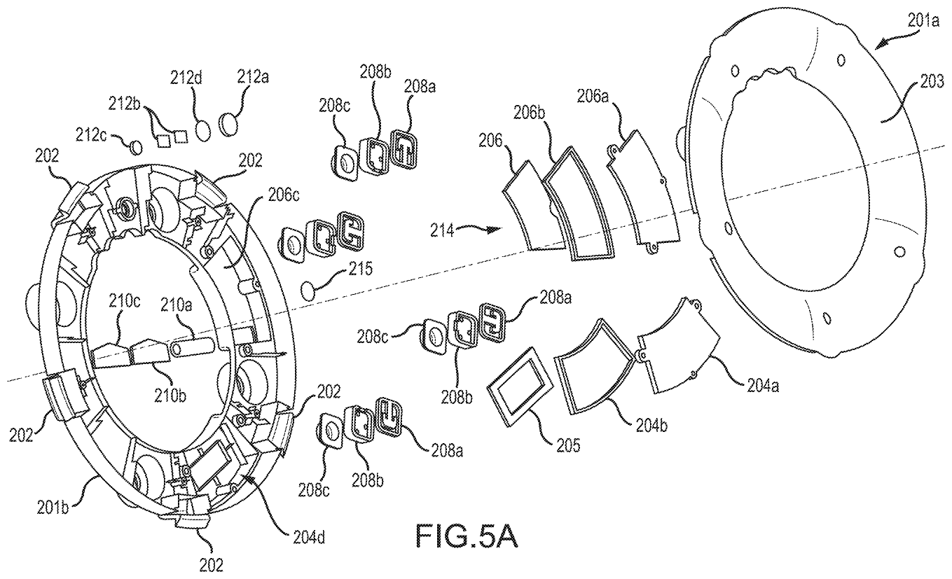

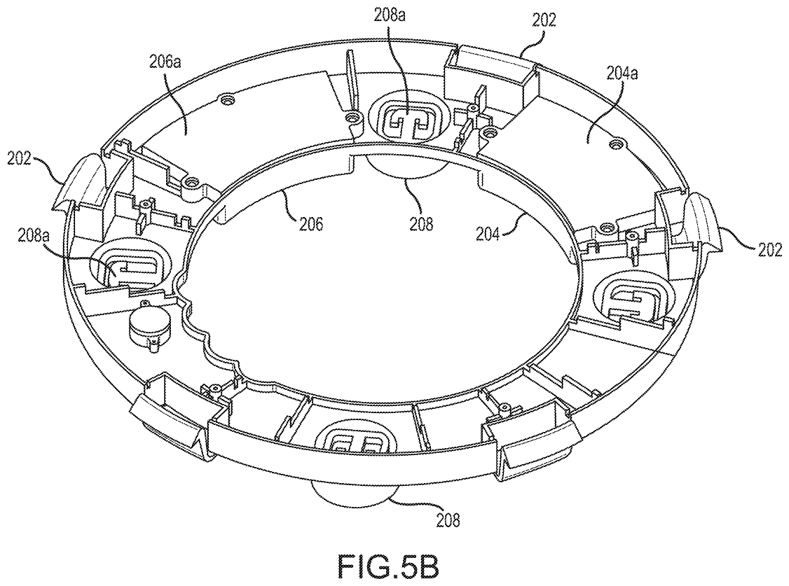

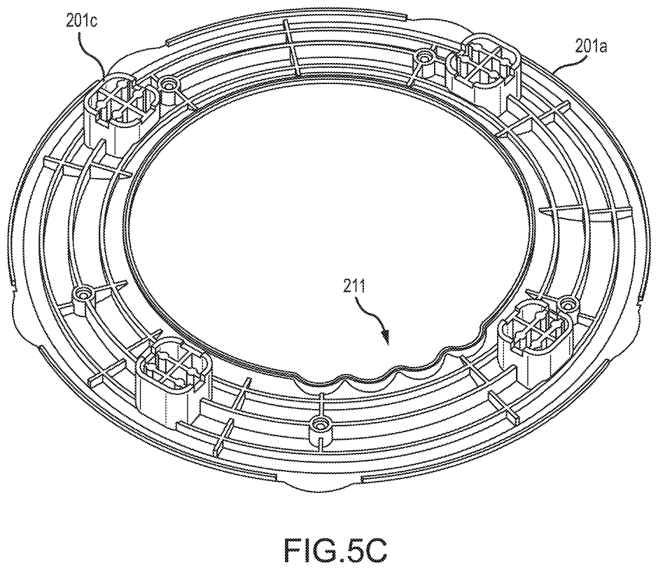

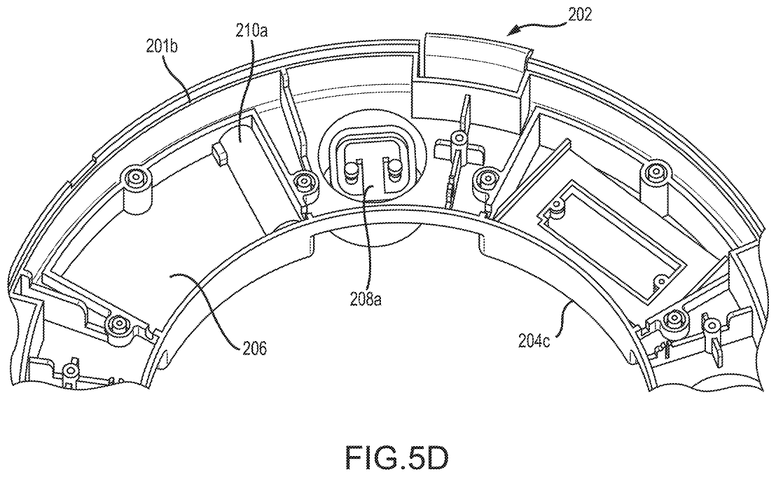

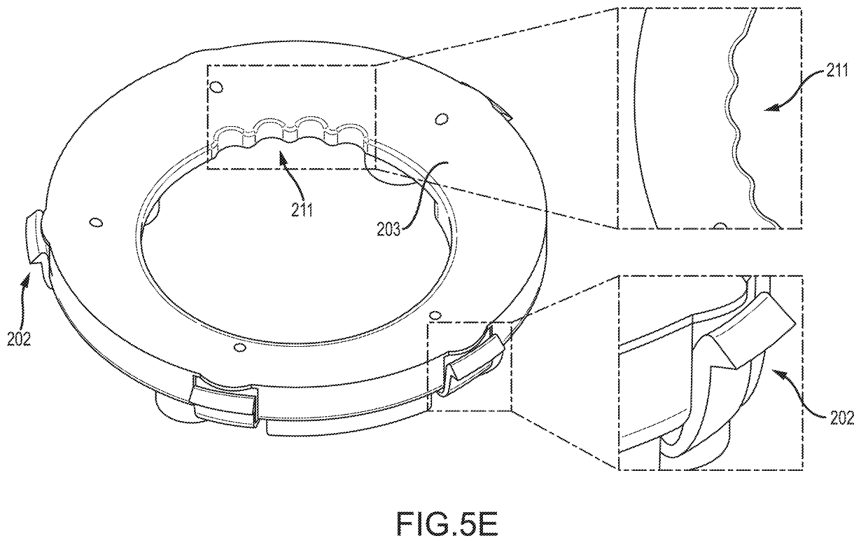

Sensor 200 further includes one or more weight sensing elements or weight sensors 208 that sense the weight of the keg (such as by measuring the pressure exerted on the weight sensor 208 by a support surface upon which sensor 200 and the keg are placed). In one embodiment, sensor 208 includes a weight sensing member 208a, a frame 208b, and a foot 208c. Four weight sensors 208 are depicted in the embodiment represented by FIGS. 4-6. In embodiments with fewer than three weight sensors, additional supports can be utilized so that the keg to which sensor 200 is attached is stable and will not easily tip when resting on a support surface. In some embodiments, the upper housing 201a can include support locations (such as the four weight sensor support locations 201c depicted in FIG. 5c) that may be used to hold the weight sensors in place.

Sensor 200 can include a battery compartment 210 for housing a battery 210a to provide electrical power to the various components of sensor 200. The battery compartment may be covered by a cover 210c and an optional waterproof strip 210b.

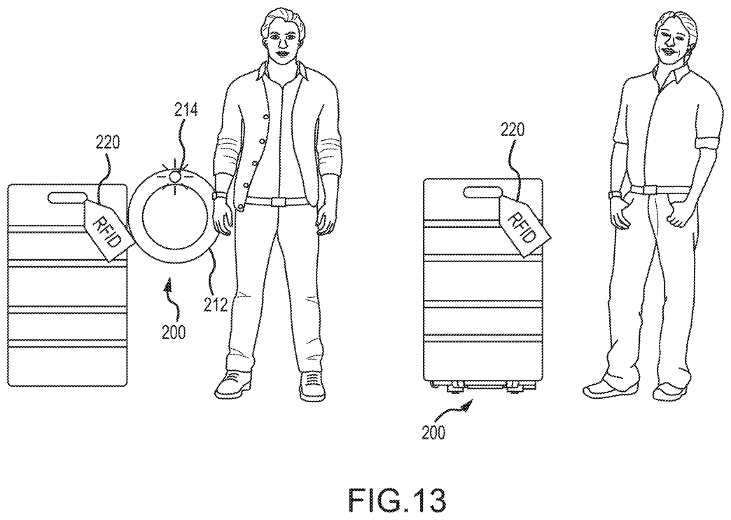

Sensor 200 may also include an optional RFID pairing capability in which a user can pair sensor 200 with an RFID device 220 (e.g., an RFID tag) (see, e.g., FIG. 13) containing information about the liquid in the container to which sensor 200 is (or will be) attached. As an example, the pairing system may include a pairing button 212 that a user depresses when in proximity to the RFID device with information related to the liquid in the keg and transfer this information from the RFID device to sensor 200. In at least one embodiment, pairing button 212 includes pairing switch cover 212a, pairing switch 212b, button 212c and an optional waterproof strip 212d. Sensor 200 can then transmit this information related to the liquid in the keg to a wireless network. An optional pairing light 214 (and/or another indicator such as sound generator 215 (FIG. 5A)) may be included as an indication to the user that sensor 200 has been paired with the RFID device. FIG. 13 depicts a user pairing a sensor to an RFID device attached to a hand hold aperture of a keg then installing the paired sensor on the keg.

Sensor 200 may also include an annular body having a handhold 211 (which may include indentations) on a radially inward edge of the annular body. Handhold 211 can assist a user in handling sensor 200. In embodiments where the orientation of sensor 200 may not be readily ascertained by a user (such as when sensor 200 is symmetrical), handhold 211 may serve as an indication of the orientation of sensor 200 (such as being positioned at a certain orientation with respect to the pairing button 212 to facilitate the user quickly locating pairing button 212), or can assist in easing removal of sensor 200 from a keg by providing the user a readily identifiable and easy place to pull the sensor 200 away from the keg.

In some embodiments of the present invention, the pairing device and RFID devices are configured for short range use to avoid interference with other RFID devices that may be stored nearby. For example, in one embodiment, the pairing system and RFID device have a maximum pairing range of approximately 15 feet. In other embodiments, the pairing system and RFID device have a maximum pairing range of approximately five (5) feet. In yet other embodiments, the pairing system and RFID device have a maximum pairing range of approximately two (2) feet. In still further embodiments, the pairing system and RFID device have a maximum pairing range of approximately one (1) foot. The short range pairing feature may have particular advantages in environments where there are multiple kegs with a sensor 200 and RFID device attached to each keg. (See, e.g., FIG. 14).

In at least one embodiment, each RFID device is programmed with a unique serial number and unique attributes of the liquid contained in the keg can be assigned to the tag via a wireless network and the attributes associated with a particular RFID device may be manipulated through the wireless network without requiring use of an RFID writer in close proximity to the RFID device.

The sensors and sensor/transmitters disclosed herein are constructed of material sufficiently strong to carry the large weight loads of a full keg and capable of operating at low temperatures, such as would be encountered in a refrigerated location, and may include various types of plastics, composites, metals, and/or alloys.

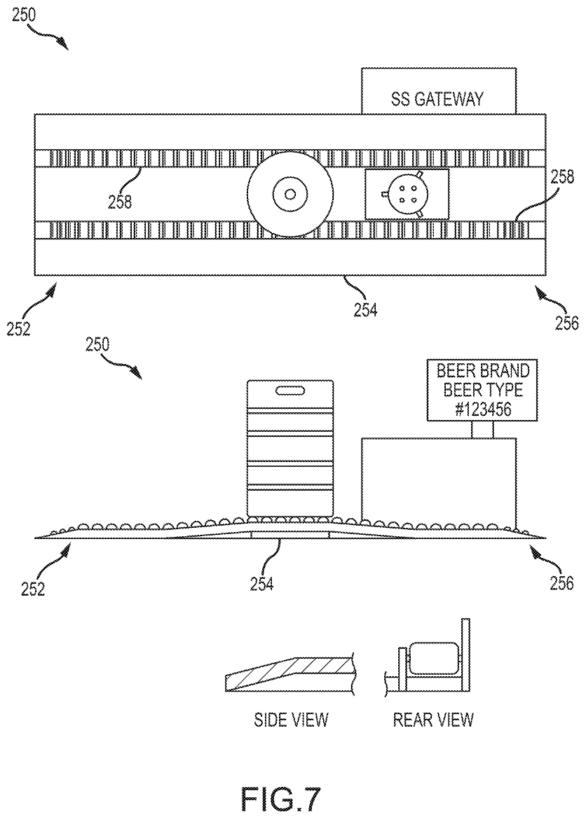

The keg sensor/transmitters may be sent in quantity to the beer distributor's warehouse. At the beer distributor's warehouse, the keg sensor/transmitter may be installed on a keg. For example, in one embodiment, the keg sensor/transmitter is mounted on the bottom of the keg in the recessed cavity that is created where the convex portion of the keg comes in contact with the outer edge. The keg has a molded lip on the outer portion of the keg that allows a tongue-and-grove fitting to be pushed into place. To achieve the fitting of the keg sensor/transmitter to the bottom of the keg, one may use a suitable keg installer, which will now be described in view of FIG. 7.

The keg installer 250 in this embodiment is a fabricated aluminum and steel platform consisting of three large pieces: the inbound ramp 252, the Plateau 254, and the outbound ramp 256. The inbound ramp 252 is approximately four feet wide and six feet long. The inbound ramp 252 has a total of approximately 20 rubber rollers 258 with each roller approximately 4 inches in width. The rollers 258 are mounted on aluminum rails spaced the width of a beer keg. There is a hollow space between the rails. There are 10 rollers on the left rail and 10 rollers on the right rail. The beginning part of the inbound ramp 252 uses small rollers that start at floor level. The inbound ramp 252 is on an incline starting at floor level then rising to approximately 5 inches off of the ground.

In use, a beer distributor warehouse worker moves a full keg of beer to the beginning of the inbound ramp 252 and positions the keg in the middle of the ramp. The worker then slightly tips the keg and scoots it forward so the keg rests on the first rubber rollers of the inbound ramp 252. The worker then pushes the keg up the inbound ramp 252 as it rolls on the rubber rollers.

The inbound ramp 252 in this embodiment is bolted directly to the Plateau portion of the keg Installer. The Plateau has approximately 12 rollers—6 rollers on the left rail and 6 rollers on the right rail. The rails and rollers in this embodiment match up exactly in alignment with the rails and rollers on the inbound ramp 252.

The outbound ramp 256 in this embodiment is approximately four feet wide and six feet long and is bolted directly to the Plateau portion of the keg installer 250. The outbound ramp 256 has approximately 20 rollers with each roller approximately 4 inches in width. There are 10 rollers on the left rail and 10 rollers on the right rail. There is an open space between the rails. The rails and rollers match up exactly in alignment with the rails and rollers on the Plateau. The outbound ramp 256 is on a decline starting at approximately 5 inches off of the ground going down to floor level.

In the open space between the rails on the outbound ramp 256 is a keg sensor/transmitter Installation device. A keg sensor/transmitter that is ready to be installed on to a keg is placed into the platform device between the rails. As the keg descends the outbound ramp 256 the weight of the keg pushes down on the installation device platform triggering a hydraulic lever. That lever flexes the keg sensor/transmitter housing and pushes the keg sensor/transmitter housing into the cavity in the bottom of the keg. The hydraulic lever then un-flexes the keg sensor/transmitter housing, and the housing snaps into place in the keg bottom cavity.

The warehouse worker then continues to move the keg down the outbound ramp 256 to floor level. The keg now has the keg sensor/transmitter installed, and it is ready to be delivered to the retailer. The warehouse worker now can put a new keg sensor/transmitter into the keg installer 250 and repeat the process.

Once a keg is empty, it can be picked up by the beer distributor delivery driver to be returned to the beer distributor warehouse. Since the keg is now empty, the keg is very light and can be easily picked up and turned over by the delivery driver or warehouse employee. The keg sensor/transmitter can have the bar code or QR code assigned to it in the distributor's inventory system. The keg sensor/transmitter in this embodiment can be taken off of the keg by hand and can be put in one of, e.g., four bins.

Bin #1: The sensor is good and can be re-used. It is put in a bin labeled with the beer brand and type.

Bin #2: The beer brand and type is no longer in distributor inventory. The warehouse employee uses the SaaS Software to re-assign the keg sensor/transmitter's individual serial number to the SKU associated with another beer brand and type.

Bin #3: The bar code is faded and needs to be replaced.

Bin #4: The battery life of the sensor has exceeded normal life, and the sensor needs to be returned to the system vendor.

At system initialization, the SaaS database can be populated with all of the current beer brand and type SKUs. As time goes by, however, new beer SKUs may appear. Each beer distributor warehouse and accounting employee on the overall system can enter in new beer brands and types with their corresponding SKUs. These new SKUs can be made available to all beer distributor users across the entire overall system. That is, the process of updating new SKU's into the SaaS system can be crowdsourced.

The keg installer 250 in the embodiment just described is made of three pieces—the inbound ramp 252, the Plateau 254, and the outbound ramp 256—so that it can be easily assembled and disassembled for shipping to beer distributor warehouses. In alternative embodiments and situations, the keg installer 250 can be used with the Plateau and the outbound ramp 256, eliminating the inbound ramp 252. The option is up to the beer distributor warehouse. By removing the inbound ramp 252, a forklift can be driven up directly to the Plateau portion of the Installer, and the keg can be moved off of the forklift onto the Plateau to complete the installation.

The keg installer 250 is both a mechanical installer of the keg sensor/transmitter and a point at which a warehouse worker can check to be sure that the keg on which he is installing the keg sensor/transmitter matches the Order Pick List. As shown in FIG. 7, a small computer and monitor can be mounted to the keg installer 250. In addition, an uplink/gateway can be mounted on the keg installer 250. This uplink/gateway can have a desensitized receive antenna so that it receives only from the keg sensor/transmitter that is being installed onto the keg. As the worker rolls the keg through the installation process, he can perform a visual check to make sure that the content of the keg he has in front of him on the installer matches what the SaaS system says it should be, and it matches the Order Pick List. That Order Pick List in some embodiments can be a piece of paper with the order written on it, while in other embodiments the SaaS system can have an EDI (Electronic Data Interface) connection to the beer distributor's inventory system.

So, for example, the keg that is being rolled onto the installer may have a paper keg collar. A paper keg collar clipped on a keg's top valve is a common way of identifying the contents of a keg. The worker looks at the keg collar and sees that the beer in the keg is identified as “Bell's Founder's Ale”. As the worker installs the keg sensor/transmitter, the unit transmits its serial number as KS1234 through the uplink/gateway. The SaaS application displays on the computer monitor that the sensor is associated to the SKU for “Bell's Founder's Ale,” and that confirms the correct Sensor Transmitter is being put on the correct keg. The SaaS Software also displays the Order Pick List and the warehouse worker can confirm that it is the correct keg/product to go out.

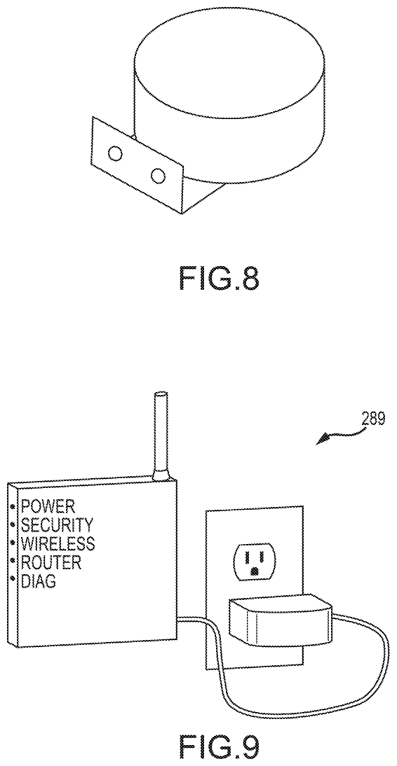

The top-mounted keg sensor/transmitter shown in FIG. 8 is a sound wave-based unit that can be mounted on the top of a keg in some embodiments of the present system, and can be mounted on the bottom or sides of the keg in other embodiments. The top-mounted keg sensor/transmitter may be mounted with its bottom surface sensor side flush and flat with the top surface of the aluminum keg. To accomplish that flush mounting, a top-mounted keg bracket may be used, such as one made out of aluminum and/or steel. The bracket may be approximately 6 inches in length. At the top of the bracket there can be a “Y”-shaped fork, and at the bottom of the bracket there can be a “T”-shaped end. In the middle can be the actual keg sensor/transmitter, which is approximately 3 inches square in one embodiment. The top-mounted bracket can be designed with a pressure spring, hand lever, and lock. The bracket may be placed on the top of the keg with the “Y” shape up against the keg valve. A branch of the “Y” sits on either side of the valve. The “T”-shaped end can rest in the outer edge of the top of the keg. The bracket can be put into place and the hand lever pushed down, which creates pressure on the spring and flexes out and bows the bracket out and down. The bracket flexes out the “Y” and the “T,” and the hand lever locks into place, securing the bracket to the keg with equal and opposing force on the “Y” at the valve and the “T” at the edge of the keg top. The force also pushes the keg sensor/transmitter firmly onto the top of the keg with the downward force. The action of the bracket in this embodiment is similar to the concept behind a snow ski binding. The bracket can be removed by unlocking the lever, the force is removed, and the bracket is free.

The majority of beer kegs used by craft brewers in the county are leased from one of several third-party keg leasing companies. In certain embodiments, agreements with keg leasing companies and with keg manufacturers can allow a more permanent mount to be included on kegs for the top-mounted keg sensor/transmitter.

The design form that may be used for the top-mounted sensor is similar, in some embodiments, to a large hockey puck, a large thimble, or a form ranging between the two. For description purposes, the “puck” form of the design will be discussed. The flat side of the “puck” can sit on top of the keg, pressed against the top surface. In some systems, the data vendor works with keg manufacturers and keg-leasing companies to spot-weld an aluminum bracket to the top of each keg. The top-mounted keg sensor/transmitter would then be attached to the top of the keg by attaching it to this welded bracket. In some embodiments, this design would be very similar to a bayonet-mount camera lens. The round-shaped top-mounted keg sensor/transmitter would have a three-pronged male bayonet mount. The bracket mounted on the top of the keg would have a recessed female bayonet mount. The keg sensor/transmitter would be placed on the top of the mount, and with a one-quarter clockwise twist, the keg sensor/transmitter mount would be securely mounted onto the keg.

The uplink/gateway in various embodiments is a self-contained unit that can be mounted on the wall, such as outside of the beer cooler, of an on-premises retailer (bar or restaurant) that contracted with their local beer distributor to use the service described herein. The uplink/gateway can be a moisture-resistant, shock-resistant plastic box that contains radio receivers, computer hardware, computer software, and radio transmitters. Each uplink/gateway can have its own unique serial number that is embedded into the uplink/gateway software. An uplink/gateway 289 according to at least one embodiment is depicted in FIG. 9.

The uplink/gateway consists of two major areas and functions in some embodiment. The hardware radio receiver and software stack receives the data transmissions from each keg sensor/transmitter within its range, which are typically the keg sensor/transmitter(s) in the nearby cooler. The receiver receives the data, organizes the data, and tags the data with information unique to the individual uplink/gateway including the unit's unique serial number and version number. Once the receiver and software stack has organized that data, it is sent to a gateway, e.g., a CDMA, GMA or like standard cellular connection gateway (collectively referred to as “CDMA uplink/gateway”). This overall system is illustrated in FIG. 10A. Information about the contents in each keg may also be communicated to the sensor/transmitter using a separate data storage device (such as an RFID device) attached to the keg, which is paired with and transfers information to the sensor/transmitter for uplink to the larger network.

The CDMA uplink/gateway is a transmitter/receiver that contains both radio hardware and software. The CDMA uplink/gateway in some embodiments can be constructed with specifications provided by a wireless carrier partner, such as Verizon Communications. (In other embodiments, of course, GSM and/or other wireless data transmission protocols are used instead of or in addition to CDMA.) The uplink/gateway can join the carrier's data service by connecting the closest cell phone tower to the on-premise retailer where the uplink/gateway has been placed. The uplink/gateway relays the data from the keg sensor/transmitter(s) that has been collected by the receiver. The CDMA uplink/gateway can communicate with the carrier's network to determine the longitude and latitude of the gateway and can transmit that data, its software version number, and the data collected by the receiver to software, e.g., SaaS Software.

In some embodiments, where a CDMA uplink/gateway is not available, feasible, or desirable, data from the keg sensor/transmitter may be received by a hardware radio receiver and software stack in communication with the Internet via Wi-Fi or Ethernet access to a Local Area Network (LAN).

In some embodiments, after the keg sensor/transmitter is attached to the keg, the keg is delivered to the on-premise retailer, a bar or restaurant that sells draft beer. At the retailer the keg is placed in the retailer's keg cooler. Once the keg is placed in the cooler, it is now in radio range to join a network that includes the keg sensor/transmitter of each keg in the cooler as well as the uplink/gateway. As soon as the keg is placed into the cooler, the keg sensor/transmitter may begin transmitting data. The data transmitted can include the weight parameter (e.g., 0-20) from the sensor, the Sensor Transmitter Serial Number (e.g., #KS1234), the version number of the software (e.g., ver1.0), and/or keg ID information (e.g., information about the fluid in a keg received from the RFID device associated with the keg). This collection of data is transmitted to the uplink/gateway. The uplink/gateway acts as a conductor collecting data from all keg sensor/transmitters in the cooler and maintains its own serial number (#UG5678) and its own location longitude and latitude data (e.g., latitude: 39.77572; longitude: −86.15569). The uplink/gateway collects Sensor Data then adds its own data that is transmitted via the carrier's CDMA cell phone data network to the SaaS software. So an example data feed would look like:

keg sensor/transmitter sends a data string:

keg_sensor_serial=KS1234&;weight_parameter=10&;keg_sensor_version=1.0&;gateway_version=1.0&;keg_rfid=1234

This data string is received by the uplink/gateway, and the uplink/gateway embedded software adds its data. The combined data string in this example would then be:

uplink_gateway_serial=UG1234&;long=39.77572&;lat=−86.15569&;=5&; keg_sensor_serial=KS1234&;weight_parameter=10&;keg_sensor_version=1.0&;gateway_version=1.0&;keg_rfid=1234

When there are multiple keg sensor/transmitters in a cooler, the combined data string would look like:

uplink_gateway_serial=UG1234&;long=39.77572&;lat=−86.15569&;=5&;keg_sensor_serial=KS1234&;weight_parameter=10&;keg_sensor_version=1.0 &;gateway_version=1.0&;keg_rfid=1234;keg_sensor_serial=KS5678&;weight_parameter=4&;keg_sensor_version=1.0&;gateway_version=1.0&;keg_rfid=5678;keg_sensor_serial=KS91011&;weight_parameter=3&;keg_sensor_version=1.0&;gateway_version=1.0;keg_rfid=91011

The data is collected and sent by the uplink/gateway through the CDMA cell data network, then over the Internet to the SaaS software. Upon receipt by the SaaS software, the collected data from the keg sensor/transmitter can be correlated and saved in the database in several different ways.

The keg sensor/transmitter Serial Number may be correlated to an SKU that matches the beer brand and type. The correlation between the Serial Number and SKU has been pre-programmed into the SaaS Database or via the keg RFID device. For example, if Serial Numbers KS0000 through KS1234 have been assigned SKU998877665544, which is beer brand and type “Bell's Founder's Ale,” then when the SaaS software receives data from Keg Sensor Serial Number KS1234, the SaaS software writes the data into the database as being associated with that SKU, beer brand and type “Bell's Founder's Ale.” The SaaS software can have programmed intelligence that also converts the weight parameter into a percentage of volume. So, for example, if the keg sensor sends a weight measurement of 10 on a scale of 0-20, that means the keg is half-weight, thus half-full. The SaaS software converts weight to volume. 20 is full, 100%. 0 is empty, 0%. The scale of 0-20 is, therefore, converted by the SaaS software to 20 steps of volume in percentage units.

The uplink/gateway can add its data to show the location of not only the Uplink Gateway, but also the location of the keg sensor/transmitters that it is collecting data from in its coolers. As an example, assume that in the SaaS software the uplink/gateway serial number UG1234 has been assigned to the location of retailer “Scotty's Bar and Restaurant.” So when the transmission of data from a keg sensor/transmitter is made through the uplink/gateway, the location of the keg is known. So, for example, a keg sensor/transmitter KS1234 with weight parameter 10 may be transmitted to the SaaS software thru uplink/gateway UG1234. The SaaS Software has presumably already stored the location data of the uplink/gateway, the association of the keg sensor/transmitter to SKU Beer Type, and the conversion of weight to volume. When each transmission of data occurs in this embodiment, the SaaS database assigns a date and time stamp converted from UTC (Coordinated Universal Time) to local time. So when the transmission of data occurs, and the SaaS software receives the data, the data is converted to report that the particular keg of “Bell's Founder's Ale” currently located at “Scotty's Bar and Restaurant” is 50% full at 10 PM today, which may be recorded in a single time zone such as UTC/GMT. When using a single time zone, the software optionally converts the UTC time stamp into local time.

KS1234=Bell's Founder's Ale

UG1234=Scotty's Bar and Restaurant

Volume=50% (Weight value of 10 converted to %)

Date-Time=10.27.14 10:00:15 PM UTC

The embedded software in the keg sensor/transmitter can have intelligence built in. For example, it can regulate the time factor of how often the data is transmitted from the keg sensor/transmitter to the uplink/gateway. In one example, the software is set to send data every hour time period, but that time period can be changed. The keg sensor/transmitter software has the intelligence to transmit data only if the weight value has changed. The keg sensor/transmitter can also have the ability to transmit the ambient temperature around the keg (cooler temp) and the keg sensor's remaining battery life as a percentage.

One design of the keg sensor/transmitter uses short-range radio technology (e.g., ZigBee and/or Bluetooth) to connect and send data through the uplink/gateway. An alternative design, an example of which is illustrated in FIG. 10B, eliminates the uplink/gateway step by providing the keg sensor/transmitter itself a direct CDMA cell data connection so that the keg sensor/transmitter can transmit its data directly to the SaaS Software.

Still further versions of the Keg/Sensor Transmitter can change from the bottom-mounted weight sensor, to a top-mounted sensor. The top-mounted keg sensor/transmitter uses sound wave technology to send a sound wave through the top of the keg. The sound wave can bounce off the top of the liquid (beer) and return to the keg sensor/transmitter. The interval of time between the time at which the sound wave was sent and the time at which the return sound wave was received would be measured. This measurement would be transmitted to the SaaS Software, which can convert the time interval into a percentage of volume of the beer remaining. A short time interval would mean a fuller keg. A longer time would mean an emptier keg.

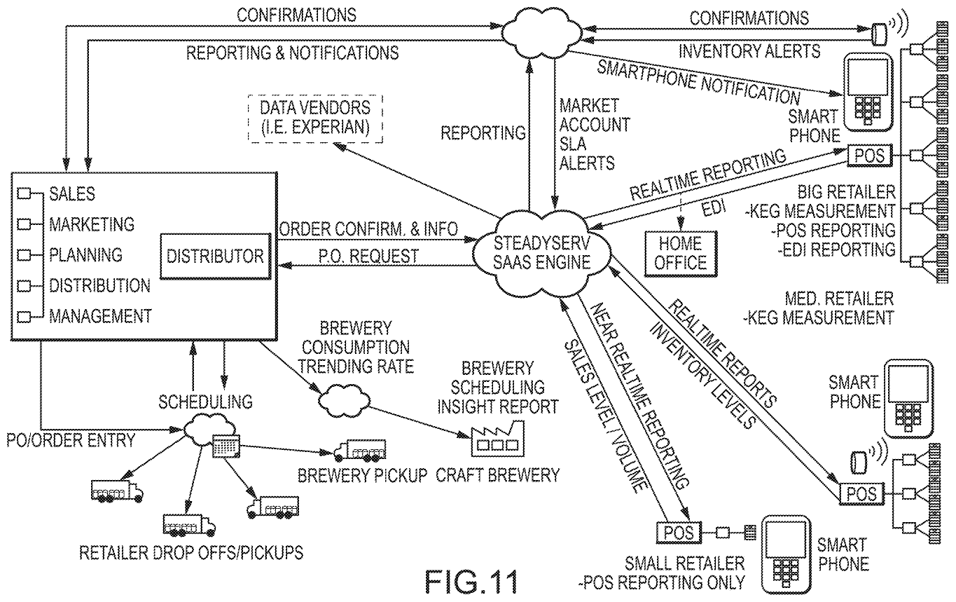

Having described the collection of data regarding the basic keg volume, date time, and location data coming from the keg sensor/transmitter through the uplink/gateway into the SaaS Software database, methods of acting upon the gathered data may now be described. FIG. 11 provides a schematic illustration of some such actions, while others will occur to those skilled in the art in view of this disclosure.

There are several levels of use of the gathered data that in the illustrated embodiments is now in the SaaS Software. The SaaS Software can be set up with individual accounts for each Bar and Restaurant retailer and their various individual establishment locations using the service. A representative of the retailer can set up accounts for each individual in their organization who interacts with keg beer. The setup process can include adding each individual's smart phone/mobile phone number. The representative can set up rules based on their organization's structure and individual needs. One function in the day-to-day operation can be to provide an insight into the current status of their keg beer inventory. The representative can log onto the SaaS software, then review the current inventory and set rules for alerts based on depletion rates of keg beer. In various embodiments, these alerts can take on the form of SMS texts sent to mobile phones, notifications resident within the application itself or associated, integrated applications, popup push alerts that are part of iPhone, Android and other smart phone formats, emails sent out, recorded voice alerts sent to phones, and other forms that will occur to those skilled in the relevant technologies. The alerts can be sent to retail workers based on their current location. The system software can take advantage of the location-based service built into each smart phone. The worker may only get alerts if they are in the geographical longitude and latitude area that has already been defined in the SaaS database by the recording of the uplink/gateway assigned to their place of work. This can assure that workers will not get alerts during their off-shift hours. A manager who would like to get alerts when he is off-site from his retail location can override this function.

In other embodiments, alerts take the form of visual flashing lights and integration into other software in the restaurant including, but not limited to, POS terminals (Point of Sale, electronic “Cash Registers”).

The retail representative can assign a value to certain beer brands and types and customize alert based on the value of the beer, that is, the importance of not running out of that beer. For example, the retailer might not value the “Stroh's Light” beer as much as the “Bell's Founder's Ale.” So the retailer representative might set up the SaaS software to automatically alert the designated retailer representative when the Stroh's reaches 10% remaining, while the more valuable Bell's would automatically alert when the remaining beer registers in the SaaS system as 40% remaining. In alternative embodiments, patterns in the rate of consumption of each product are taken into account, and depletion events are forecasted so that alerts can be raised and orders can be placed “just in time.”

When an alert is sent to the retailer, there can be multiple paths (e.g., four paths) that they can use to re-order the keg that is running low. If the alert comes to the retailer's phone, they can re-order by sending an SMS text message directly to their beer distributor sales rep, or by sending an SMS text message to an SMS gateway that is controlled by the system vendor and connected by EDI (Electronic Data Interchange) into the beer distributor's ordering system. Another option can be to activate a button in the user interface to initiate a voice call to their beer distributor's sales rep. There can also be iPhone and Android smartphone applications that have a re-ordering function built-in, connecting by EDI to the beer distributor's ordering system. The interface of the smartphone application could have a visual alert with the button option “re-order now,” which the retailer can choose.

In some embodiments, the retailer can set their account to have the SaaS software automatically submit re-orders on kegs based on rules they set for each brand and type of beer. For example they can set a rule to automatically re-order “Bell's Founder's Ale” if the depletion level has dropped below 40% and the day of the week is Wednesday through Friday.

Retailers can have standard reports accessible to them via the SaaS web-based platform or mobile app. These reports can include current and past inventory reports, current and past keg depletion rates, and other reports key to their operation.

Beer distributor sales representatives can see all of their accounts and the current state of each retailer's keg inventory. The sales representative can see when alerts on low kegs were sent out to retailers, who the alert was sent out to, and what action (if any) was taken by the retailer to re-order the depleting, or depleted, keg. The management of the beer distributor can have a near-real-time view of current beer depletion across all of their retail accounts. This near-real-time data can allow them to more efficiently control their inventory of kegs in their warehouse based on trends in usage.

The near-real-time data that the presently disclosed process may be collecting can also be used by breweries to determine what beers are being sold and at what rate. They then can adjust what beers they are planning to brew and in what quantity they brew the beer. In the case of large breweries, they can adjust the purchasing of the ingredients of beer components on the grain futures market. The system vendor can also sell data to marketing data firms who track trends in consumer consumption.

As will be appreciated by those skilled in the art, an API (Application Programming Interface) can be developed to allow other applications to access system data for real time software applications.

An example would be a consumer “Beer Finder” smartphone application. The smartphone application would integrate into the operation system of the smartphone and be able to find the phone's exact location in longitude and latitude. The app would then send a query the SaaS Database through the API to find out the closest keg sensor/transmitter and uplink/gateway to the person using the smartphone app. Near real time data of volume of a brand and type of a beer as well as its longitude and latitude location has already been recorded from the keg sensor/transmitter and uplink/gateway. So the smartphone app could show that “Bell's Founder's Ale” is at “Scotty's Bar and Restaurant,” which is X miles away from your location. The location could be plotted on a map. Plus the app could get the data that the keg is currently 50% full and do the math to determine (and display) that there are “currently 110 pints left” of this beer. If the desired beer (Bell's Founder's Ale) is not located within an acceptable geographic proximity to the consumer, the app optionally queries the system's database and locates an alternative beer based on system-measured consumption and depletion levels, for example, identifying a locally popular beer, or based on the user's individual preference used in the query.

Simple social media integration services can be created for the retailer using techniques understood by those skilled in the art. Using the data already in the SaaS Database, social media alerts can be sent automatically based on rules set by the retailer. That retailer can be prompted during their initial SaaS web setup to have the option of sending a TWITTER tweet or FACEBOOK status update when a new keg of beer is tapped. They would enter in their social media account name and password, then choose a template social message like:

“Just wanted to let you know that we just tapped a new keg of <BEER BRAND AND TYPE INSERTED HERE> at <NAME OF BAR-RESTAURANT LOCATION>. Come on down and get a pint now! #greatbeer #ikeg”

For example, say that retailer was “Scotty's Bar and Restaurant,” and they have a new, full and untapped, keg of “Bell's Founder's Ale” in their cooler. This keg has a keg sensor/transmitter that is reporting a weight value of 20, which translates into a 100% full keg. Once that keg is tapped, the beer is flowing and being sold, and is now reporting a value of 19 the Twitter Tweet or Facebook Status Update is sent out:

“Just wanted to let you know that we just tapped a new keg of Bell's Founder's Ale at Scotty's Bar and Restaurant North Side. Come on down and get a pint now! #greatbeer #ikeg”

Other embodiments include integration into POS terminals (Point of Sale, electronic “Cash Registers”). These POS terminals have their own APIs (Application Programming Interface) that would allow the SaaS Software to query into the POS database to extract data. This extracted data would then be added to the SaaS Database to be used for several purposes. For a given retailer, keg sensor/transmitters may be on some but not all kegs in that retailer's cooler. By pulling out sales data for a tap that is serving a given brand and type of beer, but is coming from a keg that does not have a keg sensor/transmitter, the SaaS application can estimate the keg depletion and the same alert rules and actions of re-order can be applied. In addition, a retailer can look at the depletion rate of a keg with a keg sensor/transmitter and compare it with the POS data on that same keg as it is reported by the POS system. By comparing the real volume data obtained from the present system with the reported sales data, a retailer can assess waste and shrinkage on that tap from “free pours” (keg beer poured to patrons to gain tips, or pours to employee friends).

The keg sensor/transmitter can be used in some embodiments to pinpoint the location of individual kegs in a warehouse.

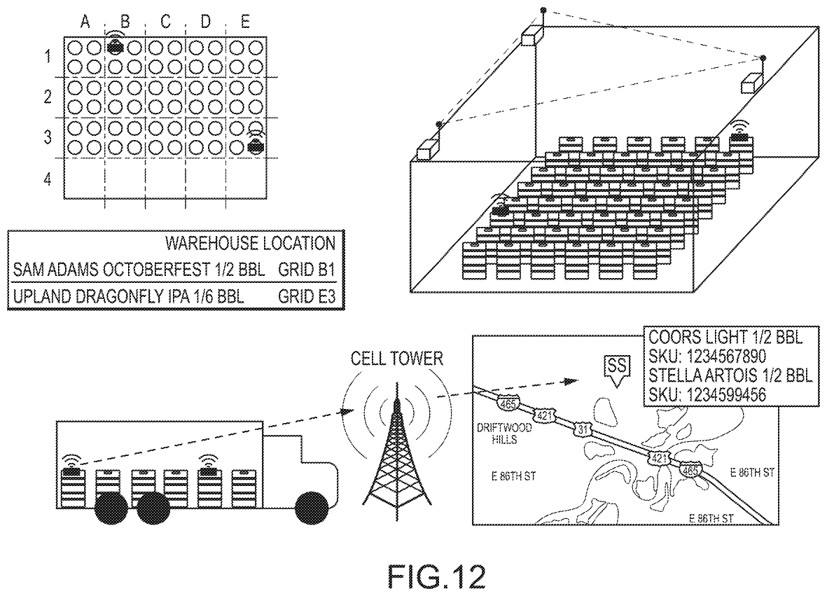

Current technology for radio transmission and reception enables fairly exact locating of a source of a transmitted signal within a wide area. Using triangulation plotting a transmitter like the one on a keg sensor/transmitter may be fairly exactly located within a broad area. In the embodiments described in previous sections of this document, the sensor is put on a keg as it leaves the warehouse to be delivered to the retailer. In other embodiments, however, the sensor could be put on the keg as it is delivered from the brewery to the beer distributor warehouse. As shown in FIG. 12, additional location technologies, whether now existing (such as RFID) or hereafter developed, in such embodiments allow for pinpoint location of a keg in a warehouse. The location can be shown on a computer-drawn map of the warehouse showing the X-axis and Y-axis location of an individual keg, but also the Z-axis. The Z-axis is the height, as when the keg is stacked up on a shelf. So in the future if a beer distributor is missing a keg, or group of kegs, by using the present system they could locate the keg. There could be a plot on a screen that shows the missing keg is in row 2, aisle 3, shelf 3.

In some embodiments the keg sensor/transmitter can be a direct CDMA or other cellular data connection. Using the longitude and latitude data from each wireless-data-equipped keg sensor/transmitter, each keg can be located when on the road for delivery and located after delivery to determine whether the individual keg has been delivered to the correct location or delivered in error to the wrong location.

Other uses would include bulk containers of soda, such as COCA-COLA or PEPSI, wine, and containers of home-delivered water, such as ICE MOUNTAIN and CULLIGAN.

There are several brands of home keg coolers marketed to consumers. The keg sensor/transmitter could be integrated into the design of these home coolers to measure the remaining beer and alert the consumer.

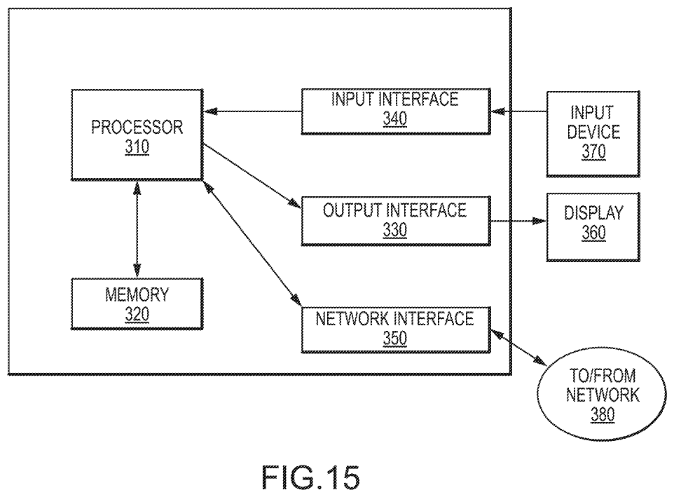

Computers (which may be used as servers, clients, resources, interface components, and the like) utilized in conjunction with embodiments described herein can generally take the form shown in FIG. 15. Computer 300, as this example will generically be referred to, includes processor 310 in communication with memory 320, output interface 330, input interface 340, and network interface 350. Power, ground, clock, and other signals and circuitry are omitted for clarity, but will be understood and easily implemented by those skilled in the art.

With continuing reference to FIG. 15, network interface 350 in this embodiment connects computer 300 to a data network (such as a direct or indirect connection to a server and/or a network 380) for communication of data between computer 300 and other devices attached to the network. Input interface 340 manages communication between processor 310 and one or more input devices 370, for example, microphones, pushbuttons, UARTs, IR and/or RF receivers or transceivers, decoders, or other devices, as well as traditional keyboard and mouse devices. Output interface 330 (which may take the form of a user interface) provides a video signal to display 360, and may provide signals to one or more additional output devices such as LEDs, LCDs, or audio output devices, or a combination of these and other output devices and techniques as will occur to those skilled in the art.

Processor 310 in some embodiments is a microcontroller or general purpose microprocessor that reads its program from memory 320. Processor 310 may be comprised of one or more components configured as a single unit. Alternatively, when of a multi-component form, processor 310 may have one or more components located remotely relative to the others. One or more components of processor 310 may be of the electronic variety including digital circuitry, analog circuitry, or both. In one embodiment, processor 310 is of a conventional, integrated circuit microprocessor arrangement, such as one or more CORE i7 HEXA processors from INTEL Corporation of 2200 Mission College Boulevard, Santa Clara, Calif. 95052, USA, or ATHLON or PHENOM processors from Advanced Micro Devices, One AMD Place, Sunnyvale, Calif. 94088, USA, or POWER8 processors from IBM Corporation, 1 New Orchard Road, Armonk, N.Y. 10504, USA. In alternative embodiments, one or more application-specific integrated circuits (ASICs), reduced instruction-set computing (RISC) processors, general-purpose microprocessors, programmable logic arrays, or other devices may be used alone or in combination as will occur to those skilled in the art.

Likewise, memory 320 in various embodiments includes one or more types such as solid-state electronic memory, magnetic memory, or optical memory, just to name a few. By way of non-limiting example, memory 320 can include solid-state electronic Random Access Memory (RAM), Sequentially Accessible Memory (SAM) (such as the First-In, First-Out (FIFO) variety or the Last-In First-Out (LIFO) variety), Programmable Read-Only Memory (PROM), Electrically Programmable Read-Only Memory (EPROM), or Electrically Erasable Programmable Read-Only Memory (EEPROM); an optical disc memory (such as a recordable, rewritable, or read-only DVD or CD-ROM); a magnetically encoded hard drive, floppy disk, tape, or cartridge medium; or a plurality and/or combination of these memory types. Also, memory 320 may be volatile, nonvolatile, or a hybrid combination of volatile and nonvolatile varieties. Memory 320 in various embodiments is encoded with programming instructions executable by processor 310 to perform the automated methods disclosed herein.

Although a keg is a particular type of container and is typically filled with a fluid (such as beer), alternate embodiments of the invention measure the quantity of other materials (which may not be a fluid) contained within other types of containers.

It should be appreciated by one of ordinary skill in the art that a receiver as referred to herein includes devices that transmit and receive electromagnetic signals, sometimes referred to as transceivers.

In some embodiments, the sensor may include a spring device or similar self-adjusting means for securing the sensor capable of securing the sensor to different sizes and/or designs of kegs, such as, for example, misshaped kegs or kegs with non-round bottoms.

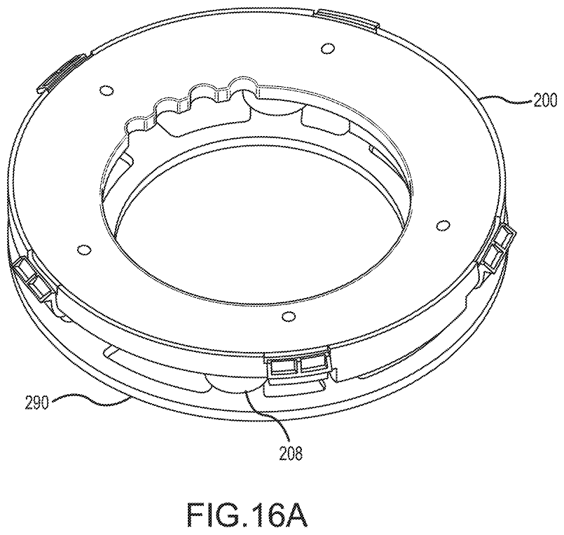

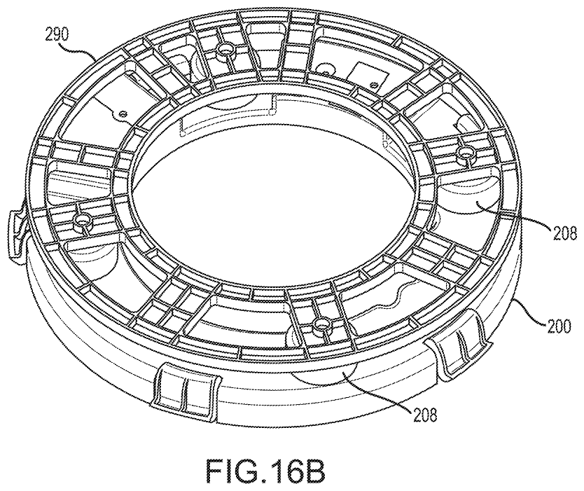

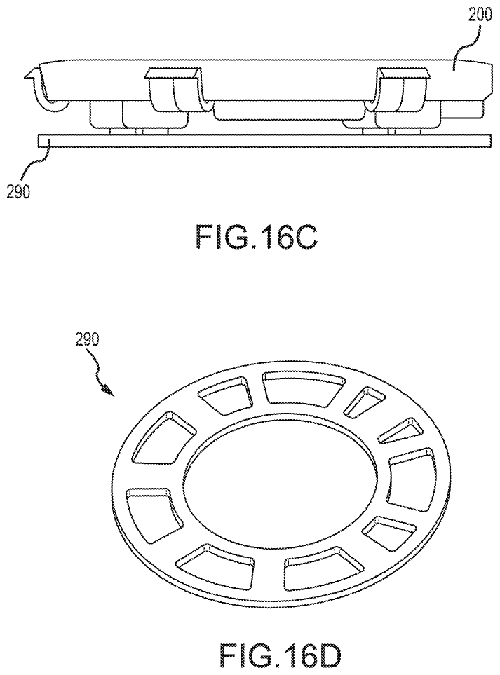

Bars and restaurants often have shelving units in keg coolers. In these environments, kegs may not be located on a solid flat surface, but instead located on shelves that have rails with gaps for supporting the keg. In such situations, the system vendor can supply a rigid, hard mat that can be placed on the rails of a shelf, and the keg placed atop the mat. In other embodiments, sensors designed for use on uneven surfaces or surfaces with gaps can be used to accurately measure the weight of a keg while being positioned on these surfaces. One example embodiment is depicted in FIGS. 16A-D, which depicts a footer 290 attached to the weight sensors 208 of the sensor 200. In this embodiment, the flat, substantially disc-shaped footer 290 is capable of spanning gaps in shelves or other surfaces and provide a stable surface for the attached sensor 200.

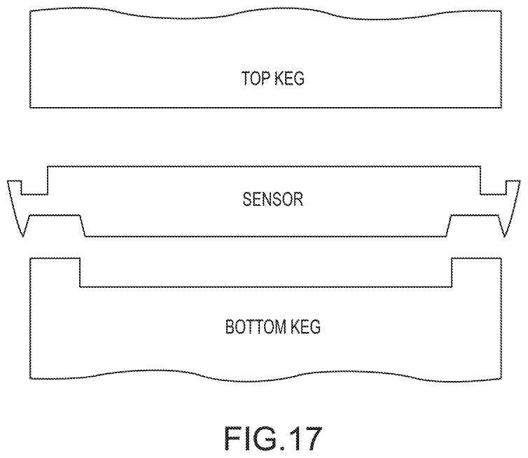

In some situations, kegs are stacked on top of each other. In an exemplary stack including a top keg and a bottom keg, each keg may include its own sensor. A sensor for the bottom keg may be mounted beneath the bottom keg, and a sensor for the top keg may be mounted on its top. Or optionally, there may be a sensor 400 between the top and bottom kegs, as shown in FIG. 17. It may include and/or exclude the various features disclosed in this specification. Also, although this inter-keg sensor may be attachable to one or both kegs, it also may remain between them, held by gravity, but not mechanically mounted or attached.

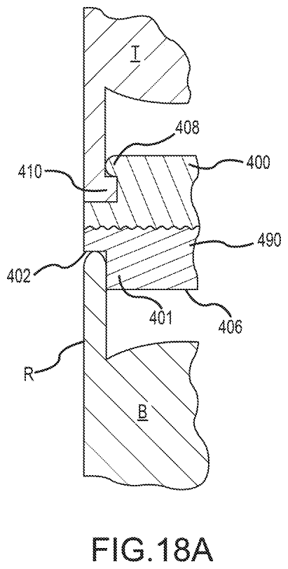

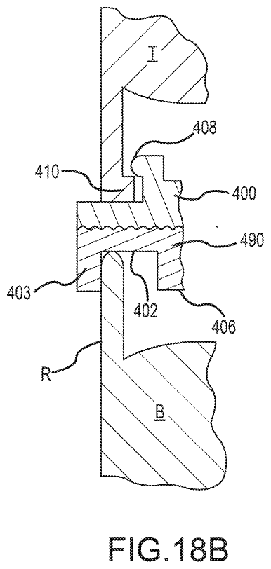

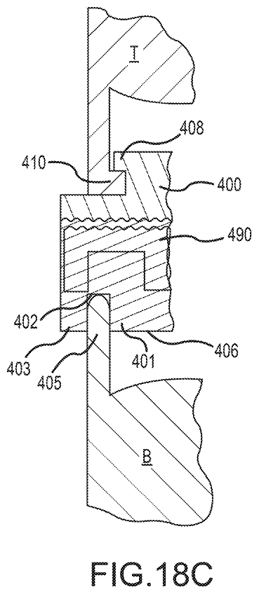

Some embodiments of the sensors may have radial constraints. Such radial constraints are to engage a vertically adjacent keg (above and/or below), such as when kegs are stacked. FIGS. 18A-180 illustrate, side cross-sectional detail examples of such radial constraints, in such case on the bottom of a sensor 400 mechanically mounted to the bottom of a top keg T. The radial constraints are sized and positioned to contact one or more surface of the adjacent keg, in this case a circumferential rim R of bottom keg B. FIG. 18A illustrates an exemplar radial restraint 401 projecting below surface 402 of the sensor, with restraint 401 engaging a radially inward surface of rim R. FIG. 18B is similar except that it has radial restraint 403 on the radially outward surface of rim R. FIG. 18C shows a third example, with both inward restraint 401 and radially outward restraint 403 forming a channel 405 therebetween and beneath surface 402. Optionally, if both inward and outward restraints are used, such restraints may be located at different circumferential locations around the sensor and the rim R. The restraints may take any form, being at simple two, three or more locations around the circumference of the sensor and/or keg, or being partial or complete rings. They may be used with any of the sensors disclosed herein. However, if the optional features of the footer 290 (see for example FIGS. 16A-16C), then this is combined with the radial restraint, as shown with footer 490. As but one example, footer 290 may have a circular void, such as a channel or otherwise, such as channel 405 in its bottom. This allows nesting with the rim R of keg B. And yet, optionally, surface 406 (see FIGS. 18A-18C) spans gaps in flooring as described in connection with FIGS. 16A-16C. Such radial restraints, whether by nesting or otherwise, help interlock stacked kegs while providing the other advantages described herein. The arrangement of FIG. 18A provides the optional advantage of having sensor 400, including any optional footer 490, with its diameter less than or equal to the keg it is mounted to, such a top keg T, and thus optionally may be flush with, or at least not projected radially outside the cylinder profile of the keg.

Sensor 400 may be snap fit to the bottom of the top keg T by pressing keg T down onto sensor 400. A flange 408 of sensor 400 may extend the entire 360 degree circumference of sensor 400 and may be made of a rubber or polyethylene material that is flexible or pliable enough to enable flange 408 to be pushed past flange 410 on top keg T. Alternatively, sensor 400 may include a plurality of flanges 408 each spanning only approximately between five and fifteen degrees in one embodiment, with circumferentially adjacent flanges 408 being separated by air gaps spanning approximately between thirty and forty degrees in one embodiment. Thus, sensor 400 may be snap fit onto top keg T with flanges 408 not having the same degree of flexibility or pliability as required in the case of a single flange 408 extending 360 degrees.

Some embodiments of the present disclosure determine the amount of liquid in each keg in a stack of kegs. For example, in some embodiments, the sensor measures and reports the status of the bottom keg in a stack of kegs such that an untapped lower keg will report its percentage full as the last reported value prior to an increase in the weight of the lower keg. In other embodiments, the software can determine the 3D location of each keg, as explained below, and detect that the upper keg is stacked atop the lower keg. The programming logic of the software can then utilize the reporting history of each keg to determine the fluid level in each keg. For example, if the software receives data that two kegs have substantially identical X and Y location coordinates and the Z coordinates differ by only a few feet, the software logic can extrapolate that one keg is stacked atop the other keg. If the software then receives data that the weight reported by each keg is decreasing in equal amounts, it can extrapolate that only the upper keg is being drained and the liquid level of the lower keg is remaining constant—the lower keg is simply reporting the decreasing weight of the upper keg. In contrast, if the software receives data that the weight of both kegs is decreasing, but the rate of decrease of the lower keg exceeds the rate of decrease of the upper keg, the software can extrapolate that both kegs are being drained and can extrapolate the respective true rates at which each keg is being drained individually.

In some embodiments, the issue of stacked kegs is addressed by pairing the sensor on the lower keg to the sensor on the upper keg through a network (e.g., a meshed network) to associate and exchange data and commands. For example, if two kegs are stack on top of each other, the kegs communicate their weights to each other and, depending on the percentage of depletion, the signal sent to the system would be adjusted depending on the relative weights sensed by the sensors. This solution may also enable accurate reporting of situations where a keg spacer is used to enable tapping of both the bottom and top kegs at the same time.

Pairing sensors are used in various embodiments. For example, in one embodiment pairing sensors is used when two or more kegs of the same brewery and product are connected together in parallel and are serving through the same tap line and tap. For example, in one embodiment the kegs communicate their weight or volume to each other, and the aggregated weight or volume reading is communicated to the system.

As one example of how the weights of kegs in a stack of kegs are determined, the sensors attached to the kegs in a stack of kegs are checked into the system (e.g., a sensor/transmitter, RFID tag, uplink, cellular network, computer database(s), etc.) as operational (and to optionally begin relaying information to the system) before the kegs are stacked. This check-in process may be accomplished sequentially with sensors being checked into the system in order of how they will be stacked (bottom to top, or top to bottom), in a nonspecific order, or simultaneously with their weight. Once the kegs with attached sensors are checked in, the kegs and their respective sensors are stacked on top of one another. The sensors may be adapted for stacking kegs, such as having a sensor bottom adapted to receive the top of a keg and a sensor top adapted to attach to the bottom of a keg, or additional items (such as mats or boards) may be included in the stack to provide an appropriate support surface for the sensors.

Once the kegs are stacked, the system will detect and interpret weights above the checked-in weight as the keg having at least one keg stacked on top of it. If the weight is a multiple of the checked in weight, the system can interpret the keg as having multiple kegs stacked on top of it. The system then calculates the weight of each keg as the kegs are individually depleted.

The rate at which the sensors transmit their weight readings to the system may be increased during the stacking process to increase the ability of the system to detect sequential increases in weight during stacking.

In some embodiments, the system will interpret weight increases as the stacking of additional kegs only when the weight increase is above a particular threshold, such as 30 pounds. This may be useful in environments where items other than kegs, such as pallets of food, are placed atop kegs with sensors.

In still other embodiments, the sensors are capable of communication with one another to determine which kegs are in a stack, and in some embodiments the order of the kegs in a stack. In certain embodiments, the sensor attached to the top keg in a stack communicates with the keg immediately below it. In some embodiments, all sensors in a stack communicate with one another. In still further embodiments, one or more sensors in a stack are identified as being in a stack (such as by a user inputting to the system which kegs are in the stack or by manually pairing kegs in a stack, or by the sensors detecting an overweight condition) to the enterprise software.

In still further embodiments, the user stacking the kegs may have an interface, such as through a smartphone or by pressing a button on each sensor in the stack, that informs the system which kegs are in a stack, and in some embodiments the order in which the kegs are stacked may be sent to the system. Once the system recognizes which kegs are being stacked, the weight increases are attributed to the kegs being stacked and the system then tracks depletion of the kegs.

In still further embodiments, the kegs may be stacked before checking the kegs/sensors into the system. In these embodiments, advantages may be realized if the user informs the system which kegs are stacked together.

As an example of the system tracking the depletion of the kegs, it is assumed that three full kegs (each 175 lbs.) are stacked atop one another, each weighing 175 lbs. for the starting condition at time 1. The next time the kegs report their weight (time 2), there has been 50 lbs. dispensed from the top keg (T), 10 lbs. dispensed from the middle keg (M), and 150 lbs. dispensed from the bottom keg (B). The actual weights are represented in Table 1.

TABLE 1

| | Actual Weight | Weight Dispensed | Actual Weight |
|---|---|---|---|
| | Time 1 (lbs.) | (lbs.) | Time 2 (lbs.) |
| Top Keg (T) | 175 | 50 | 125 |
| Middle Keg (M) | 175 | 10 | 165 |
| Bottom Keg (B) | 175 | 150 | 25 |

The sensed weights are as represented in Table 2.

TABLE 2

| | Sensed Weight | Sensed Weight |
|---|---|---|
| | Time 1 (lbs.) | Time 2 (lbs.) |
| Top Keg (T) | 175 | 125 |
| Middle Keg (M) | 350 | 290 |
| Bottom Keg (B) | 525 | 315 |

In the above example, the system can automatically determine the order in which the kegs are stacked by assuming that the kegs/sensors with heavier sensed weights are below those with lighter sensed weights. In one example embodiment, the system calculates the weights at time 1 in each keg as:

$$\begin{matrix}{T}_{1 \text{-} actual} = lightest sensed weight \\ = {T}_{1 \text{-} sensed} \\ = 175 lbs . ,\end{matrix}$$

$$\begin{matrix}{M}_{1 \text{-} actual} = ( {2}^{nd} lightest weight ) - \\ ( actual weight of top keg ) \\ = {M}_{1 \text{-} sensed} - {T}_{1 \text{-} actual} \\ = 350 lbs . - 175 lbs . \\ = 175 lbs . , and\end{matrix}$$

$$\begin{matrix}{B}_{1 \text{-} actual} = ( {3}^{rd} lightest weight ) - {M}_{1 \text{-} actual} - {T}_{1 \text{-} actual} \\ = {B}_{1 \text{-} sensed} - {M}_{1 \text{-} actual} - {T}_{1 \text{-} actual} \\ = 525 lbs . - 175 lbs . - 175 lbs . \\ = 175 lbs .\end{matrix}$$

The system, which by at least time 1 has identified the order of kegs in the stack, calculates the weights at time 2 as:

$${T}_{2 \text{-} actual} = {T}_{2 \text{-} sensed} = 125 lbs . , \\ \begin{matrix}{M}_{2 \text{-} actual} = {M}_{2 \text{-} sensed} - {T}_{2 \text{-} actual} \\ = 290 lbs . - 125 lbs . \\ = 165 lbs . , and\end{matrix}$$

$$\begin{matrix}{B}_{2 \text{-} actual} = {B}_{2 \text{-} sensed} - {M}_{2 \text{-} actual} - {T}_{2 \text{-} actual} , \\ = 315 lbs . - 165 lbs . - 125 lbs . \\ = 25 lbs .\end{matrix}$$

Stacks of fewer than three kegs or greater than three kegs can use similar algorithms.

In some embodiments of the present disclosure, a user can hold a sensor near an identification device (e.g., an RFID device) affixed to one of the containers (e.g., kegs) in a stack of containers. The user can create an association in the enterprise software and/or database(s) between the sensors attached to kegs in a stack (or attached to kegs to be stacked), such as by pushing and holding the “paring” button longer than required to pair the sensor to the RFID device to cause the sensor to enter a “stacked” mode that allows for kegs to be stacked. The employee may be given a visual indication (e.g., light blink in a different pattern, light led color changes to yellow or green), tactile (e.g., buzz), and/or an aural signal (e.g., buzz or beep) to indicate the “stacked” mode. The employee may then hold the sensor up to the other stacked keg and push the button to record the other keg. The process may be repeated with the sensors from the other kegs. The RFID serial number of each keg may now be transmitted to the enterprise software. Since the RFID serial numbers of each keg were recorded in the “stacked” mode they are identified in the database and/or software as being stacked.

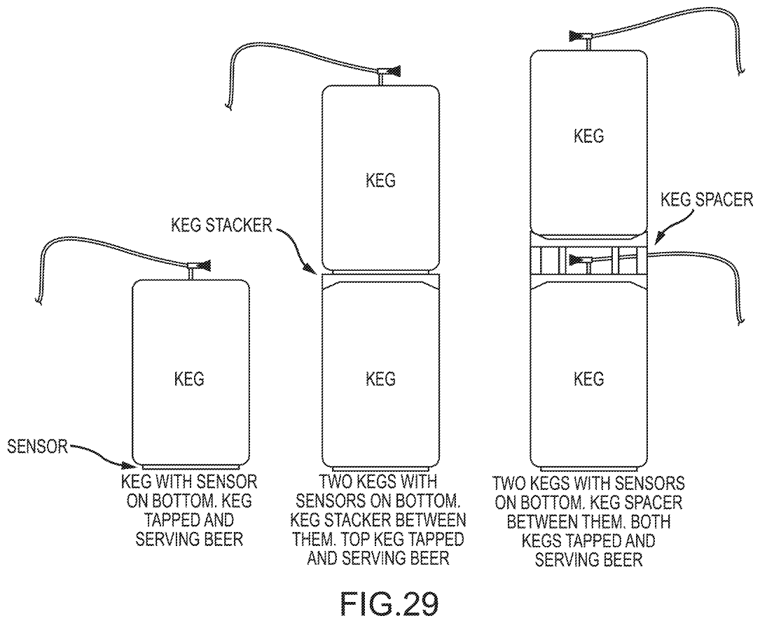

In the “stacked” mode, the system software recognizes that at least one of the bottom kegs (kegs with at least one keg stack on top) is incapable of being depleted, such as when keg stackers similar to those depicted in FIG. 29 are used. Using the unique RFID serial number for each keg (which may also include information about keg size), the system will recognize that kegs being reported as heavier than their expected weight (which may simply be the kegs that are heavier than other kegs in a stack) are bottom kegs and can recognize changes in the bottom keg's weight as being changes in the weight of the one or more kegs on top of the bottom keg. In some embodiments, the system can recognize when the weight of the keg is within expected ranges (e.g., no heavier than the typical maximum weight for a keg), indicating that the keg is no longer a bottom keg and can begin measuring the weight of the keg to track and/or report its depletion. If the bottom keg is not tapped, the system will not report depletion, but can report the keg as “inventory” and full.

In still further embodiments, a user may hold a sensor up to the RFID tag of one of the kegs to be arranged in a stack. The user may then push the “paring” button, but hold the button longer so that the sensor enters a “spacer” mode that allows for spacer kegs. See FIG. 29 for an example of kegs stacked using a keg spacer that allows for one or more bottom kegs in a stack to be tapped. The user may be given a visual (e.g., light blink in a different pattern, light led color changes to yellow or green), tactile (e.g., buzz), and/or aural signal (e.g., buzz or beep). The user can then hold the sensor up to the other spacer keg and push the button to record the other keg. The process is repeated with the sensor from the other keg(s) in the stack. The RFID serial number of each keg is now transmitted to the enterprise software. Since the RFID serial numbers of each keg were recorded in the “spacer” mode, they are recorded in the database as being put on top of each other and tapped. Using the unique RFID serial number for each keg, the sensor serial number, and the sensor being paired with each keg in the “spacer” mode, the software can use a special “spacer” logic to calculate the amount of liquid in each container in the stack as each individual keg depletes (or does not deplete). For the bottom keg the software employs logic to take the weight reading of the bottom keg, subtract the weight of the top keg, and calculate the volume reported by this new value. The top keg reports its weight which is converted to volume. It should be appreciated that the spacer mode may also be used when one or more bottom kegs (kegs with another keg on top) are not tapped and incapable of depleting.

The RFID tags can use NFC (Near Field Communication) type inlays. As such the RFID tags can be read by smart phones or tablet devices that have NFC readers built in. Embodiments of the enterprise software include a function that can use a mobile device's capability to read the identification tags and/or sensors to allow a user to use the NFC reader capabilities on the user's device to check kegs into the system. For example, the user can hold the user's device up to a keg RFID tag, read the tag, then move the user's device to the next stacked keg, hold the device next to the tag and read the tag. In some embodiments this function could be available to assist a user in situations where the keg had already been paired with a sensor ring, but afterward was needed to be stacked.

In some embodiments, a QR code, bar code, or other indicia is printed on the RFID device. The indicia can be added by a brewer, distributor, or system vendor for inventory tracking purposes so that the brewer, distributor, or system vendor can identify specific kegs.

In some embodiments, the sensor may be paired with a first RFID device containing information about the liquid in the container to which the sensor is (or will be) attached. As discussed above, the pairing device and first RFID device are configured for short range use to avoid interference with other RFID devices that may be stored nearby, such as, on nearby containers. In some embodiments, a second, longer ranged RFID device is also associated with the container. The second RFID device would be configured to not interfere with the first RFID device, such as by using a different frequency or page than the first RFID device. In one embodiment, the first RFID device is a passive RFID device and the second RFID device is an active RFID device. In another embodiment, the first and second RFID devices are both passive devices, the second RFID device operating at a higher frequency than the first RFID device. A distributor or brewer with an RFID enabled inventory system would then be able to use the inventory system to track the second RFID device and thereby track the container attached thereto. In certain embodiments, the first and second RFID devices can be incorporated into a single label or tag attached to the container.

The RFID device, if used at all, can be programmed with a unique serial number and unique attributes of the liquid contained in the keg can be assigned to the device via a wireless network. In some embodiments, RFID may be printed and affixed to the keg at the brewery. In these embodiments, the attributes of the liquid may include the identity of the liquid, e.g., “Bell's Founder's Ale,” and the date the keg was filled at the brewer. Later, when the keg is delivered to an on-premise retailer, bar, or restaurant, the sensor/transmitter can join the network that includes the keg sensor/transmitter of each keg in the premise as well as the uplink/gateway. The uplink/gateway can then relay data from the keg sensor/transmitter and the associated RFID device to the system/software. The system would then have the ability to track the location and freshness date of each individual keg filled by the brewer by comparing the date the keg was filled to the date the keg became available for consumption at the retailer, bar, or restaurant.

Some embodiments determine if the container (keg) has been properly refrigerated. For example, in some embodiments the sensor includes a temperature sensor and a non-transient computer-readable storage medium, such as a memory chip. The temperature sensor is configured to periodically or continuously record the ambient temperature and store the temperature datum with a time/date stamp. When the sensor checks into the system, the temperature/date/time information can be transmitted to the system/software along with the other information provided to the sensor by the RFID tag affixed to the keg, which can include but is not limited to product born-on-date (or born-on-date-and-time), date of receipt by the distributor, date of shipment to the retailer, brewer, brand, style and delivery location. Information concerning the temperature, location, style of beer, depletion speed, product age, or other aspect that may be useful to the users of the system (e.g., a sensor, transmitter, RFID tag, uplink, cellular network, computer database, etc.) may be sent through the system to a user of the system such as the brewer, distributor, and/or retailer. The information may be provided to the user in a report or other format, which may be compiled upon request, at certain intervals, or upon occurrence of a particular event related to the information (e.g., exceeding a particular temperature or age of the product). Maintaining the keg in a consistent temperature, cold environment at all times is important for beverage quality control. Using this system, the temperature of the keg may be tracked from the time the keg is filled until it is empty. In still other embodiments, a temperature sensor may be included in the RFID label. In certain embodiments, the sensor includes two temperature sensors, a first temperature sensor configured to record the keg surface temperature and a second temperature sensor configured to record the ambient temperature.

In embodiments including a top-mounted sensor/transmitter, such as the embodiment shown in FIG. 8, the sensor/transmitter may include a chemical sensor. The chemical sensor includes a hygienic probe made of a suitable material, such as plastic, positioned to contact liquid as the liquid leaves the keg. Commercially available probes could be used in various embodiments. For a liquid such as beer, the probe could detect the beer's sugar and/or alcohol content. For other liquids, suitable probes could be used to detect other attributes of interest. Detected chemical data can then be transmitted via the sensor/transmitter to the system software. The system vendor can then provide that data to brewers and/or retailers for quality control purposes, allowing the recipients to know if there has been a change in the beer since it left the brewery.

As previously discussed, current technology for radio transmission and reception allows for location of a transmitted signal in a wide area. Using triangulation, plotting a transmitter like the one on a keg sensor/transmitter would be a broad area. In some embodiments, the sensor is put on a keg as it leaves the warehouse to be delivered to the retailer or is put on the keg as it is delivered from the brewery to the beer distributor warehouse. As shown in FIG. 12, additional location technologies, whether now existing (such as RFID) or hereafter developed, can be incorporated in such embodiments to precisely locate one or more kegs in a facility, such as a warehouse or a retail sales location like a restaurant or bar. The location can be shown on a computer-drawn map of the facility showing the X-axis, Y-axis, and Z-axis location of an individual keg. The map may be displayed on any data-driven display, such as a computer monitor, smartphone, table computer, or other device. In embodiments including a first, short range RFID tag and a second, long range RFID tag, the second tag would be detected by an uplink/gateway placed in the facility. In alternate embodiments, a sensor/transmitter can include a cellular data mobile-to-mobile (M2M) unit and a local cellular repeater (which may be installed at the facility) to determine and track the X, Y, and Z coordinates of a keg. In other embodiments, signal strength from an active RFID could be used to determine the location of an individual keg. In further embodiments, the location of a keg can be determined by triangulation in facilities having multiple uplink/gateways operating using wireless protocols. In certain embodiments, using Bluetooth or other suitable wireless protocols, the system can interact directly with a user's smartphone to show the direction and distance from the user's present location to the keg.

It bears noting that each and any embodiment may be used with or without an identifier and with or without an RFID or a tag or label as described in this disclosure. Only the express inclusion of any feature, such as an identifier, RFID, label, tag or otherwise in a claim mandates, for that claim, its inclusion. Also, any such identifier may, now or in the future, be part of the keg itself.

In some embodiments, a flow meter attached to draft keg beer line can incorporate a short distance radio transmission (ZigBee, Bluetooth, etc.) to communicate with the system (such as through a gateway) using a similar data transfer protocol as the sensor/transmitter. Data from the flow meter is utilized in some embodiments to calculate beer being drained from the keg, either as a complement or a replacement for determining liquid via weight sensor or sound wave technology.

As discussed above, some embodiments may include a sensor mounted to the top of a keg. Certain embodiments may include a bracket adapted to receive the sensor, where the bracket is secured to the top of the keg, such as, by being welded to the keg. Other embodiments may include a bayonet mount, where the mount is secured to the top of the keg, such as, by being welded to the keg. In embodiments including a top-mounted sensor and a sound or radio wave-based liquid volume sensor, the material of the top of the keg (such as at the center of the mount/bracket) optionally includes a material that conducts sound or radio waves with greater facility than aluminum.

In some embodiments, a surface, such as a thin floor membrane, is affixed to the floor of a cooler. The surface may include indicia designating one or more areas on the surface for placement of a keg. The surface includes sensors to measure the weight of the keg placed on the surface, such as in the designated spot. Sensors, which may be the same sensors as the weight measuring sensors, can also recognize the size of the keg based on the size or circumference of the footprint of the keg placed on the surface. For example, a ⅙ barrel keg has a smaller circumference than a half barrel. The surface can have the ability to recognize the size difference and make adjustments to measurements, that is, the expected weight of a full and empty keg, based on its recognized size via its footprint.

An accelerometer is optionally included in the disclosed system. Accelerometers, such as micro electro-mechanical systems (MEMS), can record accelerations to which the keg has been subjected. By collecting, recording, and analyzing accelerometer data, the system can determine whether a keg has been dropped or has otherwise experienced an impact during transportation. In some embodiments, an accelerometer is attached to and in electronic communication with the RFID label, which can be attached at the brewery. When the label is paired by the delivery driver, the data from the accelerometer can be communicated to the sensor, through the sensor to the uplink, and to the system/software. In other embodiments, an accelerometer can be attached to and in electronic communication with the sensor. Accelerometer data can be reported at any time the sensor is in communication with an uplink, and not only after the RFID has been paired with a sensor. The system vendor could then transmit the accelerometer data to the brewery, the retailer in possession of the keg, or other entity. Accelerometer data can be transmitted as part of the periodic updates of keg volume, or can be transmitted at a predetermined time/interval.

A magnetometer is optionally included in the disclosed system. Magnetometers, such as magnetoresistive permalloy sensors, serve as compasses and can record the directional orientation of a keg. By collecting, recording, and analyzing magnetometer data, the system can determine the current and past orientation of a keg. In some embodiments, a magnetometer is attached to and in electronic communication with the RFID label, which can be attached at the brewery. When the label is paired by the delivery driver, the data from the magnetometer can be communicated to the sensor, through the sensor to the uplink, and to the system/software. In other embodiments, a magnetometer can be attached to and in electronic communication with the sensor. Magnetometer data can be reported at any time the sensor is in communication with an uplink, and not only after the RFID has been paired with a sensor. The system vendor could then transmit the magnetometer data to the brewery, the retailer in possession of the keg, or other entity. Magnetometer data can be transmitted as part of the periodic updates of keg volume, or can be transmitted at a predetermined time/interval.

Low battery level may be detected by the sensor and transmitted to the database (via gateway or otherwise). This may be used to generate a notice to the user(s) of the need to replace or recharge such sensor and/or its batteries. This may, for example, be via a data string or string segment signaling a low battery and/or the battery level. As but one example, the following my comprise part of a total data string transmitted from the sensor:
battery=10&
   In such example, the system may associate the value “10” as 10% battery life remaining, or some other threshold battery value. Optionally, instead of and/or in addition to transmitting a low-battery signal, by data string or otherwise, the sensor may trigger its own signal device(s), discussed further below. In certain embodiments, the battery is charged wirelessly. In other embodiments, the battery is omitted and the sensor is powered wirelessly from the uplink/gateway or other wireless-power providing device.

In some embodiments, the system vendor managing the software utilizes keg volume reduction data and keg location data to create a list showing the sales of beer brands in a defined geographic area. This list may be provided to retailers such as bars and restaurants, by making, for example, the list available on a website with access restricted to retailers utilizing the keg tracking service. The list can be searchable or sortable by at least geographic area, beer brand, and brewer. Retailers can use the list to inform their beer ordering practices and can help the retailers focus on beer brands selling well in their geographic area or beer brands that sell well in other areas and are not yet widely available in the retailers' geographic area.

The software can track, among other data, the depletion rate of kegs, the location of those kegs, and the brand of beer in those kegs, and low battery levels in particular sensors. Utilizing this data, the software can calculate an average depletion rate of a keg of a particular brand of beer at a particular retailer. As discussed above, the software can send alerts to a retailer, which may be based on particular rules or options set by the retailer. In some embodiments, the software can send alerts to notify a retailer that a keg may soon be depleted based on calculated and/or estimated depletion rates. The alert would remind the retailer or representative that an order should be made by a specific date and of a given minimum quantity of kegs of a specific beer to maintain stock levels. In various embodiments, these alerts can take on the form of SMS text sent to mobile phones, popup push alerts that are part of iPhone, Android and other smart phone formats, emails sent out, recorded voice alerts sent to phones, and other forms that will occur to those skilled in the relevant technologies.

A signaling device, such as one that generates an audible (such as a chime, bell, alarm, buzzer, or other noisemaker) or visual signal (such as an LED, a bulb or otherwise; flashing or otherwise), is optionally included in the disclosed system. In some embodiments, the signaling device is in communication with the sensor and may be attached thereto. The signaling device is designed to alert individuals upon fulfillment of one or more predetermined criteria. For example, a sensor may include programming logic designed to activate an audible signaling device when a keg associated with the sensor is determined to be empty, at a predetermined weight above being empty, at a low batter level, or otherwise. In some embodiments, predetermined criteria for signaling include, but are not limited to, detection of a sensor at a certain geographic location or reaching a certain value of temperature, acceleration, weight, or liquid flow. In another example, the signaling device may be configured to activate upon a user (e.g., retailer) receiving an alert relevant to the keg associated with signaling device.

In another example, the signal device (or devices) may be configured for manual activation by a user wanting to find that sensor and its associated keg. For example, a retailer may have gotten information (from this system or otherwise) about a particular keg. However, that keg may be located in a cooler with forty or so other kegs. By activating the signal device, it makes it easier for the user to find that particular keg. Such activation may be via a variety of ways, including via the gateway and/or via the user's smartphone equipped with a system app. Such app may have, for example, for each keg shown on the retailer's phone app, an activate signal device button. By pushing that button on the phone, via the system the signal device goes off. This may also be done in groups, such as to simultaneously activate the sensors in the user's establishment of a particular beer, a particular brand, or otherwise. It may optionally be that when a signal device goes off (manually or otherwise) its duration is limited to a pre-set time duration.

Remote activation of an alert device attached to a keg, to thereby locate a keg or sensor for instance, may be implemented using either a long range RFID technology or an ultra-low power radio, for example. In one embodiment, a low power radio (e.g., a low power ZigBee radio) may be left in a receive-only mode during sleep. The ZigBee radio, in response to receiving an activation signal, may wake the sensor to activate the alert device. Alternatively, a long range, possibly passive, RFID tag may be connected to the sensor. Thus, the sensor can maintain its sleep configuration, but may be awakened by the RFID reader. If the RFID reader is passive, this can be done with no additional sleep current draw, which may be advantageous in comparison to leaving the ZigBee radio in receive-only mode. If the RFID reader is attached to the gateway, then the RFID reader could still be activated via a smartphone app, or by the other methods described above with regard to other embodiments.

The signaling device may also be configured to activate upon the direction of the software automatically in response to set conditions. For example, a beer distributor with a warehouse of inventory may send a request via a smartphone or tablet computer to the system software requesting activation of the audible signaling device for a particular sensor. The software then commands the device to chirp, chime, ring, buzz, or otherwise generate an audible and/or a visual signal, thus simplifying the distributor's task of finding the keg associated with the sensor in the warehouse. The programming logic determining when to activate the audible signaling device may also be in individual sensors, in the system software, or a combination of the two.

In some embodiments, the sensor/transmitter detects the first available uplink and begins transmitting information through that uplink. However, alternatives may be provided. In situations where two establishments (bars, restaurants, etc.) are in close proximity to one another, a sensor in one facility can mistakenly begin transmitting information to the gateway in the other facility. In situations where this scenario could be problematic, embodiments of the present disclosure permit the pairing of sensor/transmitters to particular gateways. A user, such as an employee of a retailer, may choose to manually pair the sensor with a specific uplink and may do so after pairing the sensor with a particular RFID tag. The user/employee can manage this manual pairing by, for example, entering the sensor ID number into a system interface, such as an application (“App”) on a smartphone. In one example, the user/employee can select a Tools/Manual Pairing selection box within the application and select an uplink. In alternate embodiments, the sensor defaults to the uplink with the strongest send and/or receive signal(s) available. In still other embodiments, the sensor may be instructed to ignore or automatically change pairing settings either remotely (e.g., via the application's enterprise software) or if the paired uplink becomes unavailable. In further example embodiments, the delivery driver (or other person) can pair a sensor to a specific location gateway, such as by having manual buttons on the sensor and the gateway.

In further embodiments, a sensor can be paired to a specific establishment instead of a specific gateway. For example, each retail establishment may be provided an ID number from the system vendor. A user, such as an employee of the retailer, may manually pair the sensor with the establishment by entering the sensor ID number and establishment ID number into a system interface, such as a smartphone App. In these embodiments, the sensor will be paired with the correct establishment regardless of which gateway the sensor uses for communication.

In some embodiments, the disclosed system is integrated with third-party social media sources and venues. The system matches social media user profiles provided by those third party sources with product inventory managed by the system, as well as products being consumed/depleted in a set regional area surrounding the location of the user. The system optionally makes one or more recommendations to a social media user regarding (1) the retailer best suited to the user (based on proximity, presence of a desired beverage at the retail location, or other factor), (2) which product at a specific location is most suited to the user (based user beverage preference provided in his or her social media profile or other available information source), and/or (3) promotion of a product available at a specific location the user has designated as desired, or designated by a third party as an item to be promoted. The system can accept information from third party sources, which will be integrated into the system's business intelligence engine, which provides cause and effect tracking between certain promotional activity, consumption and sales information gathered and tracked by software.

Embodiments of the system are capable of sending prompts to consumers both offsite and on-premise based on events that may be automatically compiled and/or scheduled into an event scheduling system. The system can automatically gather and compile information on local activities and events external to the establishment (such as a sporting event, a scheduled convention nearby, an upcoming holiday (e.g., St. Patrick's Day), weather conditions, outside temperature, social media activity/events, etc.) and information available within the establishment and/or system (such as products available and/or consumed, promotional events, daily beer sales, average daily depletion, beers poured, average check counts and amounts, etc., which may be automatically compiled or entered by users) to generate the prompts. These prompts can result from a knowledge engine utilizing inventory and product data available to it, as well as third party data from POS, social media and partner application databases.

In certain embodiments, weight scale, volume changes and alerts are calculated in the cloud. The system is also capable of making many of these calculations locally as well. It is also possible to deliver alerts locally through the sensor/transmitter and the gateway/uplink including audible alerts signifying changes in inventory status, order and delivery status, shortages, as well as quality and infrastructure issues associated with the cooler, draft lines, environmental temperature and humidity, POS system status, etc.

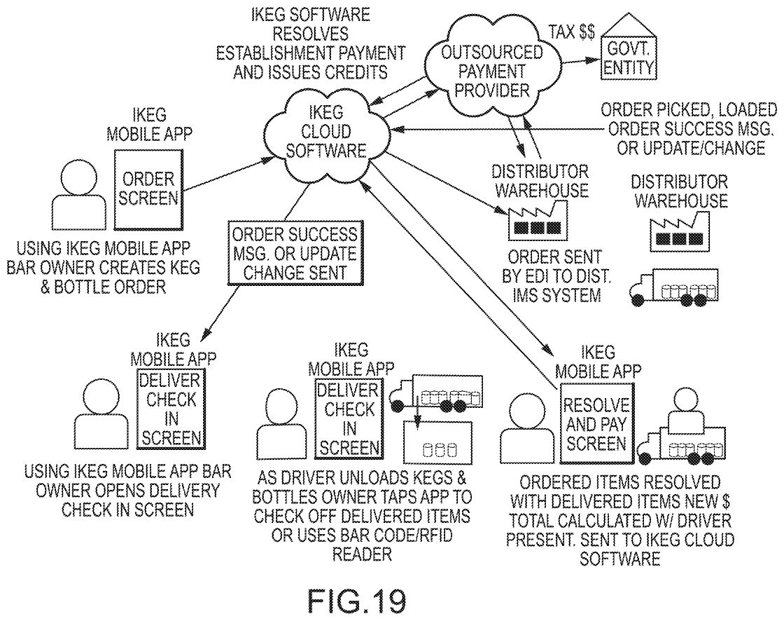

FIG. 19 depicts a process whereby a user can utilize a mobile app or other electronic portal to communicate with software (e.g., enterprise and/or SaaS software) to order, pay, check-in delivered orders, and/or resolve credits according to one embodiment of the present disclosure.

The system software (e.g., enterprise and/or SaaS software) allows a retail or wholesale user to order his keg beer and/or bottled beer (or other liquid). Enterprise software can load a copy of at least one distributor's inventory database into the enterprise software. A retailer user, such as a bar or restaurant owner, may access and browse the distributor inventory on the enterprise software and select kegs, bottles, or other beverage items and add them to the user's order. The user can create a new order by making selections from the distributor inventory, reissue an earlier order, or combine an earlier order with a new order. Once the order has been selected, the use may be given a chance to review the order before submitting, such as by having the order placed into a shopping cart. When the user is finished, the order is submitted by the user. The user has the option to submit the order with the user's PO (Purchase Order) number. The order passes first through the enterprise software and to the distributor for fulfillment. The enterprise software may be connected by EDI (Electronic Data Interface) to the distributor's IMS (Inventory Management System) and/or the distributor's accounting system.

When the order from the bar or restaurant user is transmitted to the enterprise software, it may be sent to the IMS for picking and loading for delivery. The order may also be sent to the distributor's accounting department for billing. The order is picked, put on a delivery truck and is transported to the bar or restaurant location. As the distributor's driver unloads the kegs and/or other beverage containers (e.g., bottles) the retail or wholesale user can utilize a mobile app to check-in the order, which may be accomplished in several ways. The user can manually visually inspect the incoming order and, using a screen on the app that lists the items the user ordered, electronically touch a checkbox on the screen to acknowledge receipt of the item on the user's list of orders. Alternately or in addition to visually inspection, the user can employ an automated method. The automated method can employ various technologies including optical (e.g., barcode) and/or electromagnetic (e.g., RFID) systems. If the ordered product (such as a keg, box case, six pack, syrup container, or bottle) has a visually readable barcode, the user can confirm delivery by scanning the bar code. If the delivered product unit has an RFID label (RFID inlay embedded and/or attached to the container) and the user (e.g., the user's mobile device) has an RFID reader, the product unit can be checked in via an RFID scan.

Once the inventory has been delivered and checked in, the user may pay for the delivery by sending a payment command via the mobile app or another electronic portal. The payment command may be electronically transmitted to the enterprise software, then in some embodiments to an EDI connection to a payment provider. Assuming the retail or wholesale user has an account with the payment provider, the user can authorize the payment provider to electronically transfer funds from the user's bank account. Upon receipt of a payment command, the payment provider can debit the user the amount of the order, credit the distributor the amount of the order. If the payment provider is registered with the user's state alcohol tax collection authority, the payment provider may also provide the state alcohol tax collection authority with the appropriate tax payment.

In the event that the beverage items delivered do not match the beverage items ordered, the user may utilize the mobile app or an electronic portal to communicate with the distributor's IMS via the enterprise software to remove undelivered beverage items from the purchase order and/or to add beverage items to the purchase order that were not ordered, but were mistakenly delivered and are desired by the user. The price difference between the received beverage items and the ordered beverage items may be realized by the third-party payment provider as a credit to the user's account and a debit to the distributor's account (for undelivered, ordered items) or as a debit to the user's account and a credit to the distributor's account (for delivered, unordered items).

Kegs come in different sizes, including half-barrel, quarter-barrel, and sixth-barrel sizes. Within these size categories, different manufacturers produce kegs of different dimensions. Kegs are often designed with a round bottom that is surrounded with a round collar that allows the keg to sit upright and level.

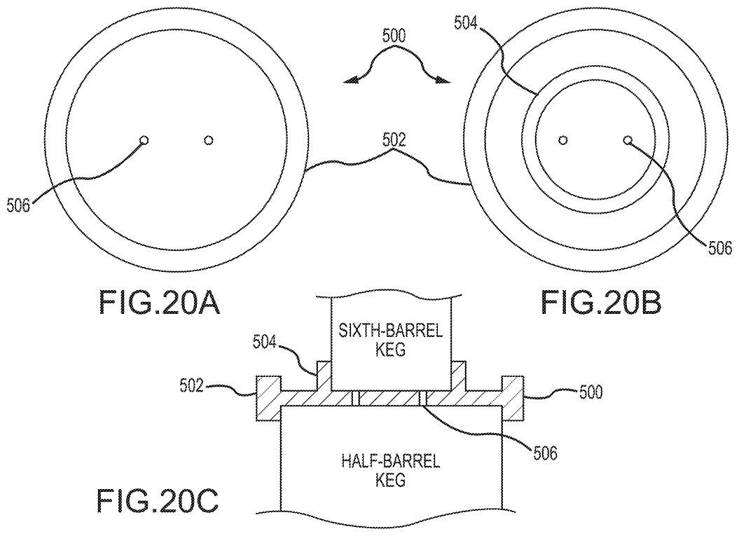

Due to the size differences, it can be difficult to stack smaller kegs atop larger kegs. As shown in FIGS. 20A-20C, a stacking adapter 500 can be used to secure a similarly-sized or smaller keg atop a larger keg, such as a half-barrel keg. A stacking adapter 500 includes a generally disc-shaped body having an upper surface and a lower surface opposite the upper surface. The generally disc-shaped stacking adapter 500 includes raised ridge 502 (which may be continuous or intermittent along the circumference of adapter 500) extending downwardly, and optionally, also upwardly from the circumference of the stacking adapter 500. The inner diameter of the circumferential ridge 502 on the lower portion of adapter 500 is sized to accept the top of a half-barrel keg, and the inner diameter of the circumferential ridge 502 on the upper portion of adapter 500 is sized to accept a similarly sized keg.

Embodiments of adapter 502, such as the one depicted in FIGS. 20A-20C, also include an inner ridge 504. The inner diameter of the ridge 504 is sized to accept the bottom of a smaller keg than the keg upon which adapter 500 is placed. If the bottom keg is a half-keg, the inner diameter of ridge 504 may be sized to fit a quarter-barrel keg or sixth-barrel keg. Some embodiments include multiple inner ridges to accommodate kegs of different sizes.

In some embodiments, the diameter of ridge 502 is at least 14 inches and at most 17 inches. In other embodiments, the diameter of ridge 502 is at least 14% inches and at most 16 inches. In still further embodiments, the diameter of ridge 502 is approximately 16 inches.

In certain embodiments, ridge 502 extends downward by about 2 inches. In other embodiments, ridge 502 extends downward by about 1.5 inches. In still further embodiments, ridge 502 extends downward by about 1 inch.

In at least one embodiment, the ridge 504 has an inner diameter of about 10 inches. In other embodiments, ridge 504 has an inner diameter of about 9.5 inches. In still other embodiments, ridge 504 has an inner diameter of about 9¼ inches

In certain embodiments, ridge 504 extends upward by about 2 inches. In other embodiments, ridge 504 extends upward by about 1.5 inches. In still further embodiments, ridge 504 extends upward by about 1 inch.

In further embodiments, the stacking adapter 500 includes one or more throughholes 506 extending through the body of the adapter in vertical directions (e.g., aligned with the force of gravity) which may be generally parallel to ridges 502, 504, allowing fluid to drain out of the enclosure formed by the raised circular ridge 502.

In some embodiments, the stacking adapter 500 is made of substantially rigid plastic.

In some embodiments, the transmitter connected to the liquid container (e.g., keg) detects the first available uplink and begins transmitting information through that uplink. However, alternatives may be provided. In situations where two establishments (bars, restaurants, etc.) are in close proximity to one another, a sensor in one facility can transmit information to the uplink/gateway in another facility. In situations where this scenario could be undesirable, embodiments of the present disclosure permit the pairing of a transmitter to a particular uplink/gateway so that communications from that transmitter occur through a particular uplink/gateway.

In some embodiments, a transmitter transmits its identifying information to an uplink/gateway, and the uplink/gateway transmits identifying information for both the transmitter and the uplink/gateway to the enterprise software. The software records the gateway used for each communication of a specific transmitter. After a predetermined number of communications for that specific sensor, the software determines the most common gateway used by that sensor for communication and pairs that sensor with the most commonly used gateway. In one example, the software waits until the total number of communications reaches a threshold before determining the most common uplink/gateway and associating a particular transmitter with a particular uplink/gateway. In another example, the software waits until the number of communications with any single uplink/gateway reaches a threshold before determining the most common uplink/gateway and associating a particular transmitter with a particular uplink/gateway.

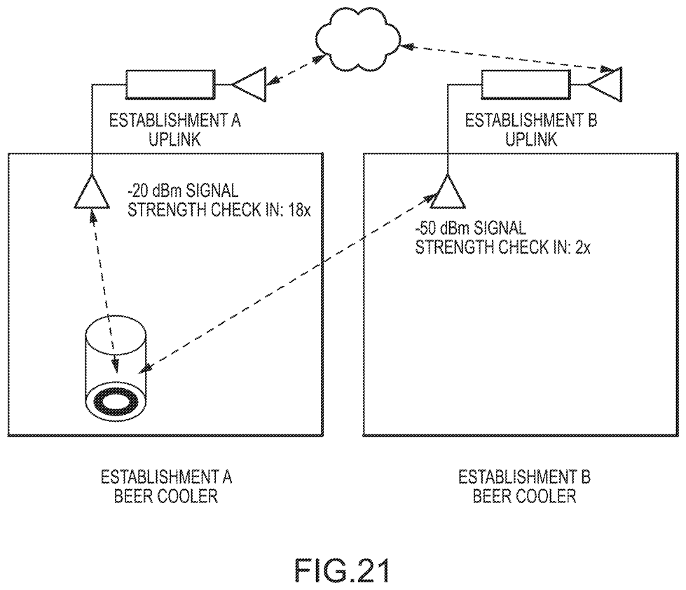

FIG. 21 depicts an example scenario with adjacent establishments—Establishment A and Establishment B, each with their own uplink/gateway. A sensor is placed on a container (e.g., keg) in Establishment A's beer cooler and communicates with the enterprise software via Establishment A's uplink. In later uses, the sensor on A's kegs occasionally communicates through Establishment B's uplink. After twenty total uses, the sensor has connected with A's uplink eighteen times and B's uplink two times. The example software evaluates the check-in locations of a sensor after twenty total check-ins, compares the eighteen Establishment A check-ins to the two Establishment B check-ins, and pairs the sensor with Establishment A based on the greater number of check-ins. In future uses, the enterprise software assumes the sensor is located on a keg in Establishment A even if that sensor communicates with the software via Establishment B's uplink.

In certain embodiments, the predetermined number is a set number of communications, such as, for example, 10, 12, 15, or 20 communications from a specific sensor. In other embodiments, the predetermined number may be set based on a ratio of communications from different uplinks. For example, when a sensor has communicated via two different uplinks, the software may pair the sensor with uplink-A when the number of communications from uplink-A is 2×, 3×, 4×, 5×, or 10× greater than the number of communications from uplink-B.

In still other embodiments, signal strength is used to associate (pair) a transmitter with an uplink/gateway. For example, the receiver portion of the uplink/gateway detects the signal strength of each transmitter communicating with the uplink/gateway, and embedded software passes the signal strength associated with each transmitter along the identifying information for each transmitter (e.g., the sensor and/or transmitter's unique serial number) to the enterprise software. In one example, after the software records a predetermined number of successful transmission signal strength messages from a transmitter through two or more uplinks/gateways, the system software compares the received signal strength of the transmitter from the uplinks/gateways and correlates (pairs/assigns) the transmitter to the uplink receiving the greatest signal strength from the transmitter. In some embodiments, the strength of the signal recorded by each uplink/gateway is associated with a strength rating (e.g., low, medium, high strength) and the uplink/gateway with the highest number of higher level signal strengths is correlated with a particular transmitter.

Turning again to FIG. 21, the sensor in Establishment A has successfully sent its data through Establishment A's Uplink at a signal strength 50 db, and thru Establishment B's Uplink at a signal strength 8 db. In one example, the system software records a certain number (e.g., 1, 2, 3, 4, 5, 10, 20) successful check-ins by an individual sensor and makes a decision on which uplink should be correlated with the sensor. In this example, the sensor successfully had a higher average signal strength (50 db) to Establishment A's uplink and a lower average signal strength (8 db) to Establishment B's uplink, and the software assigns ownership of the iKeg Sensor to Establishment A. In other embodiments, the maximum signal strength received by any gateway/uplink may be used to establish ownership/pairing of a sensor to an uplink.

In some embodiments, RFID pairing may be used to represent taps instead of kegs. The establishment may be further encoded along with the tap on the RFID tags. The RFID tag may pair a sensor to a particular establishment (and/or cooler within the establishment) as well as to the particular tap line. In this configuration, the sensor can equivalently use any gateway for communication since the cloud software explicitly knows to which establishment the sensor belongs via the RFID tag pairing information.

Alternatively (or additionally) the tags could have an extended RFID field to identify a particular radio frequency or Personal Area Network (PAN) ID for the sensor to communicate with, effectively locking the sensor to a particular gateway. The gateways in turn can be manually configured to particular radio frequencies and/or PAN ID's at installation in locations where multiple gateways are within range of one another.

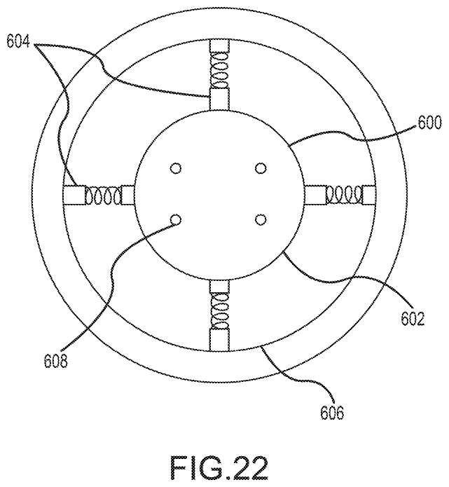

In some embodiments, the sensor is configured and adapted to attachedly coupled to beverage containers (such as beer kegs) of different sizes. At least one embodiment of the present disclosure includes a sensor and transmitter that is configured to attach to the bottom of various sizes of kegs by fitting into the space under the bottom of the keg. In one embodiment, illustrated in FIG. 22, the sensor 600 is generally a pressure sensor, which in at least one embodiment is an electronic device that converts weight into an analog and/or digital value. When the sensor 600 is mounted to the bottom of the keg, one or more sensor weight elements 608 rest on the floor. In some use scenarios, kegs are stacked on top of each other. In such situations, the system vendor can supply a rigid, hard plastic mat (not shown) that can fit on the top of a keg to provide a hard, level surface for the keg sensor/transmitter on the next layer up to sit on. In the illustrated embodiment, Sensor 600 has a center portion 602 with one or more adjustable-length connection arms 604 extending radially outward, Shapes other than circular and connection arm numbers other than four are contemplated. The connection arms 604 are configured to secure the sensor 600 to the inner surface of the keg's collar 606. In the example embodiment illustrated in FIG. 22, each of the one or more connection arms 604 contain an adjustment mechanism (illustrated as a spring) that secures the one or more arms 604 to the container.

To install the sensor 600, a user retracts one or more arms 604 (if required), places the sensor 600 on the container (such as in the cavity at the bottom of the keg), then extends the arms 604. Springs bias the arms 604 to extend outwards and engage the inner diameter of the keg's collar 606. In some embodiments, each arm 604 further includes a terminal clip (not shown) to mechanically secure the arm 604 to the lip of the keg's collar.

In some embodiments, the connection arms 604 have a travel range configured to fit keg collars with an inner diameter between about 16 inches and about 7 inches. In other embodiments, the connection arms 604 have a travel range configured to fit keg collars with an inner diameter between about 15 inches and about 12 inches. In still alternate embodiments, the connection arms 604 have a travel range configured to fit keg collars with an inner diameter between about 9 inches and about 7 inches.

In still further embodiments, the connection arms 604 can accommodate up to 1½ inch diameter differences. In yet further embodiments, the connection arms 604 can accommodate up to 3½ inch diameter differences

While the illustrated embodiment discloses connection arms 604 extendable by a spring mechanism, other structures and mechanisms for extension are contemplated. For example, in some embodiments, some of the connection arms 604 do not contain an adjustment mechanism and are fixed in length. In some embodiments, only a single connection arm 604 is adjustable. In certain embodiments, the adjustment mechanism includes a ratchet mechanism, which may or may not include a spring to bias the connection arm in either an extended or retracted direction, and which may or may not include a release mechanism to disengage the ratchet. In still further embodiments, one or more connection arms 604 are pushed into place by the downward force of the weight of the container (keg), and may include a locking (with optional release mechanism) actuated by the downward force of the container (similar to a ski binding).

While the illustrated embodiment discloses sensor weight elements 608 attached to the center portion 602, the sensor weight elements 608 may also be attached to the connection arms 604 such that, when installed on a keg, the sensor weight elements 608 fit between the keg's collar and the floor or other supporting surface.

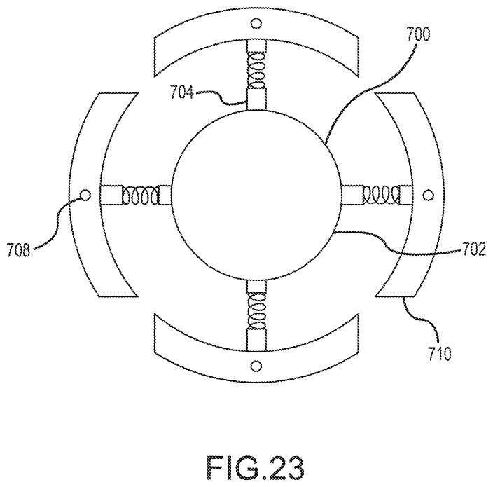

FIG. 23 illustrates another embodiment of a sensor configured to be attachedly coupled to various sizes of containers (e.g., kegs) according to another embodiment of the present disclosure. Similar to the sensor 600 shown in FIG. 22, the sensor 700 shown in FIG. 23 is generally a pressure sensor and fits into the space under the bottom of the keg. When the sensor 700 is mounted to the bottom of the keg, sensor weight elements 708 rest on the floor or other supporting surface. In the illustrated embodiment, sensor 700 has a center portion 702 with adjustable-length connection arms 704 extending outwardly, although shapes other than circular and numbers of connection arms 704 other than four are contemplated. Each connection arm 704 may be connected to a support (e.g., curved support 710), which may be shaped to correspond to a segment of a keg's collar. In some embodiments, the upper surface of one or more supports 710 may include a channel or groove (not shown) sized to accept a segment of the bottom of the collar. In certain embodiments, the channel is wider than the width of the keg's collar, so that the channel can accept collars of different sized kegs. In alternate embodiments one or more supports 710 include an upwardly extending flange adapted to engage the inner diameter of the keg. Still further embodiments include one or more supports 710 that engage the inner diameter of the container, and the one or more support 710 may be sized to engage the lower surface of the liquid vessel while holding the bottom edge of the lip extending downward from the liquid vessel off of the support surface.

When installed on a keg, the weight of the keg is supported by the one or more supports 710, which allow the sensor weight elements 708 located on the supports 710 to determine the weight of the keg. In use, a container (e.g., a keg) is connected to the sensor 700, with the weight of the container being supported by the supports 710.

In some embodiments, the connection arms 704 have a travel range configured to fit keg collars with an inner diameter between about 16 inches and about 7 inches. In other embodiments, the connection arms 704 have a travel range configured to fit keg collars with an inner diameter between about 15 inches and about 12 inches. In still alternate embodiments, the connection arms 704 have a travel range configured to fit keg collars with an inner diameter between about 9 inches and about 7 inches.

In still further embodiments, the connection arms 704 can accommodate up to 1½ inch diameter differences. In yet further embodiments, the connection arms 704 can accommodate up to 3½ inch diameter differences

Stacking spacers can be used to stack like-sized kegs atop each other. Two exemplary beer keg stacking spacers are shown in FIG. 29 and also in U.S. Design Pat. Nos. D327,604 and D331,349.

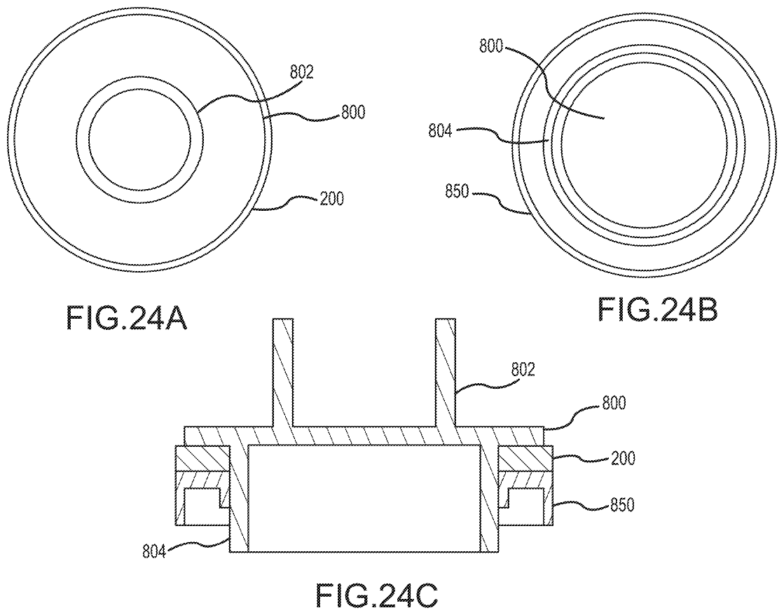

Illustrated in FIG. 24A-C is a spacer adapter 800 configured to allow a smaller keg to be used with a sensor, such as the sensor 200 shown in FIGS. 4A to 5E, sized for a larger keg, according to one embodiment of the present disclosure. For ease of understanding, the sensor 200 is represented as a simple disc in FIGS. 24A-C. The spacer adapter 800 and sensor 200 are shown mounted on a keg spacer 850, one example being the keg spacer described in U.S. Design Pat. No. D327,604.

An adapter 800 includes a body (generally circularly-shaped, e.g., disk-shaped, to match the shape of the keg) having an upper surface and a lower surface opposite the upper surface. An upper circular ridge 802 extends upwardly from the upper surface. The inner diameter of the ridge 802 is sized to accept the bottom of a smaller container (e.g., keg), such as a quarter-barrel keg or sixth-barrel keg. The stacking adapter 800 also includes a lower circular ridge 804 extending downwardly from the lower surface. In some embodiments, the outer diameter of the lower circular ridge 804 is within the range of outer diameters for half-barrel kegs, namely, between about 16 inches and about 12 inches. The outer diameter of the disc-shaped spacer adapter 800 is sized to fit within the central aperture of a weight or volume sensor (e.g., sensor/transmitter 200) and within the central aperture of a keg spacer 850 (e.g., the keg spacer described in U.S. Design Pat. No. D327,604), allowing the spacer adapter to rest atop the sensor 200 and spacer 850. As shown in FIG. 24C, the lower circular ridge 804 may be sized to extend through the central hole of the annular disc-shaped sensor 200 and through the central hole of the keg spacer 850, such that ridge 804 is snugly received within sensor 200 and spacer 850, assisting in securing the sensor and the spacer together.

In alternate embodiments, not shown, the lower circular ridge 804 extends downward to a height not greater than the height of the sensor 200. In these embodiments, the adapter 800 may be used to fit a smaller keg with a sensor 200 (sensor 200 being sized for a larger keg) without the lower circular ridge 804 extending beneath the sensor 200 such that the weight of the smaller keg and the weight of the adapter 800 will be borne by the sensor 200. While the description of the spacer adapter 800 describe a structure sized to support a sixth-barrel keg atop a sensor (and/or atop a spacer designed for a half-barrel keg), spacer adapters sized to support different sized smaller kegs on sensors and/or spacers designed for different sized larger kegs are also contemplated.

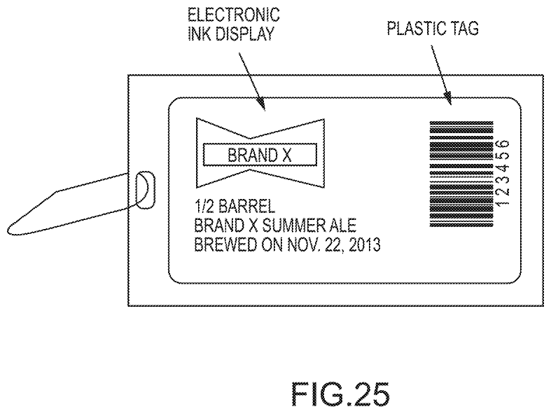

Depicted in FIG. 25 is a smart tag according to one embodiment of the present disclosure. The smart tag carries one or more data recording and/or inventory management functions in a single device. The smart tag may be attachable to a liquid container (e.g., a keg) to permit attachment or removal by hand, or it may be attached to a keg in a more permanent fashion by inhibiting removal by hand. In one embodiment, the smart tag is a plastic tag approximately 3.25 inches long, approximately 2.0 inches wide, and approximately 0.15 inches thick, and may be approximately the width and height of a credit card. The size of the smart tag may vary in other embodiments.

The smart tag may include an RFID chip and inlay encoded with at least a unique serial number and optionally other data. In one embodiment, the unique serial number will be encoded onto the RFID chip by the brewer at the end of the brew process when a keg is filled at the brewery. The encoding process is accomplished by a hardware RFID encoding device in electronic communication with the enterprise software. The unique serial number may be issued by the provider of the enterprise software and recorded in the enterprise software database along with the identifying information (such as, for example, the brewery, the brand of beer (or other beverage) and/or the product name), and may also include a time stamp (which may include the time of day, month, day and/or year).

In some embodiments, the smart tag includes an electronic ink display, the manufacture and use of which is known in the art. Electronic ink (or “E-ink”) displays with an electronic screen where the message, text or artwork is written onto the display. The display is human and/or machine readable without a continuous power supply. The E-ink display uses power to initially display a message containing text and/or artwork. Once the message is presented on the display, the display does not require a continuous power supply to maintain the message. The message remains on the display until power is supplied to the E-ink display and the message is erased or replaced by a different message.

The exemplary smart tag depicted in FIG. 25 includes identifying information, for example, a recitation that brewer is “Brand X,” the liquid product is “Brand X Summer Ale,” the keg size is ½ Barrel, and the beer's brewed date is Nov. 22, 2013. The smart tag may optionally include graphical elements such as a bar code or similar machine-readable code (e.g., a QR code), or further identifying indicia, such as the brewer's trademark. Alternate embodiments include one or more of the above identifying information.

In some embodiments, the smart tag includes a temperature sensor and a non-transient computer-readable storage media, such as a memory chip. The temperature sensor may be configured to periodically (or continuously) record the ambient temperature and store the temperature datum along with the time/date the temperature reading was taken—a date/time stamp. When the sensor checks into the system, the temperature and date/time information can be transmitted to the system software along with other information provided to the sensor by the RFID chip on the smart tag.

A temperature sensor associated with a sensor/transmitter or with an RFID tag is disclosed above in connection with recording and later transmitting temperature data. A similar temperature sensor may be attached to or incorporated within the smart tag.

In some embodiments, the temperature sensor may be configured to re-set at or near the time the RFID inlay chip on the smart tag is encoded.

In some embodiments, the smart tag includes an accelerometer. An accelerometer associated with a sensor or with an RFID tag is disclosed above in connection with recording and later transmitting acceleration data. A similar accelerometer may be attached to or incorporated within the smart tag. In some embodiments, the accelerometer may be configured to re-set at or near the time the RFID inlay chip on the smart tag is encoded.

The smart tag is attached to a keg or other beverage container. In certain embodiments, the smart tag is attached to the neck of a keg or to a keg handle by a zip tie. In other embodiments, the smart tag is bonded, glued or otherwise affixed to the keg. In further embodiments, the keg is fitted with a mounting bracket for receiving and securing the smart tag, such as, for example, a slide-and-snap-in mount, a bayonet-type mount, or a screw-in mount. Other means of attaching the smart tag to the keg are contemplated.

In some embodiments, the system software (e.g., enterprise and/or SaaS software) can provide profitability data to a system user, such as a restaurant or bar owner. As discussed, the enterprise system receives and stores data regarding changes in the weight of a keg over time, corresponding to the depletion of beer in the keg, and the identity of the beer in the keg being depleted. For example, a standard half-barrel keg contains 15.5 gallons of beer when full. As the keg is depleted, the enterprise software determines the remaining percentage of beer in the keg and the software calculates the remaining number of pints (16 oz.) or other standard serving sizes remaining in the keg and displays that to the user in an electronic interface such as, for example, an app on a mobile device or a secure Internet web portal. In addition, the enterprise software can store the beer bottle inventory of a bar or restaurant.

The enterprise software is capable of storing the cost of a keg or the unit cost of a bottle or can of beer. The cost can be stored in the enterprise software database by automatically synchronizing with the prices stored in, for example, a beer distributor's database thru EDI integration or manual input. The cost can also be stored in the enterprise software database by automatically, such as by synchronizing with a Point of Sale (POS) system in a bar or restaurant. An example point of sale system includes a computerized cash register operated by the retailer and in electronic communication with the enterprise software. The cost of kegs or bottles can be input manually by the bar owner through an input screen on an electronic interface, such as, for example, an app on a mobile device or a secure Internet web portal. In some embodiments, the enterprise software stores both the cost of a keg to the retailer and the price that the retailer charges for each pint (or other unit of measurement) of beer sold. By collecting this data, the enterprise software can calculate and display to the user the profit margin for a particular type of beverage.

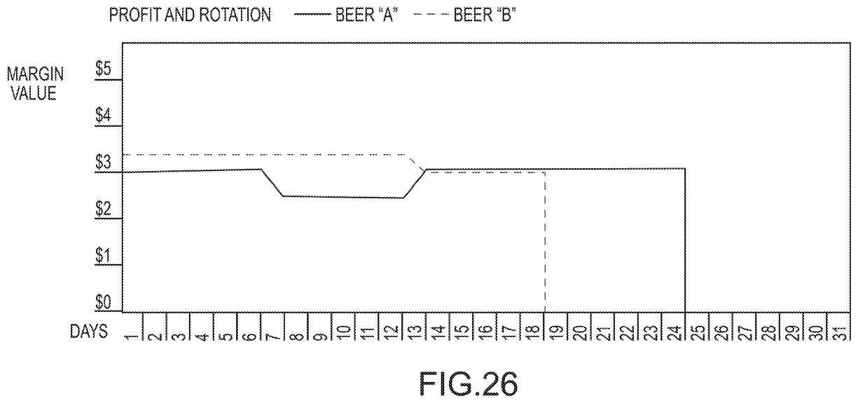

FIG. 26 illustrates example profit margins of two beers, A and B, as kegs containing the beers are depleted over time. The graph shown in FIG. 26 is representative of a graph that can be displayed to a user depicting the profitability of beverages sold by that user. Beer A begins the month at Day 1 with a profit margin of $3. For example, the retailer may sell Beer A at a price of $5 per pint and buys a keg of Beer A at a total price equivalent to $2 per pint, providing a profit margin of $3 per pint. On Day 7, Beer A goes on sale and the price decreases to $4.50 per pint, reducing the profit margin to $2.50. The sale lasts until Day 12, when the price returns to normal and the profit margin returns to $3. The keg is emptied on Day 24, so the profit margin drops to zero.

In the same figure, Beer B begins the month at Day 1 with a profit margin of $3.25. On Day 12, Beer B goes on sale and the margin drops to $3. The profit margin on Beer B remains constant at $3 until the keg containing beer B depletes to empty on Day 18.

Using the information collected and provided by the enterprise software, a user (e.g., a retail bar owner) can track profit over time, enabling the user to make informed inventory decisions about which beers to rotate on and off tap. If a beer is rotated off tap, it is returned to the safety stock inventory in the retail user's cooler awaiting its return to the tap line up. The displayed data will easily allow a user to determine if the user has rotated too many low profit margin beers on tap, indicating that the user should consider rotating a lower-margin beer off tap and replacing the lower-margin beer with a higher-margin beer.

In some embodiments, the enterprise software can notify the user via email, SMS text alert, computer automated phone call, or other notification method upon reaching a predetermined profit margin threshold. For example, a user may elect for the enterprise software to send a notification if the profit margin of any beverage drops below a predetermined amount, such as for example, $2 per pint, or if the profit margin of any beverage drops by a predetermined amount, such as, for example, by 20%. Such notifications would apprise a retail user if unprofitable kegs are on tap or if bar tenders have initiated unauthorized sales.

In some embodiments, a computer system including a processor and non-transient computer-readable storage media, such as the enterprise software, is provided. The system receives retail pricing information for a beverage from a retail point of sale system, such as a bar or restaurant owner's computerized cash register, which is in electronic communication with the computer system. The system can also receive wholesale pricing information for the beverage from a wholesale product pricing database in electronic communication with the computer system, such as a beer distributor's system integrated via EDI or by manual input by a representative of the beer distributor into an electronic form. The system can also receive information relating to depletion of the beverage from a liquid container over time from a sensor/transmitter attached to the liquid container, the sensor/transmitter being in electronic communication with the computer system. With this information, the system is capable of determining the profit margin of the beverage based on the retail pricing information, the wholesale pricing information, and the information relating to depletion of the beverage.

The data collection of the enterprise software in determining rates of keg depletion over time can aid users in making informed decisions when ordering new kegs. In some embodiments, the enterprise software provides users with recommendations regarding the number of kegs to order based on recorded depletion rates over time. The enterprise system can receive and store data regarding changes in the weight of a keg over time, corresponding to the depletion of beer in the keg, and the identity of the beer in the keg being depleted.

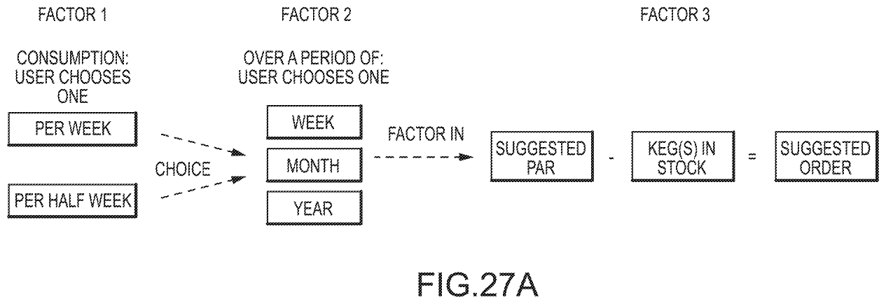

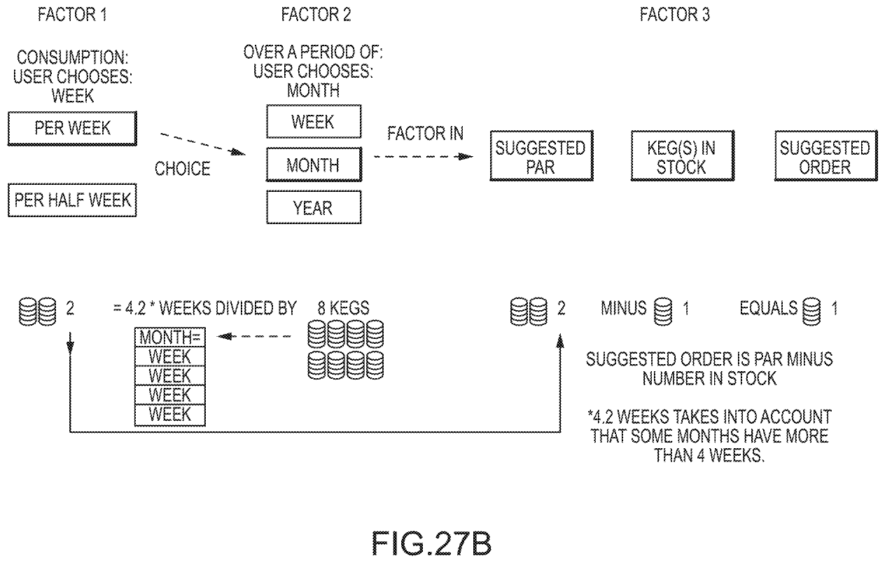

In some embodiments, the enterprise system determines the recommended number of containers (e.g., kegs) to order for a particular beverage, then suggests that the user order that number of kegs. One embodiment of a method for calculating a suggested order is illustrated in FIG. 27A. The illustrated example method utilizes three factors.

Factor 1 is the user's delivery period. For example, some retailer users may have kegs delivered to the user's establishment on a weekly or biweekly basis. Factor 1 can be entered by the user or can be determined by the enterprise software based on past orders for the customer.

Factor 2 is the measurement period for which information is available on a particular product the user would like to serve at the user's establishment, which may be, for example, one week, one month, or one year.

Factor 3 is the user's current stock of untapped kegs of the particular product (e.g., beverage). The enterprise software monitors the number and status of kegs on the user's premises and therefore can determine Factor 3.

As illustrated in FIG. 27A, the enterprise software can determine a par value for a particular product (the average number of containers of the particular product the user should receive in each deliver period to prevent the user from running out of the product) by using Factor 1, Factor 2, and information available to the enterprise software. The software can then subtract the number of containers in stock to arrive at the suggested order for delivery to the user during the next delivery event.

FIG. 27B illustrates an exemplary calculation of a suggested order. Here, the user has containers (e.g., kegs) delivered on a weekly basis—Factor 1 equals “weekly.” In this example, the user chooses to measure the user's consumption over the period of a month—Factor 2 equals “1 month.” In this example, the user selects a beverage that had eight keg depletions by the user in the preceding month. (The depletion information may be taken over a different time period or the depletion data from other establishments in the vicinity of the user may also be used). Since there are 4.2 weeks in a month on average, the software will calculate the user's par to be two kegs per week: 8 kegs per month divided by the number of delivery periods in a month (4.2, which is derived from Factor 1) equals 1.9 kegs per week, which is rounded up to two kegs per week to prevent the user from depleting the user's supply of the product. If the user has one untapped keg in stock (Factor 3), the software determines that the user's suggested order is one keg for the next delivery: two kegs per week minus the one keg in stock equals one keg.

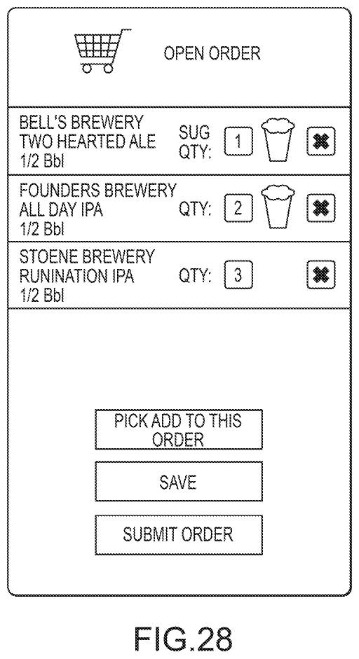

FIG. 28 depicts an exemplary user interface, such as, for example, an app on a mobile device, for ordering beverages using the enterprise software. Using the method described in FIGS. 27A-B, the software provides a suggested quantity (abbreviated “Sug Qty”) order of 1 half-barrel keg of Bell's Brewery Two Hearted Ale. In some embodiments, a design or symbol, such as the stylized beer glass shown in FIG. 28, is used to visually notify the user that a suggested order is provided for a particular beverage. The remaining beverages in this exemplary order do not include suggested orders and consequently do not display beer glass designs. In some embodiments, the suggested order quantity is pre-filled in the entry field for keg quantity. The user can choose to allow the suggested quantity number to remain in the field, or the user can change the number to a quantity of his or her own choosing. Selecting “Save” can save the order for the future, and selecting “Submit Order” can place the order.

In some embodiments, a computer system including a processor and non-transient computer-readable storage media, such as the enterprise software, is provided. The computer system receives a rate of consumption of liquid containers by electronic transmission of the rate of consumption to the computer system, such as, for example, the user reporting the rate of keg consumption using a mobile app in communication with the computer system. The computer system receives a measurement period by electronic transmission of the measurement period from a user to the computer system, such as, for example, the user entering the measurement period using a mobile app in communication with the computer system. The computer system determines a current stock of liquid containers, such as kegs, in the possession of the user by signal transmitted from a sensor/transmitter attached to each liquid container in the stock inventory to the computer system. The system then determines a suggested order for liquid containers for the user by dividing the kegs depleted within the measurement period by the rate of consumption, then subtracting the current stock.

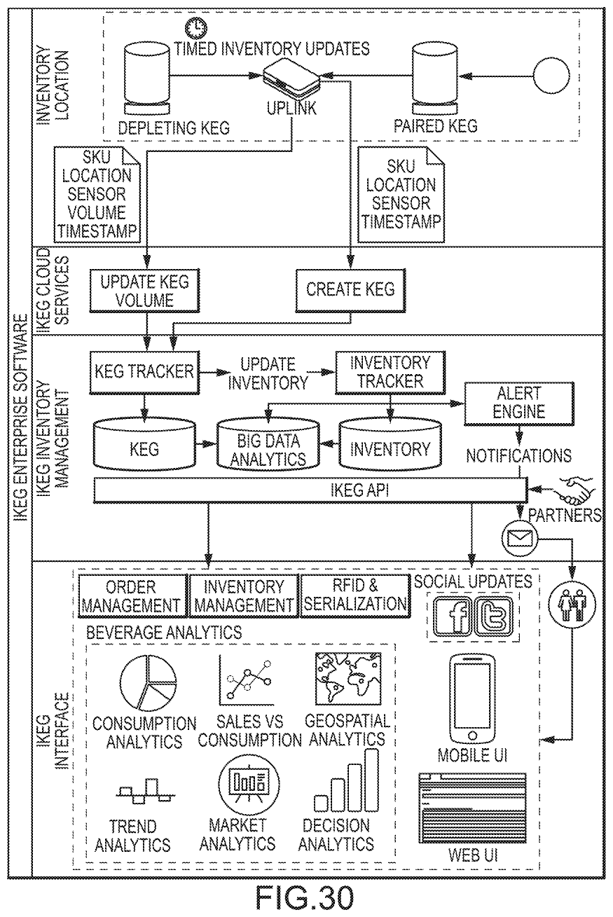

Depicted in FIG. 30 is a draft beer supply chain system and method according to at least one embodiment of the present disclosure. The system is divided into four general areas: Inventory Location (the location where the sensors and kegs being tracked are located), Services (functionality in the enterprise software system managing and communicating with the kegs/sensors at the Inventory Location, which may be cloud-based services in some embodiments), Inventory Management (software and databases within the enterprise software system used to record, manipulate and analyze information received from the kegs/sensors and from users), and Interface (software and/or hardware for a user to interface with the system).

At the inventory location, kegs that have been paired with a sensor can communication through an uplink and transmit information (e.g., location, sensor ID, volume and/or time stamp) to the enterprise system. Information about kegs that have been checked in with the system, which may be in the process of depleting, is also sent to the system via the uplink. Information about the depleting kegs may be sent at predetermined times as updates and/or may be manually sent to the system by a user.

During a “check in” procedure, the services (e.g., cloud-based services) receiving information from the uplink at the Inventory Location can receive information about a newly-paired keg and sensor, and use this information to create a new keg record for tracking information about the newly-paired keg. The services (e.g., cloud-based services) may also receive information related to kegs and sensors for which a record has already been created from the uplink, and can transfer this information to inventory management software.

In some embodiments, these services can also send information to the sensors at the inventory location to update the sensors and/or change a mode of operation of one or more of the sensors.

The Inventory Management portion of the system may include a Keg Tracker that receives updated keg information (e.g., location, sensor ID, volume, and/or time stamp) and information about newly created keg records from the services portion. The Keg Tracker may then record this information in a Keg database and/or send this information to an Inventory Tracker to update the inventory information being kept in an Inventory database. An analytical database and/or software (depicted as “Big Data Analytics”) can receive information from the Keg and/or Inventory databases and interpret/manipulate this raw information to provide useful information to one or more users. For example, the analytical database and software may send information to an Alert Engine, which in turn can send notifications to applications (e.g., mobile device apps). Various users and partners may interface with the system using various types of interfaces, such as a mobile device app. Messages may also be generated and sent to users via various type of messaging systems as illustrated by the envelope symbol in FIG. 30.

One or more types of Interfaces may be utilized by system users. For example, various modules accessible by users may be used for managing orders (Order Management), managing inventory (Inventory Replenishment), and/or sensor/keg identification (RFID & Serialization). By using their respective interfaces, users may access various types of analytics, which include but are not limited to Consumption Analytics, Sales vs. Consumption, Geospatial Analytics, Trend Analytics, Market Analytics, and/or Decision Analytics. The Interface may interact with various forms of social media to provide updates to users (Social Updates), and the interface may be embodied in different formats (e.g., apps) usable on different types of electronic devices (e.g., mobile and/or web-based user interfaces).

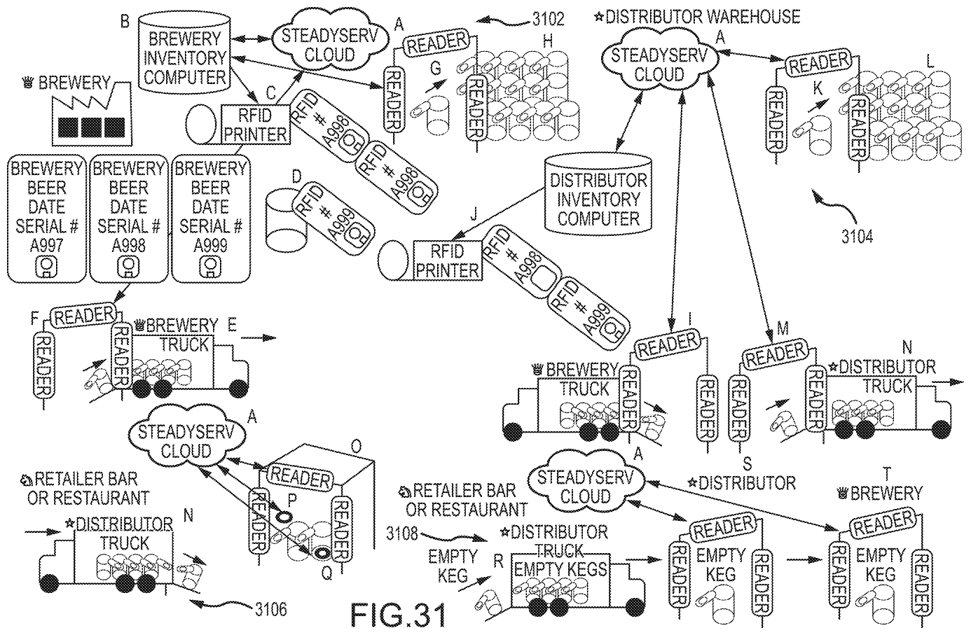

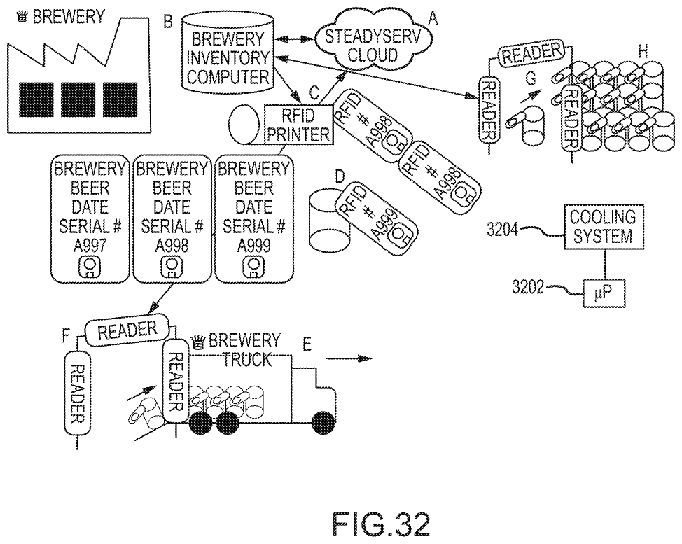

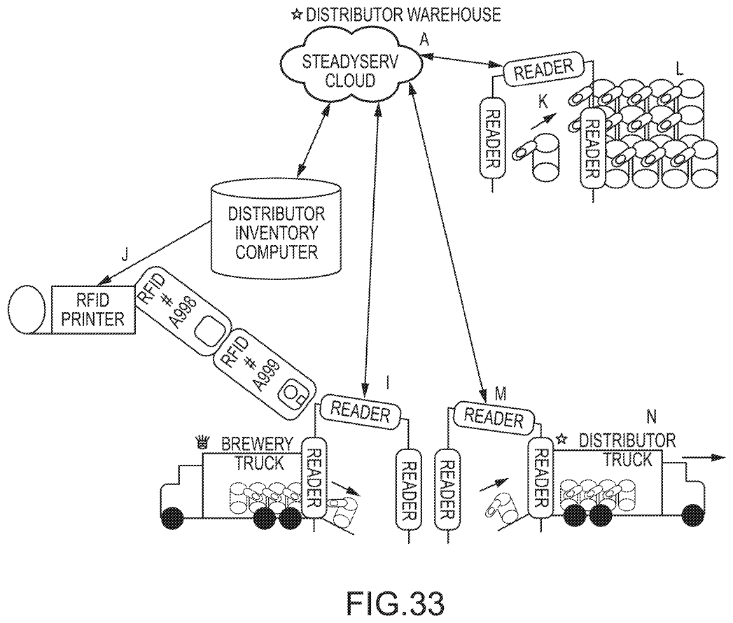

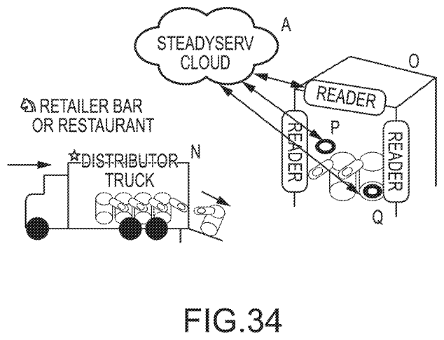

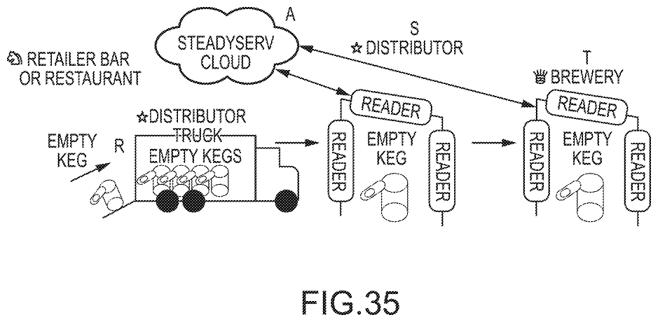

FIG. 31 is a flow chart of a draft beer supply chain system and method wherein a unique serial number may be associated with an RFID tag. A first portion 3102 (FIG. 32) is associated with a brewery; a second portion 3104 (FIG. 33) is associated with a distributor warehouse; a third portion 3106 (FIG. 34) is associated with a retailer bar or restaurant; and a fourth portion 3108 (FIG. 35) is associated with returning empty kegs to the brewery. FIGS. 31-35 illustrate the use of uniquely issued serial numbers in the brewery-distributor-retailer supply chain. The process follows a keg beer from the time it is filled with beer at the brewery until it is fully depleted and returned to the brewer as an empty keg.

The unique RFID process may begin at the brewery, as shown in FIG. 32. The system's SteadySery cloud software and its associated databases (A) may be connected by application programming interface (API) or other computer methods to a Brewery Inventory Computer (B) via the Internet. As a new keg is filled, the Brewery Inventory Computer may make a request to the cloud software to issue a new unique RFID serial number. In the example illustrated, there are three unique issued RFID serial numbers: #A997, #A998 and #A999. When the request by the Brewery Inventory Computer is completed, a new unique serial number is issued by the cloud software. The Brewery Inventory Computer saves the unique serial number and commands a printer (C) to do two things: print a visible label or tag using the issued unique serial number and encode a hybrid UHF/HF-NFC RFID inlay with that unique serial number. However, other types of RFID inlays are also contemplated.

The communication between the Brewery Inventory Computer and the cloud software results in recording in the database the unique serial number along with the brewery's name and location, the name of the beer, the date and time that the keg's beer was brewed, and the UPC number for the beer. Additional information can be recorded in the database as communicated from the Brewery Inventory Computer.

The resulting tag can be in the form of a paper-like polypropylene tag. Embedded into the tag is the hybrid UHF/HF-NFC RFID inlay. The tag has an adhesive back which is peeled off, looped through the keg handle and adhered back onto itself. Alternatively, the tag can be in the form of a plastic credit or luggage type tag. This tag may have the brewery name and beer name printed on it. The unique serial number may not be visibly printed on the tag, but the unique serial number may be encoded into the embedded RFID inlay. The plastic tag may be attached to the keg via a strong plastic strap, such as a “zip tie”.

The tag may be attached to a beer keg (D), and the keg may then be moved to a brewery warehouse (H). As the keg is moved into the brewery warehouse, it passes through the RFID gate (G). The RFID gate has UHF RFID readers that record and transmit to the cloud software a signal indicating that the keg has been moved into the brewery warehouse. The brewery warehouse may include a cooling system 3204 that cools the kegs. Cooling system 3204 may be controlled by a processor 3202 that receives temperature information associated with the kegs and that controls cooling system 3204 dependent upon the temperature information. Similarly, such a cooling system and processor may be included at keg storage facilities at a retailer or distributor, or in any keg delivery truck.

When it is decided that the keg is to be delivered to the distributor, the keg is loaded into the Brewery Truck (E) on its way to being delivered. As the keg is loaded onto the delivery vehicle, the keg passes through a RFID-equipped gate (F). The RFID-equipped gate reads the UHF tag of the keg and reports the unique serial number to the cloud software. The cloud software records that the keg has left the brewery, collects the metadata encoded on the tag, and confirms the accuracy of the steps being taken in this phase of the supply chain.

The Brewery Truck may deliver the keg to the Distributor Warehouse, where it is unloaded off of the truck and passes through another RFID gate (I) (FIG. 33). This gate communicates to the cloud software and records the arrival of the keg. Here again, the cloud software records that the keg has moved along the supply chain to a certain point, collects the metadata encoded on the tag, and confirms the accuracy of the steps being taken in this phase of the supply chain activity. This step may be repeated each time a keg passes through an RFID gate. The keg is then moved into the Distributor Warehouse (L) as it passes thru another RFID gate (K) where the keg is recorded as being put into inventory by the cloud software.

In case a brewery is not using the inventive system and a keg arrives at the warehouse without a tag, there is an alternate process wherein an RFID printer (J) is installed in the Distributor Warehouse. The RFID tag is encoded and printed with a unique serial number in a process similar to the process at the brewery. The tag is then affixed to the keg at the distributor.

When it is decided that the keg is to be delivered to the retail location (e.g., a bar or restaurant) the keg is loaded into the Distributor Truck (N) on its way to being delivered. As the keg is loaded, it passes through an RFID-equipped gate (M). The RFID-equipped gate reads the UHF tag of the keg and reports the unique serial number to the cloud software. The cloud software records that the kegs have left the distributor.

When the Distributor Truck (N) arrives at the retailer, e.g., a bar or restaurant, the keg is off loaded from the truck, as shown in FIG. 34. As the keg is moved into the cooler of the retailer, the keg passes through an RFID gate (O). The event of passing through this gateway is recorded by the cloud software. The keg is now listed in the retailer's inventory by the cloud software and is shown as being in inventory on a mobile app and web portal that can be accessed by a representative or employee of the retailer.

The iKeg sensor ring may have a built-in RFID reader which reads the HF NFC inlay that is part of the RFID tag. When the retailer decides to put an in-inventory keg on tap, the retailer may take an unused iKeg sensor (P) and hold it up to the RFID tag and push the iKeg sensor activation button. The iKeg sensor then reads the unique serial number on the RFID HF NFC portion of the tag. The retailer may put the sensor under the keg (Q). That unique RFID serial number is then transmitted to the cloud software wirelessly via the iKeg gateway (or “uplink”) along with the depletion rate of the keg through a cellular connection to the Internet. As the keg depletes, the depletion amount is recorded in the cloud software database. When the keg is fully depleted (i.e., empty), the iKeg sensor ring is removed from the keg. The keg is removed from the retailer's cooler through the RFID gate (O). The removal of the keg from the cooler is recorded by the RFID gate and transmitted to the cloud software.

The distributor may deliver fresh, new, full kegs to the proper retail location in the proper inventory amount and, at the same time, pick up empty kegs from the retailer. The empty keg is loaded onto the Distributor Truck (R) (FIG. 35) and returned to the Distributor Warehouse. When the empty keg is brought back into the Distributor Warehouse it passes through an RFID gate (S). The empty keg is recorded by the RFID gate and that empty keg is reported to the cloud software as being returned to the Distributor Warehouse. At some point when enough of the brewer's empty kegs have been collected at the Distributor Warehouse, the brewer is notified. The brewer sends a truck to the distributor. The empty kegs are picked up and returned to the brewery warehouse and pass through an RFID gate (T) and are recorded in the cloud software as being received back in brewer inventory.

When a keg is in either the brewery warehouse or the Distributor Warehouse, the keg's entry and exit are recorded by the RFID gate (F)(K) and transmitted to the cloud software. That data is communicated to the Distributor Inventory Computer and/or the Brewery Inventory Computer. While the keg is in either warehouse, a warehouse worker can find an individual keg by using a handheld RFID reader. These hand held RFID readers look similar to a gun and can read all keg RFID serial numbers, or find an individual keg.

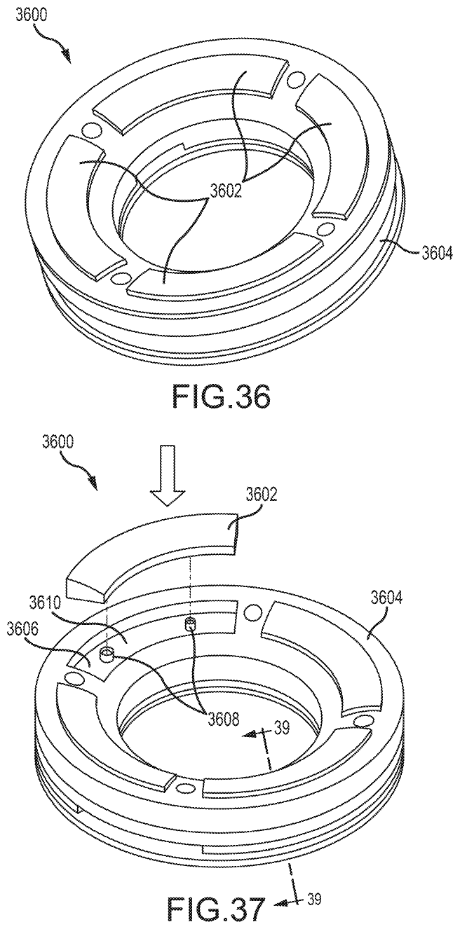

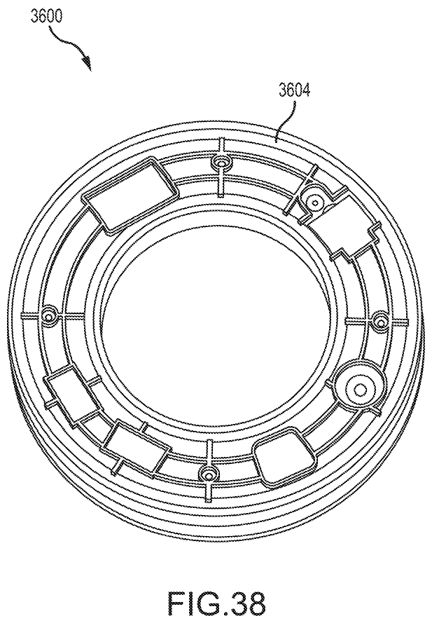

One embodiment of an iKeg no-clip sensor 3600 is illustrated in FIGS. 36-39. Sensor 3600 includes no retaining clips. The overall diameter of the sensor is small enough that it can be used under and be coupled to multiple sizes of beer kegs. The sensor may fit and be coupled to all types of ½ barrel, 40 liter, 50 liter, ¼ barrel, and ⅙ barrel kegs fabricated from steel, aluminum, plastic, rubberized material, and other commercially used materials. Sensor 3600 includes four large rubber pads 3602 on the top of the sensor. Pads 3602 have radially inwardly sloped (e.g., downwardly sloping in radially inward directions) top surfaces that grip the keg and keep the sensor from shifting when the keg is moved. The inwardly sloped top surfaces of pads 3602 enable the keg to self center on top of the sensor.

As shown in FIG. 37, sensor 3600 includes a body 3604 having arcuate slots 3606 each sized and shaped to receive a respective one of pads 3602. Two open-topped cylindrical posts 3608 project from a bottom surface 3610 of each slot 3606.

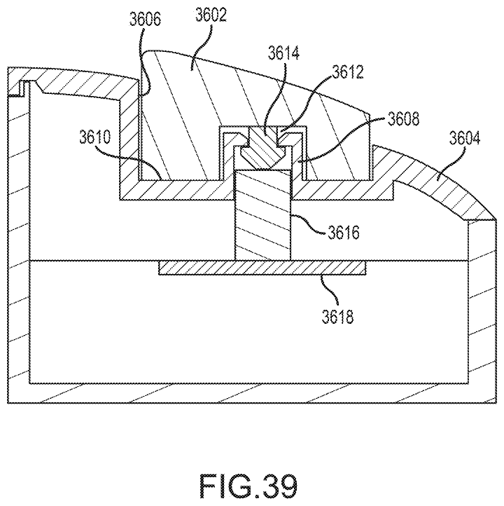

As shown in FIG. 39, a bottom surface of each pad 3602 includes two cylindrical recesses 3612 each sized to receive a respective one of posts 3608. Extending from the bottom surface within each recess 3612 is a projection 3614 sized and shaped to be snap locked into the respective post 3608. A distal end of projection 3614 presses down on an electrical element in the form of a load cell 3616 when a keg rests upon pad 3602. Electronics mounted on a circuit board 3618 measures the change in an electrical characteristic of load cell 3616 as the characteristic varies with the weight of the keg. Thus, a weight of the keg may be determined from the measurements of the electrical characteristics of the eight load cells 3616. Load cells 3616 and the electronics mounted on circuit boards 3618 conjunctively form a weight sensing arrangement to sense the weight of a keg placed on sensor 3600.

Various aspects of different embodiments of the present disclosure are expressed in paragraphs X1, X2, X3, X4, X5, X6, X7, X8, X9, X10, X11, X12, X13, X14, X15, X16, X17, X18, X19, X20, or X21 as follows:

X1. A method for determining the depletion of liquid from stacked liquid containers, comprising:

coupling a first weight sensor to a first liquid container;

coupling a second weight sensor to a second liquid container;

stacking the second liquid container above the first liquid container; and

determining a first weight of liquid contained in the first liquid container and a second weight of liquid contained in the second liquid container using weight measurements taken by the first weight sensor and the second weight sensor.

X2. A method for determining the depletion of liquid from stacked liquid containers, comprising:

attaching a first wireless electronic communication device to a first container containing a first liquid, the first wireless electronic communication device being encoded with information relating to a characteristic of the first liquid;

coupling a first sensor/transmitter to the first container;

transferring information relating to a characteristic of the first liquid from the first wireless electronic communication device to the first sensor/transmitter;

attaching a second wireless electronic communication device to a second container containing a second liquid, the second wireless electronic communication device being encoded with information relating to a characteristic of the second liquid;

coupling a second sensor/transmitter to the second container;

transferring information relating to a characteristic of the second liquid from the second wireless electronic communication device to the second sensor/transmitter;

placing the second container and second sensor/transmitter on top of the first container and first sensor/transmitter;

collecting first weight measurements of a combination of the first container, the second container, and the second sensor/transmitter;

collecting second weight measurements of the second container;

transmitting information related to the first weight measurements and the characteristic of the first liquid within the first container from the first sensor/transmitter to a computer database via a wireless network;

transmitting information related to the second weight measurements and the characteristic of the second liquid within the second container from the second/sensor transmitter to the computer database via the wireless network; and

calculating depletion of the first liquid from the first container and depletion of the second liquid from the second container based on information in the computer database.

X3. A method, comprising:

attaching a temperature sensor to a keg;

attaching a wireless electronic communication device to the keg, the wireless electronic communicating device being in electronic communication with the temperature sensor; and

transferring temperature information about the keg from the wireless electronic communication device to a computer database, the temperature information including at least one time and date at which a temperature included in the temperature information was sensed by the temperature sensor.

X4. A method, comprising:

attaching a wireless electronic communication device to a keg, the wireless electronic communication device being encoded with information relating to a characteristic of a liquid within the keg;

attaching a temperature sensor to the keg;

attaching a sensor/transmitter to the keg;

transferring temperature information collected by the temperature sensor and the information relating to a characteristic of the liquid within the keg to the sensor/transmitter; and

transmitting information related to temperature and the type of liquid within the keg from the sensor/transmitter to a computer database via a wireless network.

X5. A method, comprising:

attaching an accelerometer to a keg;

attaching a wireless electronic communication device to the keg, the wireless electronic communicating device being in electronic communication with the accelerometer; and

transferring information about acceleration of the keg to a computer database.

X6. A method, comprising:

attaching a wireless electronic communication device to a keg, the wireless electronic communication device being encoded with information relating to a characteristic of a liquid within the keg,

attaching an accelerometer to the keg, the accelerometer being in communication with the wireless electronic communication device;

attaching a transmitter to the keg;

transferring acceleration information collected by the accelerometer and information relating to a characteristic of the liquid within the keg from the wireless electronic communication device to the transmitter; and

transmitting information related to acceleration and the type of liquid within the keg from the transmitter to a computer database via a wireless network.

X7. A method, comprising:

attaching a wireless electronic communication device to a keg with liquid, the wireless electronic communication device being encoded with information relating to a characteristic of the liquid within the keg;

attaching a transmitter in communication with a flow meter to the keg, the flow meter being configured to measure flow of the liquid from the keg;

transferring information relating to a characteristic of the liquid within the keg from the wireless electronic communication device to the transmitter;

transferring information relating to the flow of the liquid from the keg from the flow meter to the transmitter; and

transmitting information related to the flow of the liquid from the keg and the type of liquid within the keg from the transmitter to a computer database via a wireless network.

X8. A method, comprising:

attaching a first wireless electronic communication device to a keg with liquid, the first wireless electronic communication device being encoded with information relating to a characteristic of the liquid within the keg, the first wireless electronic communication device configured to receive and transmit information with a wireless network;

attaching a second wireless electronic communication device to the keg with the liquid, the second wireless electronic communication device being encoded with information relating to a characteristic of the liquid within the keg, the second wireless electronic communication device configured to:
receive and transmit information with a wireless network, and
not interfere with the reception and transmission of the information by the first wireless electronic communication device;

coupling a sensor/transmitter to the keg;

transferring information relating to a characteristic of the liquid within the keg from the first wireless electronic communication device to the sensor/transmitter; and

transferring information relating to a characteristic of the liquid within the keg from the second wireless electronic communication device to a transmitter not coupled to the keg.

X9. A method, comprising:

attaching a wireless electronic communication device to each of a plurality of kegs with liquid, the wireless electronic communication device being encoded with information relating to a characteristic of the liquid within the attached keg;

coupling a sensor/transmitter to each of the plurality of kegs;

transferring information relating to a characteristic of the liquid within each keg from the wireless electronic communication device attached to the keg to the sensor/transmitter coupled to the keg;

weighing each of the plurality of kegs with the coupled sensor/transmitter;

transmitting information related to the weight of each keg and the type of liquid within each keg from the coupled sensor/transmitter to a plurality of uplink/gateways, each uplink/gateway within a predetermined distance of the sensor/transmitter; and

transmitting information related to the weight of each keg, the type of liquid within each keg, and the geographic location of the transmitting uplink/gateway from each uplink/gateway to a computer database via a wireless network, the transmitted information including a time and date associated with:
the weight of each keg;
the type of liquid within each keg; and/or
the geographic location of the transmitting uplink/gateway within the predetermined distance.

X10. A method, comprising:

attaching a wireless electronic communication device to a liquid container, the wireless electronic communication device being encoded with information relating to a characteristic of the liquid within the attached container;

coupling a sensor/transmitter to the container;

transferring information relating to a characteristic of the liquid within the container from the wireless electronic communication device attached to the container to the sensor/transmitter coupled to the container;

weighing the container with the coupled sensor/transmitter;

transmitting information related to the weight of the container and the type of liquid within the container from the coupled sensor/transmitter to an uplink/gateway associated with a retailer establishment; and

transmitting information related to the weight of the container, the type of liquid within the container, and the associated retailer establishment from the uplink/gateway to a computer database via a wireless network.

X11. A method, comprising:

coupling a chemical sensor to a keg;

attaching a wireless electronic communication device to the keg, the wireless electronic communicating device being in electronic communication with the chemical sensor;

sensing a chemical characteristic of the liquid by use of the sensor; and

transferring information about the characteristic of the liquid from the wireless electronic communication device to a computer database.

X12. A method, comprising:

determining the size of a liquid container positioned on a surface, the size determination being dependent upon a weight sensed by one or more weight sensors;

determining the weight of the liquid container using information about the size of the liquid container; and

determining an amount of liquid in the liquid container using a weight sensed by the one or more weight sensors and information about the weight of the liquid container.

X13. A method, comprising:

attaching a wireless electronic communication device to a keg with liquid, the wireless electronic communication device being encoded with information relating to a characteristic of the liquid within the keg;

coupling a sensor/transmitter to a bottom of the keg;

transferring information relating to a characteristic of the liquid within the keg from the wireless electronic communication device to the sensor/transmitter;

weighing the keg with the sensor/transmitter; and

transmitting information related to the weight of the keg and the type of liquid within the keg from the sensor/transmitter to a computer database via a wireless network, the transmitted information including a time and date associated with:
the weight of the keg; and/or
the type of liquid within the keg.

X14. An apparatus, comprising:

a sensor/transmitter adapted to fit within and attach to an inner diameter of a keg bottom, the sensor/transmitter protruding below the keg bottom when the keg is upright, the sensor/transmitter including

an attachment clip adapted to engage a portion of the keg bottom and inhibit the sensor/transmitter from detaching from the keg when the keg is raised above a support surface,

an abutment surface adapted to abut a surface of the keg and support the keg above the support surface when the sensor/transmitter is attached to the keg bottom and placed on the support surface,

a weight sensor configured and adapted to contact the support surface and measure the weight of a keg when the sensor/transmitter is attached to the keg bottom and placed on the support surface,

a receiver that receives information related to a liquid in the keg from a wireless electronic communication device, and

a transmitter that receives information from the receiver and from the weight sensor, wherein the transmitter transmits the information received from the receiver and the weight sensor to a wireless network.

X15. A system, comprising:

a plurality of wireless electronic communication devices, each encodable with information identifying a characteristic of liquid within a keg, each wireless electronic communication device being attachable to a keg;

a plurality of sensors each couplable to the bottom of a keg, each sensor configured and adapted to:
measure the weight of the keg to which the sensor is coupled,
receive information from one of the plurality of wireless electronic communication devices coupled to the same keg as each sensor, the information relating to a characteristic of the liquid within the keg to which the one wireless electronic communication device and the sensor is coupled, and
transmit information to a wireless network, the transmitted information including information from the wireless electronic communication device including the characteristic of the liquid within the keg to which the sensor is coupled, and information about the weight of the keg to which the sensor is coupled; and

a computer database that receives and stores information from the plurality of sensors via the wireless network.

X16. An apparatus, comprising:

a generally disc-shaped body including an upper surface and a lower surface opposite the upper surface;

a circumferential ridge extending downward from the lower surface, the circumferential ridge having a first inner diameter sized to accept a first keg; and

a raised circular ridge extending upward from the upper surface, the raised circular ridge having a second inner diameter sized to accept a second keg, the second inner diameter being smaller than the first inner diameter.

X17. A method, comprising:

attaching smart tag to a keg, the smart tag including an electronic ink display configured to visually display information relating to a characteristic of a liquid within the keg, the smart tag also including a wireless electronic communication device, the wireless electronic communication device being encoded with information relating to a characteristic of a liquid within the keg;

coupling a sensor/transmitter to the keg;

transferring information relating to a characteristic of the liquid within the keg to the sensor/transmitter; and

transmitting information related to the type of liquid within the keg from the sensor/transmitter to a computer database via a wireless network.

X18. A method, comprising:

attaching a wireless electronic communication device to a liquid, the wireless electronic communication device being encoded with information relating to a characteristic of the liquid within the attached liquid container;

coupling a sensor/transmitter to the liquid container;

transferring information relating to a characteristic of the liquid within the liquid container from the wireless electronic communication device attached to the liquid container to the sensor/transmitter coupled to the liquid container;

weighing the liquid container with the attached sensor/transmitter at a plurality of time points;

transmitting information related to the weight of the liquid container and the type of liquid within the liquid container from the attached sensor/transmitter to a computer database via a wireless network, the computer database containing retail pricing information for the type of liquid within the keg and wholesale pricing information for the type of liquid within the keg;

determining the profit margin of the liquid container based on the retail pricing information, the wholesale pricing information, and the information related to the weight of the liquid container.

X19. A method, comprising:

providing a computer system including a processor and a non-transient computer-readable storage medium;

receiving retail pricing information for a beverage from a retail point of sale system, the retail point of sale system being in electronic communication with the computer system;

receiving wholesale pricing information for the beverage from a wholesale product pricing database, the wholesale product pricing database being in electronic communication with the computer system;

receiving information relating to depletion of the beverage from a liquid container over time from a sensor/transmitter coupled to the liquid container, the sensor/transmitter being in electronic communication with the computer system;

determining a profit margin of the beverage based on the retail pricing information, the wholesale pricing information, and the information relating to depletion of the beverage; and

ascertaining a quantity of the beverage to have delivered to a retail establishment, the ascertaining being dependent upon the determined profit margin.

X20. A method, comprising:

providing a computer system including a processor and a non-transient computer-readable storage medium;

receiving at the computer system via electronic transmission a rate of consumption of liquid in liquid containers;

receiving at the computer system from a user an electronic transmission of a measurement time period;

determining a current stock of liquid containers in the possession of the user from signals transmitted to the computer system by a plurality of sensor/transmitters, each said sensor/transmitter being coupled to a respective said liquid container;

determining a number of additional liquid containers needed by the user by calculation of the computer system based on the rate of consumption, the measurement time period, and the current stock.

X21. An apparatus, comprising:

a sensor/transmitter disposed below and supporting a keg bottom when the keg is upright, the sensor/transmitter including:

a circular body having a top surface;

a plurality of pads received in the circular body and projecting upwardly beyond the top surface of the circular body, each pad having a top surface adapted to engage and support a circular rim of the keg bottom;

a weight sensing arrangement including a plurality of electrical elements, each said electrical element being disposed below the top surface of a respective one of the pads, said weight sensing arrangement being configured and adapted to measure a weight of the keg when the sensor/transmitter is supporting the keg bottom;

a receiver that receives information related to liquid in the keg from a wireless electronic communication device, and

a transmitter that receives information from the receiver and from the weight sensing arrangement, wherein the transmitter transmits the information received from the receiver and the weight sensing arrangement to a wireless network.

Yet other embodiments include the features described in any of the previous statements X1, X2, X3, X4, X5, X6, X7, X8, X9, X10, X11, X12, X13, X14, X15, X16, X17, X18, X19, X20, or X21, as combined with

(i) one or more of the previous statements X1, X2, X3, X4, X5, X6, X7, X8, X9, X10, X11, X12, X13, X14, X15, X16, X17, X18, X19, X20, or X21,

(ii) one or more of the following aspects, or

(iii) one or more of the previous statements X1, X2, X3, X4, X5, X6, X7, X8, X9, X10, X11, X12, X13, X14, X15, X16, X17, X18, X19, X20, or X21 and one or more of the following aspects:

Re-determining the weight of liquid contained in each liquid container using the weight sensed by the first and second weight sensors at a time different from the time at which said determining was performed.

Determining the quantity of fluid in the keg using the information related to the flow of the liquid.

Determining the quantity of fluid in the keg using the information related to the weight sensed by each weight sensor.

Communicating the amount of fluid in each container to a computer database.

Wherein the weight sensors transfer weight information between one another.

Wherein the computer database identifies the sensors used in a stack of liquid containers.

Wherein the computer database determines the sensors in a stack using the weight information from the sensors.

Wherein the computer database determines the top to bottom order of the sensors in a stack using the weight information from the sensors.

Wherein the computer database determines the sensors in a stack using positional information (e.g., coordinates) of the sensors.

Wherein the computer database determines the top to bottom order of the sensors in a stack using positional information (e.g., coordinates) of the sensors.

Wherein a user identifies the sensors in a stack to the computer database.

Wherein a user identifies the top to bottom order of sensors in a stack to the computer database.

Wherein the computer database determines whether a liquid container has been placed atop another liquid container by identifying a weight increase of the sensor associated with the lower liquid container.

Wherein the computer database determines whether a liquid container has been placed atop another liquid container by identifying a weight increase of the sensor associated with the lower liquid container and determining if the weight increase surpasses a threshold weight.

Placing a mat below one or more sensors.

Determining the rate of depletion of a type of liquid within a geographic area using the information related to the weight of each keg, the type of liquid within each keg, and the geographic location of the transmitting uplink/gateway.

Communicating the rate of depletion of a type of liquid within a geographic area.

Determining the presence of a type of liquid at a particular geographic location using the information related to the weight of each keg, the type of liquid within each keg, and the geographic location of the transmitting uplink/gateway.

Communicating the presence of a type of liquid at a particular geographic location.

Encoding a wireless electronic communication device with information concerning one or more attributes of liquid in the liquid container.

Wherein the one or more attributes include the identity (e.g., brand name) of the liquid, the alcohol content of the liquid, the type of liquid, the date the liquid was transferred into the liquid container.

Attaching an accelerometer to the keg, the accelerometer being in communication with the wireless electronic communication device; transferring acceleration information collected by the accelerometer from the wireless electronic communication device to the sensor/transmitter; and transmitting information related to acceleration from the sensor/transmitter to a computer database via a wireless network.

Wherein the chemical characteristic transferred to the computer database includes information about the sugar content and/or alcohol content of the liquid.

Attaching a weight sensor to the keg, the weight sensor being in communication with the wireless electronic communication device; transferring weight information collected by the weight sensor from the wireless electronic communication device to the sensor/transmitter; and transmitting information related to weight from the sensor/transmitter to a computer database via a wireless network.

Attaching a temperature sensor to the keg, the weight sensor being in communication with the wireless electronic communication device; transferring temperature information collected by the temperature sensor from the wireless electronic communication device to the sensor/transmitter; and transmitting information related to temperature from the sensor/transmitter to a computer database via a wireless network.

Wherein temperature information about a keg is transmitted to a computer database when the temperature exceeds a threshold.

Wherein temperature information about the keg is transmitted to a computer database at predetermined intervals.

Wherein acceleration information about a keg is transmitted to a computer database when the acceleration exceeds a threshold.

Wherein acceleration information about the keg is transmitted to a computer database at predetermined intervals.

Wherein the accelerometer is located within the housing of the weight sensor.

Wherein the accelerometer is not located within the housing of the weight sensor.

Wherein the accelerometer is included in a tag connected to the liquid container and/or keg.

Attaching two electronic communication devices to a liquid container, one having a longer range than the other, and optionally determining the location of the liquid container using the two electronic communication devices.

Wherein the weight sensors are included in a thin floor membrane.

Wherein the sensor/transmitter includes one or more weight sensors.

Wherein a footer is attached to the sensor/transmitter.

Wherein the sensor/transmitter includes an audible signaling device.

Wherein the wireless electronic communication device is a RFID tag.

Wherein a computer system in communication with the computer database sends an alert upon fulfillment of one or more predetermined criteria.

Wherein the predetermined criteria include detection of a sensor/transmitter at a certain geographic location or reaching a certain value of temperature, acceleration, weight, or liquid flow.

Wherein the alert is an audible signal.

Wherein the alert is a visual signal.

Sending one or more alerts to a user informing the user that one or more kegs will likely be depleted within a time period.

Pairing of one or more sensors, transmitters and/or sensor/transmitters to a particular uplink and/or gateway.

Transmitting information to one or more users with:
information related to products available to a particular user, and/or
recommendations regarding:
   a retailer suited to the user (based on, for example, proximity, presence of a desired beverage at the retail location, or other factor),
   which product at a specific location is most suited to the user (for example, based user beverage preference provided in his or her social media profile or other available information source), and/or
   promotion of a product available at a specific location the user has designated as desired, or designated by a third party as an item to be promoted.

Sending prompts to one or more consumers based on events that may be automatically compiled and/or scheduled into an event scheduling system.

Automatically gathering and compiling information related to:
local activities and events external to an establishment (such as a sporting event, a scheduled convention nearby, an upcoming holiday (e.g., St. Patrick's Day), weather conditions, outside temperature, social media activity/events, etc.), and/or
information available within the establishment and/or system (such as products available and/or consumed, promotional events, daily beer sales, average daily depletion, beers poured, average check counts and amounts, etc., which may be automatically compiled or entered by users); and/or
generating prompts to users and/or consumers based on the information.

Wherein the smart tag further includes a temperature sensor in communication with the wireless electronic communication device, and wherein transferring information includes transferring temperature information collected by the temperature sensor, and wherein transmitting information includes transmitting temperature information.

Wherein the smart tag further includes an accelerometer in communication with the wireless electronic communication device, and wherein transferring information includes transferring acceleration information collected by the accelerometer, and wherein transmitting information includes transmitting acceleration information. Wherein the first keg is a half-barrel keg and wherein the second keg is one of a quarter-barrel keg and a sixth-barrel keg.

Wherein the sensor/transmitter includes a center portion and a plurality of connecting arms extending radially from the center portion.

Wherein the sensor/transmitter includes a weight sensor configured and adapted to contact a support surface and measure the weight of a keg when the sensor/transmitter is attached to the bottom of a keg and placed on a support surface,

Wherein the weight sensor is located on the central body.

Wherein the weight sensor is located on a connecting arm.

Wherein the weight sensor is a plurality of weight sensors, each of the plurality of weight sensors located on one of the plurality of connecting arms.

Wherein the connecting arms are adjustable in length.

Wherein each of the plurality of connecting arms includes a spring biasing the arm outward from the center portion.

Wherein each of the plurality of connecting arms includes a terminal end having curved support.

Wherein the curved support includes a groove sized to accept the collar of a keg.

Wherein the liquid container is a keg.

Wherein trending data is indicative of changing rates of sales of identified products, and the trending data is collected and analyzed, and inventory levels of the products are adjusted based on the trending data, or on the analysis of the trending data.

Wherein the trending data is collected from the Internet.

Wherein the volume of data processed is reduced by data compression and/or by using a communication protocol other than hypertext transfer protocol (http).

Wherein the weight of the liquid container is determined and is used to ascertain the weight of the liquid in the liquid container.

Wherein the sensor/transmitter wakes up at time intervals and checks a weight, and if the weight has changed since the last check, the sensor/transmitter transmits the new weight along with an identification of the version of the software running on the sensor/transmitter.

Wherein a newer version of the software is transmitted to and loaded onto the sensor/transmitter if the newer version is available.

Wherein in a normal operating mode the sensor/transmitter transmits weight data to an uplink, and in a maintenance operating mode all communications between the uplink and the sensor/transmitter are for software updates or other system maintenance.

Wherein weight data is monitored, and the maintenance operating mode is entered in response to time periods of reduced changes in the weight data.

Wherein a multi-cast or carousel transmits software updates to the sensor/transmitter.

Wherein a first frequency channel is used for transmitting weight data, and a second frequency channel is used for software updates or other system maintenance.

Wherein a voltage of a battery is monitored, and the sensor/transmitter is powered up in response to the battery voltage exceeding a threshold voltage.

Wherein, during manufacturing of a sensor/transmitter, a Faraday cage prevents the sensor/transmitter from communicating with an unintended uplink.

Wherein, during manufacturing of sensor/transmitters, different frequency channels and/or PAN IDs are used at different manufacturing stations as a means to prevent one of the sensor/transmitters from communicating with an unintended uplink at one of the different manufacturing stations.

Wherein an RFID tag is used to transmit information about a liquid container's content to a sensor/transmitter when the RFID tag and the sensor/transmitter are paired.

Wherein each sensor/transmitter pairs with and/or accepts information from the RFID tag in response to receiving a particular RFID code.

Wherein the RFID code includes functional instructions to the sensor/transmitter.

Wherein the RFID tag is associated with a particular operational mode, and the RFID tag is moved within communication range of a sensor/transmitter in order to change an operation mode of the sensor/transmitter to the particular operational mode.

Wherein the RFID tag includes a code for locking and/or unlocking the sensor/transmitter.

Wherein the RFID tag is used to change a radio frequency channel and/or PAN ID for the sensor/transmitter.

Wherein an RFID tag is placed on a customer's cup and is read in order to verify that the customer has paid for the cup to be filled with a beverage.

Wherein the customer is enabled to reprogram the RFID tag on the customer's cup by paying for the cup to be filled with a beverage.

Wherein the system counts a number of different RFID tags that are on cups that have been filled with liquid as a proxy for a number of customers served.

Wherein, in response to determining that a battery has dropped below a threshold voltage, a sensor/transmitter transmits a low battery signal and/or decreases a frequency at which the sensor/transmitter wakes up and weighs the liquid container.

Wherein, in in response to determining that a battery has dropped below a threshold voltage, a sensor/transmitter transmits a low battery signal and weighs the liquid container only in response to receiving a command signal from a user.

Wherein the communication ranges of uplinks and/or sensor/transmitters are reduced as a means for determining a precise location of the liquid container.

Wherein a specific serial number is provided on each RFID tag, and each RFID tag is attached to a respective liquid container.

Wherein, upon power up, the sensor/transmitter paired with the RFID tag communicates to an uplink that is paired with the specific serial number, and the location of the sensor/transmitter is determined based upon the communication to the uplink.

Wherein sensor/transmitters respond to an interrogation signal from either an uplink or a separate interrogator by providing an audible, visual or RF signal when particular information stored in the sensor/transmitter matches information being requested by the uplink or standalone interrogator during the interrogation.

Wherein the particular information comprises a freshness date by which the product in the container should be consumed.

Wherein the determining is performed by a processor communicatively coupled to the first weight sensor and the second weight sensor.

Wherein the second weight sensor is sandwiched between the first liquid container and the second liquid container.

Wherein the first weight sensor is sandwiched between the first liquid container and a support surface.

Wherein the first weight of liquid contained in the first liquid container is determined dependent upon an ascertained weight of the first liquid container, and the second weight of liquid contained in the second liquid container is determined dependent upon an ascertained weight of the second liquid container.

Wherein the calculating is dependent upon the first weight measurements and the second weight measurements.

Wherein the first weight measurements and the second weight measurements are taken substantially simultaneously at a plurality of points in time.

Wherein the transmitted information includes the points in time at which the first weight measurements and the second weight measurements were taken.

Deciding whether to cease serving beverages from the keg, the deciding being dependent upon the temperature information.

Automatically controlling a keg cooling system, the keg cooling system being dependent upon the temperature information.

Wherein the temperature information about the keg includes an ambient temperature around the keg.

Transferring information about the temperature sensor's remaining battery life as a percentage from the wireless electronic communication device to the computer database.

Wherein the transmitted information includes dates and times at which the temperature information was collected.

Wherein the sensor/transmitter comprises a weight sensor, the transmitted information including information related to weight of the keg and dates and times at which keg weight information was sensed.

Transmitting information related to a geographical location of the keg from the sensor/transmitter to the computer database via the wireless network.

Wherein the transmitted information includes at least one date and time at which a measurement was taken by the accelerometer.

Coupling a weight sensor/transmitter to the keg.

Sensing a weight of the keg by use of the weight sensor/transmitter.

Wirelessly transmitting information about the weight of the keg from the weight sensor/transmitter to the computer database.

Wherein the step of transferring information about acceleration of the keg to a computer database includes transferring the information about acceleration of the keg to the weight sensor/transmitter, and wirelessly transmitting the information about acceleration of the keg from the weight sensor/transmitter to the computer database.

Using a computer system to produce a suggestion regarding one of whether to refill the keg with a beverage and whether to serve beverages from the keg, the suggestion being dependent upon the information about acceleration of the keg.

Wherein the transmitted information includes at least one date and time at which the acceleration information was collected by the accelerometer.

Wherein the transmitter comprises a weight sensor.

Sensing a weight of the keg.

Transmitting information related to the weight of the keg from the transmitter to the computer database via the wireless network.

Wherein the transmitted information includes at least one date and time at which the information related to the weight of the keg was sensed by the weight sensor.

Wherein the transmitted information includes at least one date and time at which the flow meter measured the flow of the liquid from the keg.

Wherein the transmitter comprises a weight sensor.

Wherein the transmitted information includes at least one date and time at which the information related to the weight of the keg was sensed by the weight sensor.

Wherein the sensor/transmitter comprises a weight sensor/transmitter.

Wirelessly transmitting the transferred information from the first and second wireless electronic communication devices to a computer database.

Wherein the first and second wireless electronic communication devices use different frequencies and/or different communication protocols.

Wherein the time is expressed in the transmitted information in terms of Coordinated Universal Time.

Wherein the transmitted information includes an identity of a retail establishment at which the transmitting uplink/gateway is disposed.

Assigning a respective unique RFID serial number to each of the wireless electronic communication devices.

Transferring the unique RFID serial numbers from the wireless electronic communication devices attached to the kegs to the sensor/transmitters coupled to the kegs.

Transmitting the unique RFID serial number associated with each keg from the coupled sensor/transmitters to a plurality of uplink/gateways.

Transmitting the unique RFID serial number associated with each said keg from each uplink/gateway to the computer database via the wireless network.

Wherein the uplink/gateway is closer to the coupled sensor/transmitter than any other uplink/gateway.

Wherein the transmitted information includes at least one date and time at which the information related to the weight of the container was sensed by the sensor/transmitter.

Assigning a unique RFID serial number to the wireless electronic communication device.

Transferring the unique RFID serial number from the wireless electronic communication device to the sensor/transmitter.

Transmitting the unique RFID serial number from the coupled sensor/transmitter to the uplink/gateway.

Transmitting the unique RFID serial number from said uplink/gateway to the computer database via the wireless network.

Wherein the transferred information includes at least one date and time at which the chemical characteristic was sensed by the sensor.

Wherein the chemical characteristic comprises at least one of a sugar content and an alcohol content of the liquid.

Assigning a unique identifier to the wireless electronic communication device.

Transferring information about the unique identifier from the wireless electronic communication device to the computer database.

Wherein the size of the liquid container comprises a half-barrel, 40 liter, 50 liter, quarter-barrel, or sixth-barrel.

Transmitting information about the determined amount of liquid in the liquid container to a computer database.

Wherein the size of the liquid container is determined by use of a lookup table associating the weight sensed by the one or more weight sensors with sizes of liquid containers.

Wherein the transmitted information includes a location of the keg.

Wherein the characteristic of the liquid within the keg includes at least one of:
an identity of the liquid;
a date on which the liquid was placed in the container; and
the type of liquid within the keg.

Assigning a unique RFID serial number to the wireless electronic communication device.

Wherein the abutment surface is downwardly sloping in radially inward directions.

Wherein the sensor/transmitter includes an annular body.

Wherein the annular body includes a handhold on a radially inward edge of the annular body.

Wherein the transmitted information includes a time and date at which the weight of the keg was measured by the sensor.

Wherein the transmitted information includes a location of the keg.

Wherein the wireless electronic communication devices comprises a plastic luggage type tag attachable to a keg via a plastic strap.

Wherein the generally disc-shaped body includes at least one vertically aligned throughhole.

A sensor/transmitter having a central throughhole and a keg spacer having a central throughhole, the circumferential ridge being snugly received in the central throughholes of the sensor/transmitter and of the keg spacer.

A sensor/transmitter having a central throughhole, the circumferential ridge being snugly received in the central throughhole of the sensor/transmitter, a height of the sensor/transmitter being at least as great as a height of the circumferential ridge.

Wherein the first keg is a half-barrel keg, and the second keg is one of a sixth-barrel keg and a quarter-barrel keg.

Wherein the sensor/transmitter is configured and adapted to sense a weight of the keg.

Wherein the transmitted information is related to the weight of the keg.

Wherein the attaching step includes peeling off an adhesive back from the smart tag, looping the smart tag through a keg handle and adhering the smart tag back onto itself.

Ordering a quantity of the liquid dependent upon the determined profit margin.

Wherein the ordering is performed automatically by a computer system via the wireless network.

Wherein the ordering comprises ordering the quantity of the liquid to be delivered to a retail establishment.

Ordering the ascertained quantity of the beverage to have delivered to the retail establishment.

Wherein the ordering is performed automatically by the computer system.

Weighing the liquid container by use of the sensor/transmitter.

Wherein the signals transmitted to the computer system by the sensor/transmitters include information related to the weights of the kegs sensed by the sensor/transmitters, the determining of the number of additional liquid containers needed by the user being dependent upon the sensed weights.

Ordering the number of additional liquid containers needed by the user.

Wherein the ordering is performed automatically by the computer system.

Wherein the circular body has a bottom surface configured to engage a support surface.

Wherein the circular body is annular and has a central through hole.

Wherein the top surface of the circular body slopes downwardly in a radially inward direction.

Wherein the top surfaces of the pads slope downwardly in radially inward directions.

Reference systems that may be used herein can refer generally to various directions (e.g., upper, lower, forward and rearward), which are merely offered to assist the reader in understanding the various embodiments of the disclosure and are not to be interpreted as limiting. Other reference systems may be used to describe various embodiments, such as referring to the direction of projectile movement as it exits the firearm as being up, down, rearward or any other direction.

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Features of one embodiment may be used in combination with features of other embodiments as would be understood by one of ordinary skill in the art, whether or not explicitly described as such. One or more exemplary embodiments have been shown and described, and all changes and modifications that come within the spirit of the disclosure are desired to be protected.

1-87. (canceled)

88. A method comprising:
attaching an accelerometer to a beverage container;
detecting an acceleration of the beverage container by the accelerometer;
comparing the detected acceleration to a predetermined value of acceleration; and
transferring information about the acceleration of the beverage container to a computer database.

89. The method of claim 88, which further comprises measuring a temperature of the beverage container and transferring information about the temperature to a computer database.

90. The method of claim 88, which further comprises flowing beverage from the beverage container through a flowmeter and transferring information about the flow of beverage from the beverage container to a computer database.

91. The method of claim 88, which further comprises sensing a chemical characteristic of a beverage contained by the beverage container and transferring the information to a computer database.

92. The method of claim 92 wherein the chemical characteristic comprises at least one of a sugar content and an alcohol content of the beverage in the beverage container.

93. The method of claim 89 comprising deciding whether to cease serving beverages from the beverage container using the temperature information.

94. The method of claim 89 comprising automatically controlling a beverage container cooling system using the temperature information.

95. The method of claim 88 comprising transferring information about the remaining battery life of the accelerometer to the computer database if the detected acceleration exceeds the predetermined value of acceleration.

96. The method of claim 88 which further comprises:
coupling a weight sensor to the beverage container;
sensing a weight of the beverage container by use of the weight sensor; and
wirelessly transmitting information about the weight of the beverage container from the weight sensor to the computer database if the detected acceleration exceeds the predetermined value of acceleration.

97. The method of claim 88 which further comprises suggesting whether to refill the beverage container with a beverage if the detected acceleration exceeds the predetermined value of acceleration.

98. The method of claim 88 which further comprises suggesting whether to serve beverages from the beverage container if the detected acceleration exceeds the predetermined value of acceleration.

99. The method of claim 88 which further comprises encoding a wireless electronic communication device with information relative to the quantify of beverage within the beverage container, and transmitting information relative to the quantity of beverage within the beverage container if the detected acceleration exceeds the predetermined value of acceleration.

100. The method of claim 99 which further comprises calculating a rate of depletion of the beverage within the beverage container and transmitting data related to the depletion rate if the detected acceleration exceeds the predetermined criteria.

101. The method of claim 99 which further comprises sending a text message to a smart phone if the detected acceleration exceeds the predetermined criteria.

102. The method of claim 99 which further comprises activating a signaling device if the detected acceleration exceeds a predetermined criteria, and generating an audible signal.

103. The method of claim 99 which further comprises activating a signaling device if the detected acceleration exceeds a predetermined criteria, and generating a visual signal.

104. The method of claim 99 which further comprises sending an alert signal to a smart phone if the detected acceleration exceeds a predetermined criteria.

105. The method of claim 88 which further comprises activating a signaling device if the detected acceleration exceeds the predetermined value of acceleration.

106. The method of claim 105 which further comprises generating an audible signal by said activating a signaling device.

107. The method of claim 105 which further comprises generating a visual signal by said activating a signaling device.

108. The method of claim 105 which further comprises transmitting information related to the quantity of beverage within the beverage container if the detected acceleration exceeds the predetermined criteria.

109. The method of claim 105 which further comprises sending an alert signal to a smart phone if the detected acceleration exceeds the predetermined criteria.

110. The method of claim 88 sending an alert signal related to the transferred information from the computer database to a smart phone if the detected acceleration exceeds the predetermined value of acceleration.

111. The method of claim 110 which further comprises sending an alert signal related to the transferred information to a social media website.

112. The method of claim 111 wherein the social media website is Twitter.

113. The method of claim 111 wherein the social media website is Facebook.

114. The method of claim 110 which further comprises sending a voice mail related to the transferred information.

115. The method of claim 110 which further comprises generating a visual signal if the acceleration exceeds a predetermined criteria.

116. The method of claim 110 which further comprises generating an audible signal if the acceleration exceeds a predetermined criteria.

117. The method of claim 110 which further comprises transmitting the quantity of beverage within the beverage container if the acceleration exceeds a predetermined criteria.

118. The method of claim 110 which further comprises sending a text message to a smart phone if the acceleration exceeds a predetermined criteria.
